(19) United States
(12) Patent Application Publication
(10) Pub. No.: US 2025/0158790 A1
(43) Pub. Date: May 15, 2025

(54) TERMINAL, RADIO COMMUNICATION METHOD, AND BASE STATION

(71) Applicant: NTT DOCOMO, INC., Tokyo (JP)

(72) Inventors: Haruhi Echigo, Tokyo (JP); Hiroki Harada, Tokyo (JP); Yuki Matsumura, Tokyo (JP); Naoya Shibaike, Tokyo (JP); Qiping Pi, Beijing (CN)

(73) Assignee: NTT DOCOMO, INC., Tokyo (JP)

(21) Appl. No.: 18/838,516

(22) PCT Filed: Feb. 18, 2022
(86) PCT No.: PCT/JP2022/006720

§ 371 Date: Aug. 14, 2024

(51) Int. Cl. H04L 5/00

(52) U.S. Cl. CPC H04L 5/0091

(57) ABSTRACT

A terminal according to one aspect of the present disclosure includes: a receiving section that receives configuration information including a configuration related to a transmission configuration indication (TCI) state to be applied to a plurality of types of channels and indication of the TCI state, a TCI field codepoint included in the indication being associated with a plurality of the TCI states; and a control section that determines, based on information related to application initiation timing of the TCI state included in the configuration information and the indication, the application initiation timing of the TCI state. According to one aspect of the present disclosure, it is possible to appropriately recognize a TCI state.

### TECHNICAL FIELD

The present disclosure relates to a terminal, a radio communication method, and a base station in next-generation mobile communication systems.

### BACKGROUND ART

In a Universal Mobile Telecommunications System (UMTS) network, the specifications of Long-Term Evolution (LTE) have been drafted for the purpose of further increasing high speed data rates, providing lower latency and so on (see Non-Patent Literature 1). In addition, for the purpose of further high capacity, advancement and the like of the LTE (Third Generation Partnership Project (3GPP) Release (Rel.) 8 and Rel. 9), the specifications of LTE-Advanced (3GPP Rel. 10 to Rel. 14) have been drafted.

Successor systems of LTE (for example, also referred to as “5th generation mobile communication system (5G),” “5G+ (plus),” “6th generation mobile communication system (6G),” “New Radio (NR),” “3GPP Rel. 15 (or later versions),” and so on) are also under study.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

For future radio communication systems (for example, NR), it is studied that a user terminal (terminal, User Equipment (UE)) controls transmission/reception processing, based on information related to quasi-co-location (QCL) (QCL assumption/Transmission Configuration Indication (TCI) state/spatial relation).

A unified TCI state for applying a configured/activated/indicated TCI state to a plurality of types of channels/reference signals (RSs) is studied. However, a method of applying a unified TCI state is not clear in some cases. Unless such a relationship is clear, degradation in communication quality, throughput reduction, and the like may occur.

Thus, an object of the present disclosure is to provide a terminal, a radio communication method, and a base station that are to appropriately determine a TCI state.

### Solution to Problem

A terminal according to one aspect of the present disclosure includes: a receiving section that receives configuration information including a configuration related to a transmission configuration indication (TCI) state to be applied to a plurality of types of channels and indication of the TCI state, a TCI field codepoint included in the indication being associated with a plurality of the TCI states; and a control section that determines, based on information related to application initiation timing of the TCI state included in the configuration information and the indication, the application initiation timing of the TCI state.

### Advantageous Effects of Invention

According to one aspect of the present disclosure, it is possible to appropriately recognize a TCI state.

### BRIEF DESCRIPTION OF DRAWINGS

FIG. 1A and FIG. 1B are diagrams to show examples of a common beam.

FIG. 2 is a diagram to show an example of a MAC CE defined in Rel. 16.

FIG. 3 is a diagram to show another example of the MAC CE defined in Rel. 16.

FIG. 4 is a diagram to show another example of the MAC CE defined in Rel. 16.

FIG. 5A and FIG. 5B are diagrams to show examples of joint/separate TCI state indication.

FIG. 6 is a diagram to show an example of timing to application of an indicated TCI state.

FIG. 7 is a diagram to show an example of a reference of start of a BAT according to a first embodiment.

FIG. 8A and FIG. 8B are diagrams to show an example of application of a TCI state according to option 1-1-1.

FIG. 9A and FIG. 9B are diagrams to show an example of application of a TCI state according to option 1-1-3.

FIG. 10 is a diagram to show an example of application of a TCI state according to option 1-1-4.

FIG. 11 is a diagram to show an example of application of a TCI state according to modification example 1 of option 1-1-4.

FIG. 12 is a diagram to show an example of application of a TCI state according to modification example 2 of option 1-1-4.

FIG. 13 is a diagram to show an example of a structure of a MAC CE according to option 1-1-5-1.

FIG. 14 is a diagram to show an example of a structure of a MAC CE according to option 1-1-5-2.

FIG. 15A and FIG. 15B are diagrams to show an example of application of a TCI state according to option 1-2-1.

FIG. 16 is a diagram to show an example of application of a TCI state according to option 1-2-2.

FIG. 17A is a diagram to show an example of associations of BAT values according to option 1-3-1. FIG. 17B is a diagram to show an example of associations of BAT values according to option 1-3-2.

FIG. 18A and FIG. 18B are diagrams to show an example of application of TCI states according to a second embodiment.

FIG. 19 is a diagram to show another example of the application of TCI states according to the second embodiment.

FIG. 20 is a diagram to show an example of a TCI state parameter according to option 2-1-1.

FIG. 21A is a diagram to show an example of application of a TCI state according to variation 2-1-1-1. FIG. 21B is a diagram to show an example of application of a TCI state according to variation 2-1-1-2.

FIG. 22A is a diagram to show an example of application of a TCI state according to variation 2-1-1-3. FIG. 22B is a diagram to show an example of application of a TCI state according to variation 2-1-1-4.

FIG. 23 is a diagram to show an example of a TCI state parameter according to option 2-1-2.

FIG. 24 is a diagram to show an example of a structure of a MAC CE according to option 2-1-3-1.

FIG. 25 is a diagram to show an example of a structure of a MAC CE according to option 2-1-3-2.

FIG. 26A and FIG. 26B are diagrams to show an example of application of TCI states according to choice 2-2-1.

FIG. 27A and FIG. 27B are diagrams to show an example of application of TCI states according to choice 2-2-2.

FIG. 28 is a diagram to show an example of application of TCI states according to aspect 5-1.

FIG. 29 is a diagram to show another example of the application of TCI states according to aspect 5-1.

FIG. 30 is a diagram to show an example of application of TCI states according to aspect 5-3.

FIG. 31 is a diagram to show an example of application of TCI states according to option 5-5-1.

FIG. 32 is a diagram to show an example of application of TCI states according to option 5-5-2.

FIG. 33 is a diagram to show an example of a schematic structure of a radio communication system according to one embodiment.

FIG. 34 is a diagram to show an example of a structure of a base station according to one embodiment.

FIG. 35 is a diagram to show an example of a structure of a user terminal according to one embodiment.

FIG. 36 is a diagram to show an example of a hardware structure of the base station and the user terminal according to one embodiment.

FIG. 37 is a diagram to show an example of a vehicle according to one embodiment.

### DESCRIPTION OF EMBODIMENTS

### (TCI, Spatial Relation, QCL)

For NR, control of reception processing (for example, at least one of reception, demapping, demodulation, and decoding) and transmission processing (for example, at least one of transmission, mapping, precoding, modulation, and coding) of at least one of a signal and a channel (expressed as a signal/channel) in a UE, based on a transmission configuration indication state (TCI state) is under study.

The TCI state may be a state applied to a downlink signal/channel. A state that corresponds to the TCI state applied to an uplink signal/channel may be expressed as spatial relation.

The TCI state is information related to quasi-co-location (QCL) of the signal/channel, and may be referred to as a spatial reception parameter, spatial relation information, or the like. The TCI state may be configured for the UE for each channel or for each signal.

QCL is an indicator indicating statistical properties of the signal/channel. For example, when a certain signal/channel and another signal/channel are in a relationship of QCL, it may be indicated that it is assumable that at least one of Doppler shift, a Doppler spread, an average delay, a delay spread, and a spatial parameter (for example, a spatial reception parameter (spatial Rx parameter)) is the same (the relationship of QCL is satisfied in at least one of these) between such a plurality of different signals/channels.

Note that the spatial reception parameter may correspond to a receive beam of the UE (for example, a receive analog beam), and the beam may be identified based on spatial QCL. The QCL (or at least one element in the relationship of QCL) in the present disclosure may be interpreted as sQCL (spatial QCL).

For the QCL, a plurality of types (QCL types) may be defined. For example, four QCL types A to D may be provided, which have a different parameter(s) (or a parameter set(s)) that can be assumed to be the same, and such parameters (which may be referred to as QCL parameters) are described below:
QCL type A (QCL-A): Doppler shift, Doppler spread, average delay, and delay spread
QCL type B (QCL-B): Doppler shift and Doppler spread
QCL type C (QCL-C): Doppler shift and average delay
QCL type D (QCL-D): Spatial reception parameter

A case that the UE assumes that a certain control resource set (CORESET), channel, or reference signal is in a relationship of specific QCL (for example, QCL type D) with another CORESET, channel, or reference signal may be referred to as QCL assumption.

The UE may determine at least one of a transmit beam (Tx beam) and a receive beam (Rx beam) of the signal/channel, based on the TCI state or the QCL assumption of the signal/channel.

The TCI state may be, for example, information related to QCL between a channel as a target (in other words, a reference signal (RS) for the channel) and another signal (for example, another RS). The TCI state may be configured (indicated) by higher layer signaling or physical layer signaling, or a combination of these.

The physical layer signaling may be, for example, downlink control information (DCI).

A channel for which the TCI state or spatial relation is configured (specified) may be, for example, at least one of a downlink shared channel (Physical Downlink Shared Channel (PDSCH)), a downlink control channel (Physical Downlink Control Channel (PDCCH)), an uplink shared channel (Physical Uplink Shared Channel (PUSCH)), and an uplink control channel (Physical Uplink Control Channel (PUCCH)).

The RS to have a QCL relationship with the channel may be, for example, at least one of a synchronization signal block (SSB), a channel state information reference signal (CSI-RS), a reference signal for measurement (Sounding Reference Signal (SRS)), a CSI-RS for tracking (also referred to as a Tracking Reference Signal (TRS)), and a reference signal for QCL detection (also referred to as a QRS).

The SSB is a signal block including at least one of a primary synchronization signal (PSS), a secondary synchronization signal (SSS), and a broadcast channel (Physical Broadcast Channel (PBCH)). The SSB may be referred to as an SS/PBCH block.

An RS of QCL type X in a TCI state may mean an RS in a relationship of QCL type X with (a DMRS of) a certain channel/signal, and this RS may be referred to as a QCL source of QCL type X in the TCI state.

For a PDCCH and a PDSCH, a QCL type A RS may always be configured, while a QCL type D RS may be configured additionally. Since it is difficult to estimate Doppler shift, latency, and the like, based on one-shot reception of a DMRS, the QCL type A RS is used for improvement of channel estimation accuracy. The QCL type D RS is used for receive beam determination at the time of DMRS reception.

For example, TRSs 1-1, 1-2, 1-3, and 1-4 are transmitted, and TRS 1-1 is notified as a QCL type C/D RS according to the TCI state of a PDSCH. By the TCI state being notified, the UE can use information obtained from results of past periodic reception/measurement of TRS 1-1, for reception/channel estimation of a DMRS for PDSCH. In this case, the QCL source of the PDSCH is TRS 1-1, and the QCL target is the DMRS for PDSCH.

### (Multi-TRP)

For NR, it is studied that one or a plurality of transmission/reception points (TRPs) (multi-TRP (multi TRP (MTRP))) perform DL transmission to a UE by using one or a plurality of panels (multi-panel). It is also studied that the UE performs UL transmission to the one or plurality of TRPs by using one or a plurality of panels.

Note that the plurality of TRPs may correspond to the same cell identifier (ID) or may correspond to different cell IDs. The cell ID may be a physical cell ID or a virtual cell ID.

The multi-TRP (for example, TRPs #1 and #2) may be connected via ideal/non-ideal backhaul to exchange information, data, and the like. Each TRP of the multi-TRP may transmit a different codeword (Code Word (CW)) and a different layer. As one mode of multi-TRP transmission, non-coherent joint transmission (NCJT) may be employed.

In NCJT, for example, TRP #1 performs modulation mapping on a first codeword, performs layer mapping, and transmits a first PDSCH in layers of a first number (for example, two layers) by using first precoding. TRP #2 performs modulation mapping on a second codeword, performs layer mapping, and transmits a second PDSCH in layers of a second number (for example, two layers) by using second precoding.

Note that a plurality of PDSCHs (multi-PDSCH) transmitted by NCJT may be defined to partially or entirely overlap in terms of at least one of the time and frequency domains. In other words, the first PDSCH from a first TRP and the second PDSCH from a second TRP may overlap in terms of at least one of the time and frequency resources.

The first PDSCH and the second PDSCH may be assumed not to be in a quasi-co-location (QCL) relationship (not to be quasi-co-located). Reception of the multi-PDSCH may be interpreted as simultaneous reception of PDSCHs of a QCL type other than a certain QCL type (for example, QCL type D).

A plurality of PDSCHs (which may be referred to as multi-PDSCH (multiple PDSCHs)) from the multi-TRP may be scheduled by using one piece of DCI (single DCI, single PDCCH) (single master mode, multi-TRP based on single DCI (single-DCI based multi-TRP)). The plurality of PDSCHs from the multi-TRP may be separately scheduled by using a plurality of pieces of DCI (multi-DCI, multi-PDCCH (multiple PDCCHs)) (multi-master mode, multi-TRP based on multi-DCI (multi-DCI based multi-TRP)).

For URLLC for multi-TRP, it is studied to support PDSCH (transport block (TB) or codeword (CW)) repetition over multi-TRP. It is studied to support a scheme of repetition over multi-TRP in the frequency domain, the layer (space) domain, or the time domain (URLLC schemes, for example, schemes 1, 2a, 2b, 3, and 4). In scheme 1, multi-PDSCH from multi-TRP is space division multiplexed (SDMed). In schemes 2a and 2b, PDSCHs from multi-TRP are frequency division multiplexed (FDMed). In scheme 2a, a redundancy version (RV) is the same for the multi-TRP. In scheme 2b, an RV may be the same or may be different for the multi-TRP. In schemes 3 and 4, multi-PDSCH from multi-TRP is time division multiplexed (TDMed). In scheme 3, multi-PDSCH from multi-TRP is transmitted in one slot. In scheme 4, multi-PDSCH from multi-TRP is transmitted in different slots.

According to such a multi-TRP scenario, more flexible transmission control using a channel with high quality is possible.

To support intra-cell (with the same cell ID) and inter-cell (with different cell IDs) multi-TRP transmission based on a plurality of PDCCHs, one control resource set (CORESET) in PDCCH configuration information (PDCCH-Config) may correspond to one TRP in RRC configuration information for linking a plurality of pairs of a PDCCH and a PDSCH with a plurality of TRPs.

When at least one of conditions 1 and 2 below is satisfied, the UE may determine that it is multi-TRP based on multi-DCI. In this case, a TRP may be interpreted as a CORESET pool index.

### {Condition 1}

One CORESET pool index is configured.

### {Condition 2}

Two different values (for example 0 and 1) of a CORESET pool index are configured.

When the following condition is satisfied, the UE may determine that it is multi-TRP based on single DCI. In this case, two TRPs may be interpreted as two TCI states indicated by a MAC CE/DCI.

### {Condition}

To indicate one or two TCI states for one codepoint of a TCI field in DCI, an “enhanced TCI states activation/deactivation for UE-specific PDSCH MAC CE” is used.

DCI for common beam indication may be a UE-specific DCI format (for example, DL DCI format (for example, 1_1, 1_2)), may be a UL DCI format (for example, 0_1, 0_2), or may be a UE-group common DCI format.

### (Unified/Common TCI Framework)

With a unified TCI framework, UL and DL channels can be controlled by a common framework. A unified TCI framework may indicate a common beam (common TCI state) and apply the common beam to all the UL and DL channels instead of defining a TCI state or a spatial relation for each channel as in Rel. 15, or apply a common beam for UL to all the UL channels while applying a common beam for DL to all the DL channels.

One common beam for both DL and UL or a common beam for DL and a common beam for UL (two common beams in total) are studied.

The UE may assume the same TCI state (joint TCI state, joint TCI pool, joint common TCI pool, joint TCI state set) for UL and DL. The UE may assume respective different TCI states (separate TCI states, separate TCI pools, UL separate TCI pool and DL separate TCI pool, separate common TCI pools, UL common TCI pool and DL common TCI pool) for UL and DL.

By beam management based on a MAC CE (MAC CE level beam indication), default UL and DL beams may be aligned. A default TCI state of a PDSCH may be updated to match to a default UL beam (spatial relation).

By beam management based on DCI (DCI level beam indication), a common beam/unified TCI state may be indicated from the same TCI pool (joint common TCI pool, joint TCI pool, set) for both UL and DL. X (>1) TCI states may be activated by a MAC CE. UL/DL DCI may select one from the X active TCI states. The selected TCI state may be applied to channels/RSs of both UL and DL.

The TCI pool (set) may be a plurality of TCI states configured by an RRC parameter or a plurality of TCI states (active TCI states, active TCI pool, set) activated by a MAC CE among the plurality of TCI states configured by the RRC parameter. Each TCI state may be a QCL type A/D RS. As the QCL type A/D RS, an SSB, a CSI-RS, or an SRS may be configured.

The number of TCI states corresponding to each of one or more TRPs may be defined. For example, the number N (≥1) of TCI states (UL TCI states) to be applied to a UL channel/RS and the number M (≥1) of TCI states (DL TCI states) to be applied to a DL channel/RS may be defined. At least one of N and M may be notified/configured/indicated to a UE by higher layer signaling/physical layer signaling.

In the present disclosure, when it is described as N=M=X (where X is any integer), this may mean that X TCI states (corresponding to X TRPs) common to UL and DL (joint TCI states) are notified/configured/indicated to a UE.

When it is described as N=X (where X is any integer) and M=Y (where Y is any integer, Y may be equal to X (Y=X)), this may mean that X UL TCI states (corresponding to X TRP(s)) and Y DL TCI states (corresponding to Y TRP(s)) are notified/configured/indicated to a UE. The UL TCI states and the DL TCI state(s) may each mean a TCI state common to UL and DL (in other words, a joint TCI state) or may each mean a TCI state separately for either UL or DL (in other words, a separate TCI state).

For example, when it is described as N=M=1, this may mean that one TCI state common to UL and DL for a single TRP is notified/configured/indicated to a UE (joint TCI state for a single TRP).

For example, when it is described as N=1 and M=1, this may mean that one UL TCI state and one DL TCI state for a single TRP are separately notified/configured/indicated to a UE (separate TCI states for a single TRP).

For example, when it is described as N=M=2, this may mean that a plurality of (two) TCI states common to UL and DL for a plurality of (two) TRPs are notified/configured/indicated to a UE (joint TCI states for a plurality of TRPs).

For example, when it is described as N=2 and M=2, this may mean that a plurality of (two) UL TCI states and a plurality of (two) DL TCI states for a plurality of (two) TRPs are notified/configured/indicated to a UE (separate TCI states for a plurality of TRPs).

For example, when it is described as N=2 and M=1, this may mean that two TCI states common to UL and DL are notified/configured/indicated to a UE. In this case, the UE may use the two configured/indicated TCI states as UL TCI states while using one TCI state of the two configured/indicated TCI states as a DL TCI state.

For example, when it is described as N=2 and M=1, this may mean that two UL TCI states and one DL TCI state are notified/configured/indicated as separate TCI states to a UE.

Note that, in the above examples, cases where the values of N and M are each one or two have been described, but the values of N and M may each be three or more, and N and M may be different from each other.

A case of M>1/N>1 may indicate at least one of a TCI state indication for a plurality of TRPs and a plurality of TCI state indications for inter-band (inter band) CA.

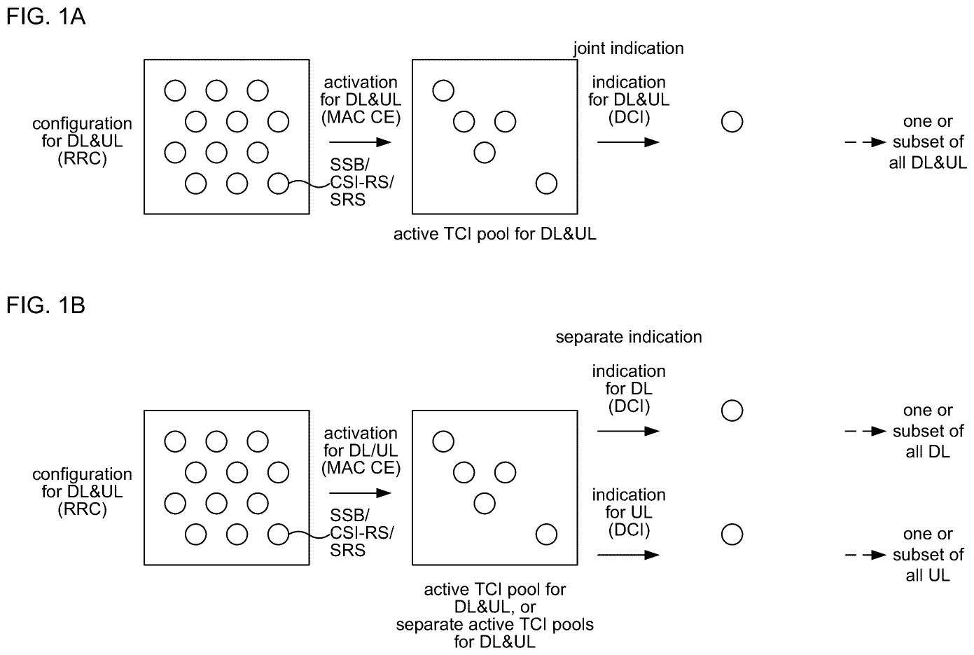

In the examples in FIG. 1, an RRC parameter (information element) configures a plurality of TCI states for both DL and UL.

The MAC CE may activate a plurality of TCI states among the plurality of configured TCI states. DCI may indicate one of the plurality of activated TCI states. The DCI may be UL/DL DCI. The indicated TCI state may be applied to at least one (or all) of UL/DL channels/RSs. One piece of DCI may indicate both a UL TCI and a DL TCI.

In the example in FIG. 1A, one dot may be one TCI state applied to both UL and DL or may be two respective TCI states applied to UL and DL.

At least one of the plurality of TCI states configured by the RRC parameter and the plurality of TCI states activated by the MAC CE may be referred to as a TCI pool (common TCI pool, joint TCI pool, TCI state pool). The plurality of TCI states activated by the MAC CE may be referred to as an active TCI pool (active common TCI pool).

Note that, in the present disclosure, a higher layer parameter (RRC parameter) that configures a plurality of TCI states may be referred to as configuration information that configures a plurality of TCI states or simply as “configuration information.” In the present disclosure, one of a plurality of TCI states being indicated by using DCI may be receiving indication information indicating one of a plurality of TCI states included in DCI or may simply be receiving “indication information.”

In the example in FIG. 1B, an RRC parameter configures a plurality of TCI states for both DL and UL (joint common TCI pool). A MAC CE may activate a plurality of TCI states (active TCI pool) among the plurality of configured TCI states. Respective (different, separate) active TCI pools for UL and DL may be configured/activated.

DL DCI or a new DCI format may select (indicate) one or more (for example, one) TCI states. The selected TCI state(s) may be applied to one or more (or all) DL channels/RSs. The DL channel(s) may be a PDCCH/PDSCH/CSI-RS(s). The UE may determine the TCI state of each of the DL channels/RSs by using operation of a TCI state (TCI framework) of Rel. 16. UL DCI or a new DCI format may select (indicate) one or more (for example, one) TCI states. The selected TCI state(s) may be applied to one or more (or all) UL channels/RSs. The UL channel(s) may be a PUSCH/SRS/PUCCH(s). Thus, different pieces of DCI may indicate a UL TCI and a DL DCI separately.

Existing DCI format 1_1/1_2 may be used for indication of a common TCI state.

The DCI format indicating a TCI state may be a specific DCI format. For example, the specific DCI format may be DCI format 1_1/1_2 (defined in Rel. 15/16/17).

The DCI format indicating a TCI state (DCI format 1_1/1_2) may be a DCI format without DL assignment. In the present disclosure, a DCI format without DL assignment, a DCI format not scheduling a PDSCH (DCI format 1_1/1_2), a DCI format not including one or more specific fields (DCI format 1_1/1_2), a DCI format with one or more specific fields being set at a fixed value(s) (DCI format 1_1/1_2), and the like may be interchangeably interpreted.

For a DCI format without DL assignment (DCI format not including one or more specific fields), the specific field(s) may be a field(s) other than a TCI field, a DCI format identifier field, a carrier indicator field, a bandwidth part (BWP) indicator field, a time domain resource assignment (TDRA) field, a Downlink Assignment Index (DAI) field (if configured), a transmission power control (TPC) command field (for a scheduled PUCCH), a PUCCH resource indicator field, and PDSCH-to-HARQ-ACK feedback timing indicator (PDSCH-to-HARQ feedback timing indicator) field (if present). The specific field(s) may be set as a reserved field(s) or may be ignored.

For a DCI format without DL assignment (DCI format with one or more specific fields being set at a fixed value(s)), the specific field(s) may be a redundancy version (RV) field, a modulation and coding scheme (MCS) field, a new data indicator field, and a frequency domain resource assignment (FDRA) field.

The RV field may be entirely set at 1. The MCS field may be entirely set at 1. The NDI field may be set at 0. A Type 0 FDRA field may be entirely set at 0. A Type 1 FDRA field may be entirely set at 1. An FDRA field for dynamic switch (higher layer parameter dynamicSwitch) may be entirely set at 0.

A common TCI framework may include separate TCI states for DL and UL.

### (MAC CE)

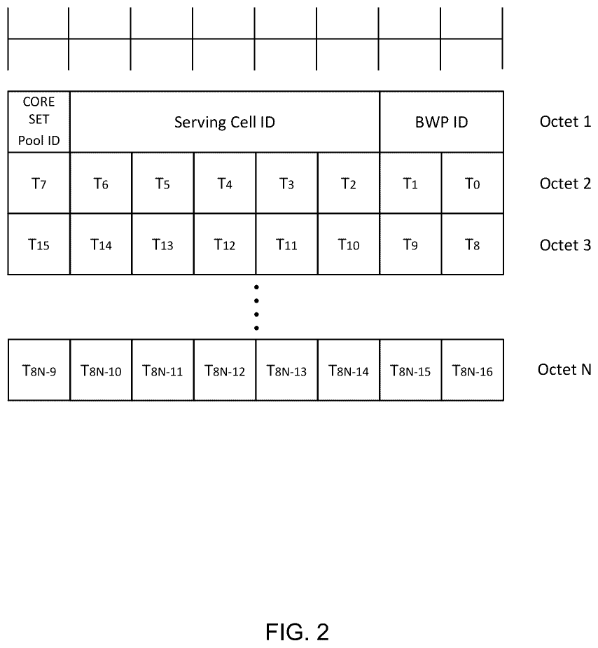

In Rel. 16, a MAC CE is used for activation/deactivation for a TCI state of a UE-specific PDSCH (TCI States Activation/Deactivation for UE-specific PDSCH MAC CE) (refer to FIG. 2).

The MAC CE is identified by a MAC subheader having a Logical Channel ID (LCID).

The MAC CE may be used in an environment of using a single TRP or multi-TRP based on multi-DCI.

The MAC CE may include a serving cell ID field, a BWP ID field, fields (Ti) each being for indicating activation/deactivation of a TCI state, and a CORESET pool ID

### FIELD

The serving cell ID field may be a field for indicating a serving cell to which the MAC CE is to be applied. The BWP ID field may be a field for indicating a DL BWP to which the MAC CE is to be applied. The CORESET pool ID field may be a field indicating that correspondence (mapping) of an activated TCI state and a TCI field codepoint indicated by DCI set in the field Ti (DCI TCI codepoint) is specific to ControlResourceSetId configured by a CORESET pool ID.

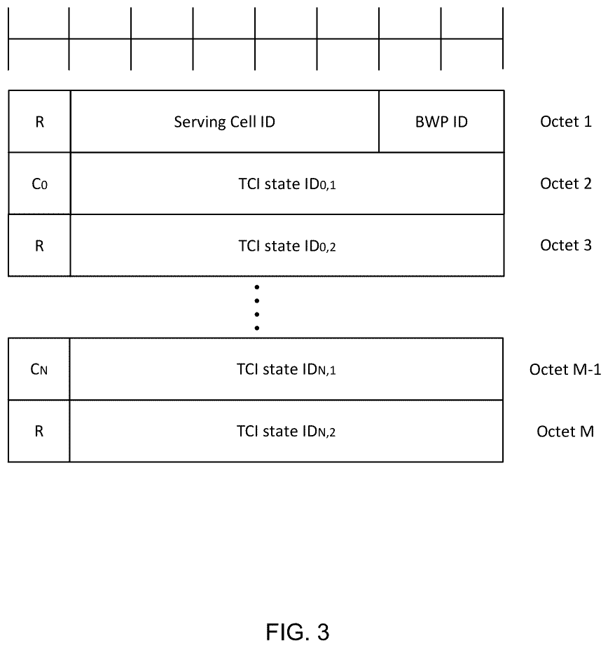

Moreover, in Rel. 16, a MAC CE is used for activation/deactivation for a TCI state of a UE-specific PDSCH (Enhanced TCI States Activation/Deactivation for UE-specific PDSCH MAC CE) (refer to FIG. 3).

The MAC CE is identified by a MAC PDU subheader having an eLCID.

The MAC CE may be used in an environment of using multi-TRP based on single DCI.

The MAC CE may include a serving cell ID field, BWP ID field, fields each being for indicating a TCI state identified by TCI-StateID (TCI state IDi,j (where i is an integer from 0 to N, and j is 1 or 2)), fields (Ci) each indicating whether or not TCI state IDi,2 is present in a corresponding octet, and a reserved bit field (R, set at 0).

“i” may correspond to the index of the TCI field codepoint indicated by DCI. “TCI state IDi,j” may indicate the j-th TCI state of the i-th TCI field codepoint.

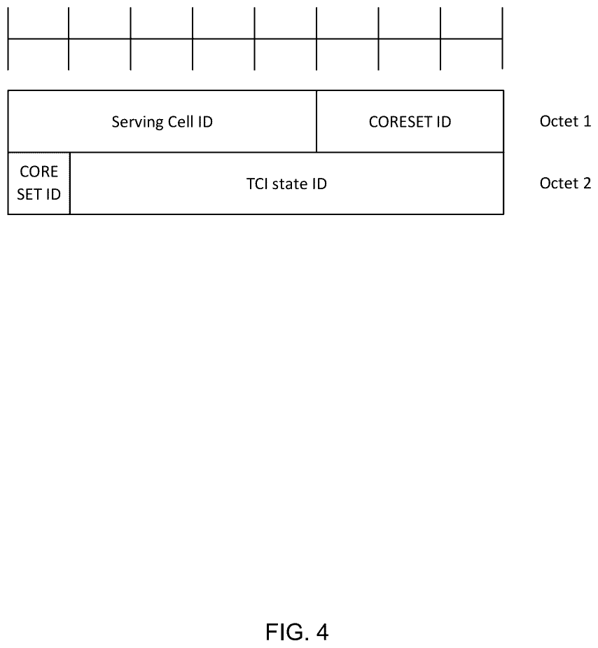

Moreover, in Rel. 16, a MAC CE is used for activation/deactivation for a TCI state of a UE-specific PDCCH/CORESET (TCI State Indication for UE-specific PDCCH MAC CE) (refer to FIG. 4).

The MAC CE is identified by a MAC subheader having an LCID.

The MAC CE may include a serving cell ID field, a field indicating a CORESET (CORESET ID) to which a TCI state is indicated, and a field for indicating a TCI state applicable to the CORESET identified by CORESET ID (TCI state ID).

### (Beam Application Time (BAT))

In DCI-based beam indication in Rel. 17, studies 1 and 2 below are studied related to application time of indication of a beam/unified TCI state.

### {Study 1}

It is studied that the first slot to which indicated TCI is applied is at least Y symbol(s) after the last symbol of acknowledgement (ACK) for joint or separate DL/UL beam indication. It is studied that the first slot to which indicated TCI is applied is at least Y symbol(s) after the last symbol of ACK/negative acknowledgement (NACK) for joint or separate DL/UL beam indication. The Y symbol(s) may be configured by a base station, based on UE capability reported by a UE. The UE capability may be reported in symbol units.

The ACK may be ACK for a PDSCH scheduled by beam indication DCI. No PDSCH may be scheduled by beam indication DCI. In this case, the ACK may be ACK for beam indication DCI.

It is studied to configure, for DCI-based beam indication of Rel. 17, at least one Y symbol(s) is configured for a UE for each BWP/CC.

When SCS is different among a plurality of CCs, the value of Y symbol(s) is also different, which may cause application time to be different among the plurality of CCs.

### {Study 2}

In a case of CA, an application time point of the beam indication may follow any of choices 1 to 3 below.
{Choice 1}Both the first slot and the Y symbol(s) are determined on a carrier with the smallest SCS among one or more carriers to which the beam indication is applied.
{Choice 2}Both the first slot and the Y symbol(s) are determined on a carrier with the smallest SCS among the one or more carriers to which the beam indication is applied and a UL carrier carrying the ACK.
{Choice 3}Both the first slot and the Y symbol(s) are determined on a UL carrier carrying the ACK.

Commonalizing a beam among a plurality of CCs in CA is studied as a CC simultaneous beam update function of Rel. 17. According to study 2, application time is in common to a plurality of CCs.

Application time (Y symbol(s)) of beam indication for CA may be determined on a carrier with the smallest SCS among carriers to which the beam indication is applied. MAC CE based beam indication of Rel. 17 (when only a single TCI codepoint is activated), this may follow a Rel-16 application time line of MAC CE activation.

Based on these studies, it is studied to define the following operation in a specification.

### {Operation}

When a UE transmits the last symbol of a PUCCH with HARQ-ACK information corresponding to DCI reporting TCI state indication, application of an indicated TCI state with a Rel-17 TCI state may be initiated from the first slot at least Y symbol(s) after the last symbol of the PUCCH. Y may be a higher layer parameter (for example, BeamAppTime_r17 [symbol]). Both the first slot and the Y symbol(s) may be determined on a carrier with the smallest SCS among carriers to which the beam indication is applied. The UE may assume one indicated TCI state with a Rel-17 TCI state for DL and UL or may assume one indicated TCI state with Rel-17 TCI state for UL (separately from DL), at a given time point.

Instead of Y [symbol], X [ms] may be used.

Related to application time, it is studied that a UE reports at least one of UE capabilities 1 and 2 below.

### {UE Capability 1}

Minimum application time per SCS (minimum value of Y symbol(s) between the last symbol of a PUCCH carrying ACK and the first slot to which a beam is applied).

### {UE Capability 2}

Minimum time gap between the last symbol of a beam indication PDCCH (DCI) and the first slot to which a beam is applied. The gap between the last symbol of a beam indication PDCCH (DCI) and the first slot to which a beam is applied may satisfy the UE capability (minimum time gap).

UE capability 2 may be existing UE capability (for example, timeDurationForQCL).

The relationship between indication of a beam and a channel/RS to which the beam is applied may satisfy at least one of UE capabilities 1 and 2.

### (Application of Artificial Intelligence (AI) Technology to Radio Communication)

For future radio communication technologies, it is studied to utilize the AI technology, such as machine learning (ML), for control, management, and the like of networks/devices.

For example, for future radio communication technologies, it is studied to utilize beam quality predicted by using AI/ML for future beam indication. AI/ML enables prediction of beam quality.

It is studied that a BAT from HARQ-ACK related to beam indication is at least one value configured/defined (in advance) for TCI states defined in Rel. 17 or later versions.

For Rel. 17, it is studied not to support beam pattern indication (sequence of TCI states).

### (Analysis)

As described above, for Rel. 17 or later versions, it is studied to use a TCI state field (TCI field, 3 bits at maximum) included in a DCI format (for example, DCI format 1_1/1_2 without/with DL assignment) to indicate one or more TCI states (common TCI state(s)), for a UE.

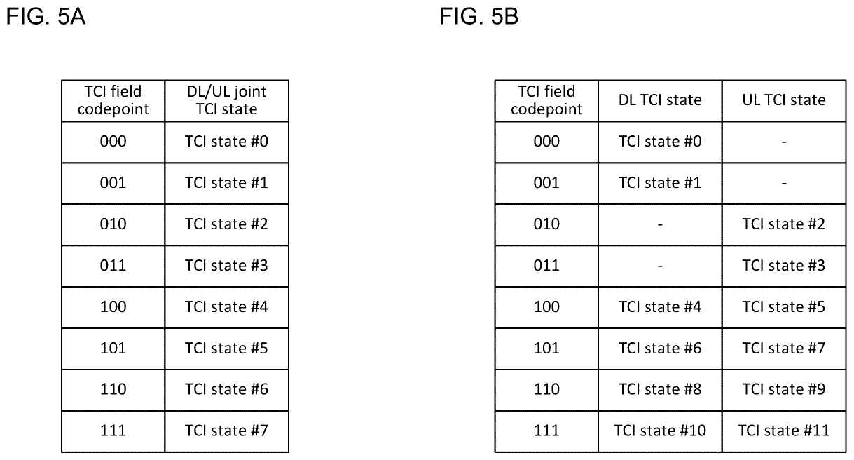

FIG. 5A is a diagram to show an example of joint TCI state indication. As shown in FIG. 5A, in the joint TCI state indication, one TCI field codepoint may correspond to one joint TCI state (DL/UL joint TCI state). A UE may determine a TCI state (DL/UL joint TCI state) to apply to a DL channel/signal and a UL channel/signal, based on the indicated TCI field codepoint.

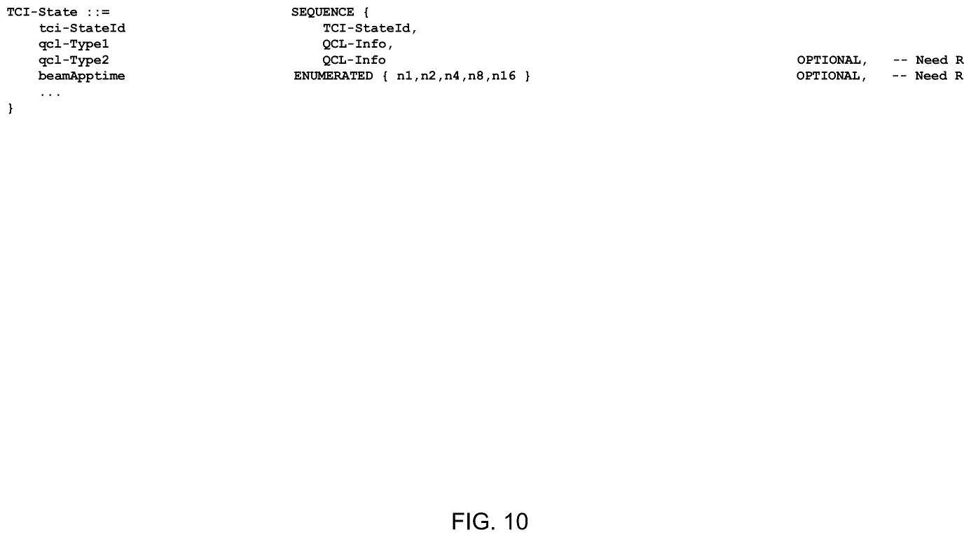

FIG. 5B is a diagram to show an example of separate TCI state indication. As shown in FIG. 5B, in the separate TCI state indication, one TCI field codepoint may correspond to one or two TCI states. The two respective TCI states may be a DL (separate) TCI state and a UL (separate) TCI state. A UE may determine a TCI state to apply to a DL channel/signal and a TCI state to apply to a UL channel/signal, based on the indicated TCI field codepoint. When the UE is notified of a TCI field codepoint corresponding to only one TCI state (for example, the codepoint “000” in FIG. 10B), the UE may continue/indicate, for a TCI state not indicated (for example, a UL TCI state in a case of the codepoint “000” in FIG. 5B), the UL TCI state applied until the notification.

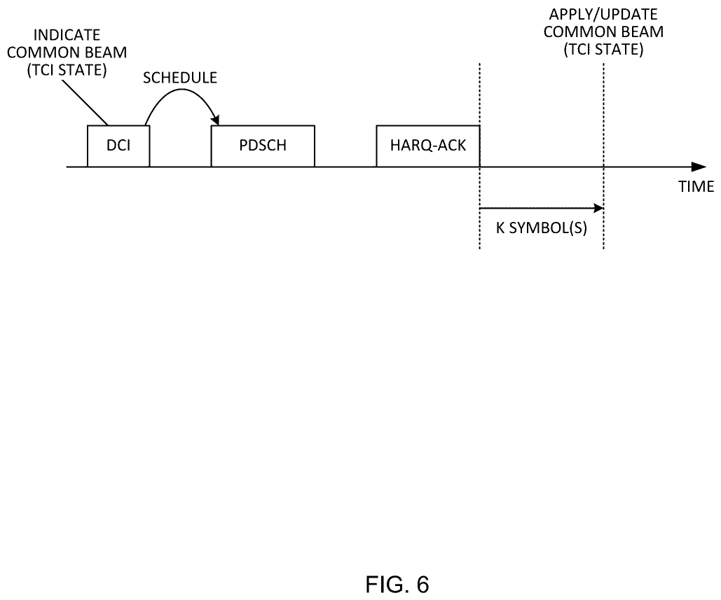

For Rel. 17 or later versions, a time line related to a period from TCI state indication (which may be referred to as “beam indication”) to application of an indicated TCI state is studied. The timing after beam indication reception to application of a TCI state (which may be referred to as beam application timing (BAT)) may be timing a specific time (for example, K symbol(s)) after transmission of HARQ-ACK for a PDSCH scheduled by DCI indicating a TCI state (refer to FIG. 6). The timing may be the first slot after at least a specific time (for example, K symbol(s)). In the present disclosure, BAT, beam application initiation timing, K symbol(s), Y symbol(s), X [ms], a time offset, and a timing offset may be interchangeably interpreted.

The K may be determined based on higher layer signaling (RRC parameter) based on capability information reported by a UE (UE Capability Information, for example “timeDurationForQCL-rel18”). Note that BAT for specific subcarrier spacing may be configured for a plurality of (for example, all the) CCs/BWPs for which a common TCI state ID of a common TCI state in carrier aggregation (CA) is configured.

Meanwhile, study about application of a unified TCI state is not sufficient in some cases. For example, study about dynamic indication of a time line (for example, BAT described above) from indication of a beam (TCI state) to application is not sufficient. Moreover, for example, study about indication of a beam pattern for a unified TCI state is not sufficient. Unless such studies are sufficient, degradation in communication quality, throughput reduction, and the like may occur.

Thus, the inventors of the present invention came up with the idea of a method of appropriately configuring/indicating/applying a TCI state. Note that, each of the embodiments of the present disclosure may be applied when AI/prediction is not used.

In one embodiment of the present disclosure, a terminal (user terminal, User Equipment (UE))/base station (BS) performs training of an ML model in a training mode and performs the ML model in a test mode (also referred to as a testing mode and the like). In the test mode, validation of the accuracy of the ML model trained in the training mode (trained ML model) may be performed.

In the present disclosure, the UE/BS may input channel state information, a reference signal measurement value, and the like to the ML model and output highly accurate channel state information/measured value/beam selection/position, future channel state information/radio link quality, and the like.

Note that, in the present disclosure, AI may be interpreted as an object (also referred to as a target, data, function, program, and the like) having (implementing) at least one of the following features:
estimation based on observed or collected information,
selection based on observed or collected information, and
prediction based on observed or collected information.

In the present disclosure, the object may be, for example, an apparatus, a device, or the like, such as a terminal or a base station. The object may correspond to a program included in the apparatus.

Note that, in the present disclosure, the ML model may be interpreted as an object having (implementing) at least one of the following features:
feeding information to thereby generate an estimated value,
feeding information to thereby predict an estimated value,
feeding information to thereby find a feature, and
feeding information to thereby select an operation.

In the present disclosure, the ML model may be interpreted as at least one of a model, an AI model, predictive analytics, a predictive analytics model, and the like. The ML model may be derived by using at least one of regression analysis (for example, linear regression analysis, multiple regression analysis, logistic regression analysis), support vector machine, random forest, neural network, deep learning, and the like. In the present disclosure, a model may be interpreted as at least one of an encoder, a decoder, a tool, and the like.

The ML model outputs at least one piece of information among an estimated value, a predicted value, a selected operation, classification, and the like, based on the input information.

Examples of the ML model may include supervised learning, unsupervised learning, and reinforcement learning. The supervised learning may be used to perform learning of a general rule for mapping an input to an output. The unsupervised learning may be used to perform learning of characteristics of data. The reinforcement learning may be used to perform learning of operation for maximizing a goal.

In each of the embodiments to be described below, description will be given mainly by assuming a case of using supervised learning for an ML model, but this is not restrictive.

In the present disclosure, “perform,” “manage,” “operate,” “carry out,” and the like may be interchangeably interpreted. In the present disclosure, test, after-training, substantial use, actual use, and the like may be interchangeably interpreted. A signal may be interpreted as a signal/channel and vice versa.

In the present disclosure, the training mode may correspond to a mode in which a UE/BS transmits/receives a signal for an ML model (in other words, an operation mode in a training period). In the present disclosure, the test mode may correspond to a mode in which a UE/BS performs an ML model (for example, performs a trained ML model to predict an output) (in other words, an operation mode in a test period).

In the present disclosure, the training mode may mean a mode in which, as a specific signal to be transmitted in the test mode, the specific signal with high overhead (for example, a large resource amount) is transmitted.

In the present disclosure, the training mode may mean a mode in which a first configuration (for example, a first DMRS configuration, a first CSI-RS configuration) is referred to. In the present disclosure, the test mode may mean a mode in which a second configuration (for example, a second DMRS configuration, a second CSI-RS configuration), which is different from the first configuration, is referred to. In the first configuration, a larger number of at least one of time resources, frequency resources, coding resources, ports (antenna ports) related to measurement than those in the second configuration may be configured.

In the present disclosure, estimation, prediction, and inference may be interchangeably interpreted. In the present disclosure, “estimate,” “predict,” and “infer” may be interchangeably interpreted.

Embodiments according to the present disclosure will be described in detail with reference to the drawings as follows. The radio communication methods according to respective embodiments may each be employed individually, or may be employed in combination.

In the present disclosure, “A/B/C” and “at least one of A, B, and C” may be interchangeably interpreted. In the present disclosure, a cell, a serving cell, a CC, a carrier, a BWP, a DL BWP, a UL BWP, an active DL BWP, an active UL BWP, and a band may be interchangeably interpreted. In the present disclosure, an index, an ID, an indicator, and a resource ID may be interchangeably interpreted. In the present disclosure, a sequence, a list, a set, a group, a cluster, a subset, and the like may be interchangeably interpreted. In the present disclosure, “support,” “control,” “controllable,” “operate,” and “operable” may be interchangeably interpreted.

In the present disclosure, configuration (configure), activation (activate), update, indication (indicate), enabling (enable), specification (specify), and selection (select) may be interchangeably interpreted.

In the present disclosure, the higher layer signaling may be, for example, any one or combinations of Radio Resource Control (RRC) signaling, Medium Access Control (MAC) signaling, broadcast information, and the like. In the present disclosure, RRC, RRC signaling, an RRC parameter, a higher layer, a higher layer parameter, an RRC information element (IE), an RRC message, and a configuration may be interchangeably interpreted.

The MAC signaling may use, for example, a MAC control element (MAC CE), a MAC Protocol Data Unit (PDU), or the like. In the present disclosure, a MAC CE, an update command, and an activation/deactivation command may be interchangeably interpreted.

The broadcast information may be, for example, a master information block (MIB), a system information block (SIB), minimum system information (Remaining Minimum System Information (RMSI), SIB1), other system information (OSI), or the like.

In the present disclosure, a beam, a spatial domain filter, spatial setting, a TCI state, a UL TCI state, a unified TCI state, a unified beam, a common TCI state, a common beam, TCI assumption, QCL assumption, a QCL parameter, a spatial domain reception filter, a UE spatial domain reception filter, a UE receive beam, a DL beam, a DL receive beam, DL precoding, a DL precoder, a DL-RS, an RS of QCL type D in a TCI state/QCL assumption, an RS of QCL type A in a TCI state/QCL assumption, a spatial relation, a spatial domain transmission filter, a UE spatial domain transmission filter, a UE transmit beam, a UL beam, a UL transmit beam, UL precoding, a UL precoder, and a PL-RS may be interchangeably interpreted. In the present disclosure, a QCL type X-RS, a DL-RS associated with QCL type X, a DL-RS having QCL type X, a DL-RS source, an SSB, a CSI-RS, and an SRS may be interchangeably interpreted.

In the present disclosure, a panel, a UE panel, a panel group, a beam, a beam group, a precoder, an Uplink (UL) transmission entity, a transmission/reception point (TRP), a base station, spatial relation information (SRI), a spatial relation, an SRS resource indicator (SRI), a control resource set (CORESET), a Physical Downlink Shared Channel (PDSCH), a codeword (CW), a transport block (TB), a reference signal (RS), a base station, an antenna port of a given signal (for example, a demodulation reference signal (DMRS) port), a DMRS, an antenna port group of a given signal (for example, a DMRS port group), a group for multiplexing (for example, code division multiplexing (CDM)) group, a reference signal group, a CORESET group, a Physical Uplink Control Channel (PUCCH) group, a PUCCH resource group), a resource (for example, a reference signal resource, an SRS resource), a resource set (for example, a reference signal resource set), a CORESET pool, a CORESET subset, a downlink Transmission Configuration Indication state (TCI state) (DL TCI state), an uplink TCI state (UL TCI state), a unified TCI state, a common TCI state, quasi-co-location (QCL), QCL assumption, a redundancy version (RV), and a layer (multi-input multi-output (MIMO) layer, transmission layer, spatial layer) may be interchangeably interpreted. A panel Identifier (ID) and a panel may be interchangeably interpreted. In the present disclosure, a TRP ID and a TRP may be interchangeably interpreted.

A panel Identifier (ID) and a panel may be interchangeably interpreted. In other words, a TRP ID and a TRP, a CORESET group ID and a CORESET group, and the like may be interchangeably interpreted.

In the present disclosure, a TRP, a transmission point, a panel, a DMRS port group, a CORESET pool, and one of two TCI states associated with one codepoint of a TCI field may be interchangeably interpreted.

Each of the embodiments of the present disclosure may be used for at least one of transmission/reception using a single-DCI based single TRP, transmission/reception using single-DCI based multi-TRP, and transmission/reception using multi-DCI based multi-TRP.

In the present disclosure, it may be assumed that a single PDCCH (DCI) is supported when multi-TRP uses ideal backhaul. It may be assumed that multi-PDCCH (DCI) is supported when multi-TRP use non-ideal backhaul.

Note that the ideal backhaul may be referred to as DMRS port group type 1, reference signal related group type 1, antenna port group type 1, CORESET pool type 1, and the like. The non-ideal backhaul may be referred to as DMRS port group type 2, reference signal related group type 2, antenna port group type 2, CORESET pool type 2, and the like. The name is not limited to these.

In the present disclosure, a single TRP, a single-TRP system, single-TRP transmission, and a single PDSCH may be interchangeably interpreted. In the present disclosure, multi-TRP (a plurality of TRPs), a multi-TRP system, multi-TRP transmission, and multi-PDSCH may be interchangeably interpreted. In the present disclosure, single DCI, a single PDCCH, multi-TRP based on single DCI, and two TCI states on at least one TCI codepoint being activated may be interchangeably interpreted.

In the present disclosure, a single TRP, a channel using a single TRP, a channel using one TCI state/spatial relation, multi-TRP being not enabled by RRC/DCI, a plurality of TCI states/spatial relations being not enabled by RRC/DCI, and one CORESET pool index (CORESETPoolIndex) value being not configured for any CORESET and any codepoint of a TCI field being not mapped to two TCI states may be interchangeably interpreted.

In the present disclosure, multi-TRP, a channel using multi-TRP, a channel using a plurality of TCI states/spatial relations, multi-TRP being enabled by RRC/DCI, a plurality of TCI states/spatial relations being enabled by RRC/DCI, and at least one of multi-TRP based on single DCI and multi-TRP based on multi-DCI may be interchangeably interpreted. In the present disclosure, multi-TRP based on multi-DCI and one CORESET pool index (CORESETPoolIndex) value being configured for a CORESET may be interchangeably interpreted. In the present disclosure, multi-TRP based on single DCI and at least one codepoint in a TCI field being mapped to two TCI states may be interchangeably interpreted.

In the present disclosure, TRP #1 (first TRP) may correspond to CORESET pool index=0 or may correspond to the first TCI state of two TCI states corresponding to one codepoint of a TCI field. TRP #2 (second TRP) may correspond to CORESET pool index=1 or may correspond to the second TCI state of two TCI states corresponding to one codepoint of a TCI field.

In the present disclosure, single DCI (sDCI), a single PDCCH, a multi-TRP system based on single DCI, sDCI-based MTRP, and two TCI states in at least one TCI codepoint being activated may be interchangeably interpreted.

In the present disclosure, multi-DCI (mDCI), multi-PDCCH, a multi-TRP system based on multi-DCI, mDCI-based MTRP, and two CORESET pool indices or CORESET pool index=1 (or a value equal to one or greater) being configured may be interchangeably interpreted.

QCL in the present disclosure may be interchangeably interpreted as QCL type D.

In the present disclosure, “TCI state A is of the same QCL type D as that of TCI state B,” “TCI state A and TCI state B are the same,” “TCI state A is QCL type D with TCI state B,” and the like may be interchangeably interpreted.

In the present disclosure, a codepoint of a DCI field ‘Transmission Configuration Indication,’ a TCI codepoint, a DCI codepoint, and a TCI field codepoint may be interchangeably interpreted.

In the present disclosure, a single TRP and a single frequency network (SFN) may be interchangeably interpreted. In the present disclosure, a high speed train (HST), an HST scheme, a scheme for high speed movement, scheme 1, scheme 2, an NW pre-compensation scheme, HST scheme 1, HST scheme 2, and an HST NW pre-compensation scheme may be interchangeably interpreted.

In the present disclosure, a PDSCH/PDCCH using a single TRP, a PDSCH/PDCCH based on a single TRP, and a single TRP PDSCH/PDCCH may be interchangeably interpreted. In the present disclosure, a PDSCH/PDCCH using an SFN, a PDSCH/PDCCH using an SFN in multi-TRP, a PDSCH/PDCCH based on an SFN, and an SFN PDSCH/PDCCH may be interchangeably interpreted.

In the present disclosure, receiving a DL signal (PDSCH/PDCCH) by using an SFN may mean receiving the same data (PDSCH)/control information (PDCCH) and/or by using the same time/frequency resource, from a plurality of transmission/reception points. Receiving a DL signal by using an SFN may mean receiving the same data/control information and/or by using the same time/frequency resource, by using a plurality of TCI states/spatial domain filters/beams/QCLs.

In the present disclosure, an HST-SFN scheme, an SFN scheme of Rel. 17 or later versions, a new SFN scheme, a new HST-SFN scheme, an HST-SFN scenario of Rel. 17 or later versions, an HST-SFN scheme for an HST-SFN scenario, an SFN scheme for an HST-SFN scenario, scheme 1, HST-SFN scheme A/B, HST-SFN type A/B, a Doppler pre-compensation scheme, and at least one of scheme 1 (HST scheme 1) and a Doppler pre-compensation scheme may be interchangeably interpreted.

In the present disclosure, a Doppler pre-compensation scheme, a base station pre-compensation scheme, a TRP pre-compensation scheme, a pre-Doppler compensation scheme, an NW pre-compensation scheme, an HST NW pre-compensation scheme, a TRP pre-compensation scheme, a TRP-based pre-compensation scheme, HST-SFN scheme A/B, and HST-SFN type A/B may be interchangeably interpreted. In the present disclosure, a pre-compensation scheme, a reduction scheme, an improvement scheme, and a compensation scheme may be interchangeably interpreted.

In the present disclosure, PDCCHs/search spaces (SSs)/CORESETs having a linkage, linked PDCCHs/SSs/CORESETs, and a pair of PDCCHs/SSs/CORESETs may be interchangeably interpreted. In the present disclosure, a PDCCH/search space (SS)/CORESET having no linkage, a not linked PDCCH/SS/CORESET, and a single PDCCH/SS/CORESET may be interchangeably interpreted.

In the present disclosure, two linked CORESETs for PDCCH repetition and two CORESETs associated with two respective linked SS sets may be interchangeably interpreted.

In the present disclosure, SFN-PDCCH repetition, PDCCH repetition, two linked PDCCHs, one DCI being received over two linked search spaces (SSs)/CORESETs may be interchangeably interpreted.

In the present disclosure, PDCCH repetition, SFN-PDCCH repetition, PDCCH repetition for higher reliability, a PDCCH for higher reliability, a PDCCH for reliability, and two linked PDCCHs may be interchangeably interpreted.

In the present disclosure, a PDCCH reception method, PDCCH repetition, SFN-PDCCH repetition, an HST-SFN, and an HST-SFN scheme may be interchangeably interpreted.

In the present disclosure, a PDSCH reception method, single-DCI based multi-TRP, and an HST-SFN scheme may be interchangeably interpreted.

In the present disclosure, single-DCI based multi-TRP repetition may be NCJT of an enhanced mobile broadband (eMBB) service (low priority, priority degree 0), or may be repetition of a URLLC service, that is, a ultra-reliable and low latency communications service (high priority, priority degree 1).

In each of the embodiments of the present disclosure, a PDSCH for a plurality of TRPs based on single DCI and a PDSCH to which TDM/FDM/SDM for a plurality of TRPs (defined in Rel. 16) may be interchangeably interpreted.

In each of the embodiments of the present disclosure, a PDSCH for a plurality of TRPs and a PDSCH to which TDM/FDM/SDM for a plurality of TRPs based on single DCI (defined in Rel. 16) may be interchangeably interpreted.

In each of the embodiments of the present disclosure, a PUSCH/PUCCH/PDCCH for a plurality of TRPs based on single DCI and repetition transmission (repetition) of a PUSCH/PUCCH/PDCCH for a plurality of TRPs (defined in Rel. 17 or later versions) may be interchangeably interpreted.

In each of the embodiments of the present disclosure, an SFN PDSCH/PDCCH and an SFN PDSCH/PDCCH defined in Rel. 17 or later versions may be interchangeably interpreted.

In each of the embodiments of the present disclosure, use of a plurality of TRPs based on multi-DCI being configured may mean that CORESET pool index=1 is configured. Alternatively, use of a plurality of TRPs based on multi-DCI being configured may mean that two different values (for example, 0 and 1) of a CORESET pool index are configured.

In each of the embodiments of the present disclosure, UL transmission using a plurality of panels may mean a UL transmission scheme using a plurality of panels of a UE by DCI enhancement.

In each of the embodiments of the present disclosure, if a joint TCI state/separate TCI state in a unified TCI state framework is not applicable to each channel/signal, the above-described default TCI state/QCL/spatial relation may be used to determine the TCI state/QCL/spatial relation of the channel.

Each of the embodiments of the present disclosure below may be applied to transmission/reception of any channel/signal being a target of application of a unified TCI state framework defined in Rel. 17 or later versions described above.

In the present disclosure, applying a TCI state to each channel/signal/resource may mean applying a TCI state to transmission/reception of each channel/signal/resource.

In the present disclosure, small, little, short, and low may be interchangeably interpreted. In the present disclosure, “ignore,” “drop,” and the like may be interchangeably interpreted.

In the present disclosure, “highest (largest)” and “lowest (smallest)” may be interchangeably interpreted. In the present disclosure, “the largest” may be interpreted as the “n-th (where n is any natural number)” largest, larger, higher, and the like, and vice versa. In the present disclosure, “the smallest” may be interpreted as the “n-th (where n is any natural number)” smallest, smaller, lower, and the like, and vice versa.

In the present disclosure, repetition, repetition transmission, and repetition reception may be interchangeably interpreted.

In the present disclosure, a channel, a signal, and a channel/signal may be interchangeably interpreted. In the present disclosure, a DL channel, a DL signal, a DL signal/channel, transmission/reception of a DL signal/channel, DL reception, and DL transmission may be interchangeably interpreted. In the present disclosure, a UL channel, a UL signal, a UL signal/channel, transmission/reception of a UL signal/channel, UL reception, and UL transmission may be interchangeably interpreted.

In the present disclosure, a first TCI state may correspond to a first TRP. In the present disclosure, a second TCI state may correspond to a second TRP. In the present disclosure, an n-th TCI state may correspond to an n-th TRP.

In the present disclosure, the value of a first CORESET pool index (for example, 0), the value of a first TRP index (for example, 1), and a first TCI state (first DL/UL (joint/separate) TCI state) may correspond to each other. In the present disclosure, the value of a second CORESET pool index (for example, 1), the value of a second TRP index (for example, 2), and a second TCI state (second DL/UL (joint/separate) TCI state) may correspond to each other.

In the present disclosure, timing, a time point, a time, a time instance, a slot, a sub-slot, a symbol, a subframe, and the like may be interchangeably interpreted.

### (Radio Communication Method)

Each of the embodiments/aspects/options/choices/modification examples of the present disclosure may be used based on at least one of the following conditions:
configuration of a (explicitly) corresponding higher layer parameter,
configuration of a (implicitly) related higher layer parameter,
indication of a MAC CE/(field included in) DCI,
(reported) UE capability,
definition in a specification,
specific condition defined in a specification, and
configuration/indication by at least one of a higher layer parameter, a MAC CE, DCI, and (reported) UE capability.

The embodiments/aspects/options/choices/modification examples/variations of the present disclosure may be used individually or may be used in combination.

### First Embodiment

A first embodiment relates to BAT indication.

A UE may refer to an RS indicated with a TCI state as an RS configured with a specific QCL type (for example, QCL type D) for a specific signal (if applicable). The UE may apply the TCI state to transmission/reception of one or a plurality of channels/signals.

The specific signal may be at least one of a DMRS for PDSCH, a DMRS for PDCCH, and a CSI-RS, for example.

The UE may determine to apply a TCI state indicated by using beam indication (DCI) in the first symbol/slot after the elapse of a BAT from a specific time resource (for example, a specific symbol/slot).

The specific time resource may be at least one of options 1-0-1 to 1-0-3 below.

The specific time resource may be at least one of the first/last symbol of a PUCCH with HARQ-ACK scheduled by DCI including indication of a TCI state (beam indication DCI) and a slot (for example, the first/last slot) of the PUCCH (option 1-0-1).

In the present disclosure, HARQ-ACK scheduled by given DCI and HARQ-ACK related to given DCI may be interchangeably interpreted. In the present disclosure, DCI for beam indication may be a DCI format with DL assignment or a DCI format without DL assignment.

The specific time resource may be at least one of the first/last symbol of the PDCCH of DCI including indication of a TCI state (beam indication DCI) and a slot (for example, the first/last slot) of the PDCCH (option 1-0-2).

The specific time resource may be an indicated symbol/slot/subframe (option 1-0-3). The symbol/slot/subframe may be expressed by at least one of a symbol (index) in the slot, a slot index in the subframe, and a subframe index.

A time resource in at least one of options 1-0-1 to 1-0-3 above may be defined in a specification in advance, may be configured for/indicated to a UE by using higher layer signaling (RRC/MAC CE)/DCI (beam indication DCI/DCI other than beam indication DCI), or may be determined based on UE capability information reported by a UE.

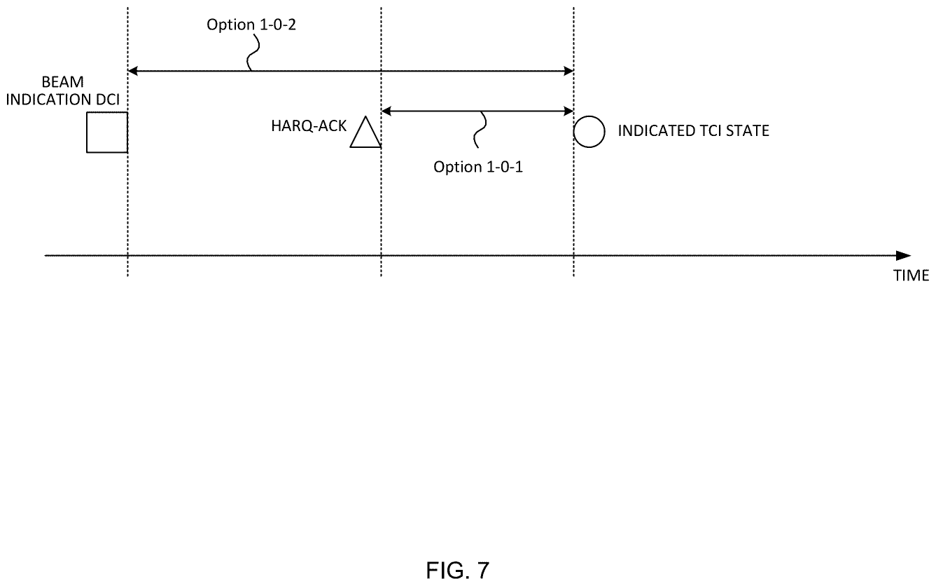

FIG. 7 is a diagram to show an example of a reference of start of a BAT according to the first embodiment. In the example shown in FIG. 7, a UE receives beam indication DCI. According to option 1-0-1 above, a specific period from the transmission of HARQ-ACK related to the DCI corresponds to the BAT. According to option 1-0-2 above, a specific period from the reception of the DCI corresponds to the BAT.

According to options 1-0-1 to 1-0-3 above, it is possible to appropriately determine a time resource being the start of a period corresponding to a BAT.

In the following, the BAT will be described.

A UE may determine to apply (a TCI state according to) beam indication after the elapse of a specific period from the time resource described in at least one of options 1-0-1 to 1-0-3 above.

The specific period may be expressed by a specific (for example, X (where X is any integer)) symbol(s)/slot(s)/subframe(s) or may be expressed by Y [ms](where Y is any number).

The specific period may be determined according to at least one of options 1-1-1 to 1-1-7 below.

### <<Option 1-1-1>>

The specific period may be a value defined in a specification in advance.

The value may be determined based on reported UE capability information and a configured higher layer parameter (RRC parameter/MAC CE field), for example.

For example, the RRC parameter may be an RRC parameter indicating enabled/disabled of beam indication of a plurality of beam application time points (BATs).

The value may be determined for each specific number of (for example, N (where N is an integer larger than 0)) TCI codepoints in a TCI field included in DCI.

The N may be defined in a specification in advance, may be configured for/indicated to a UE by using higher layer signaling (RRC/MAC CE)/DCI (beam indication DCI/DCI other than beam indication DCI), or may be determined based on UE capability information reported by a UE.

The value may be determined for each TCI state/source RS in specific QCL (QCL information). The specific QCL may be QCL corresponding to each specific number of (for example, N) TCI codepoints in a TCI field included in DCI.

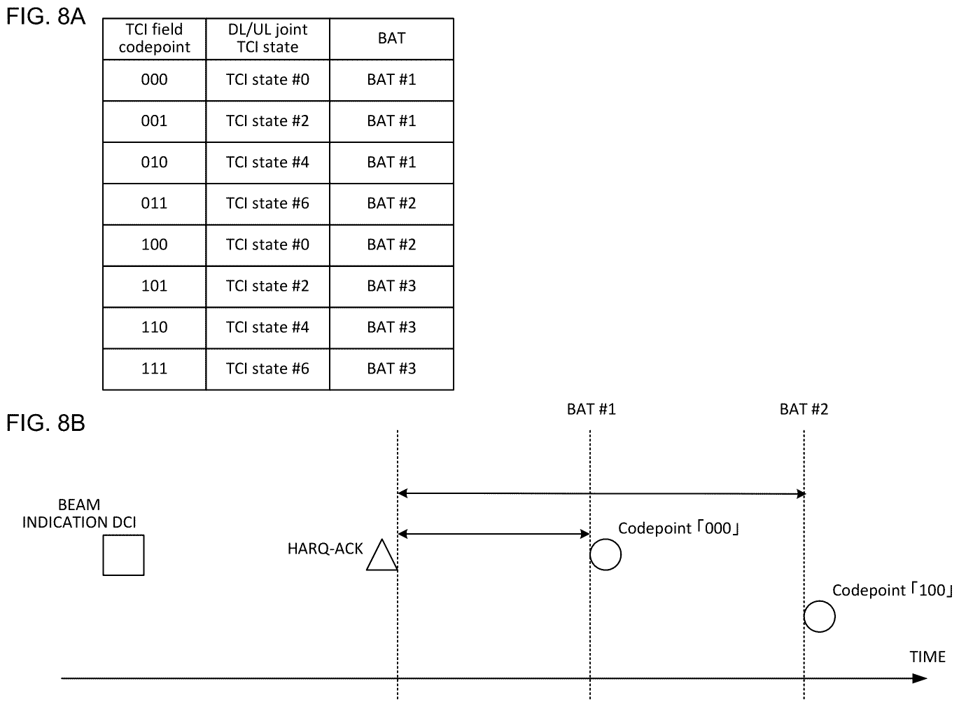

FIG. 8A and FIG. 8B are diagrams to show an example of application of a TCI state according to option 1-1-1. As shown in FIG. 8A, associations between a TCI codepoint (TCI state (joint DL/UL TCI state in the example in FIG. 8A)) and a BAT for a UE.

Note that the associations of a TCI codepoint and a TCI state described in each of the embodiments of the present disclosure are merely examples, and the number of bits of a codepoint and an indicated TCI state are not limited to the shown examples. Description will be given by mainly taking, as an example of each TCI state described in the associations, a joint DL/UL TCI state. However, each TCI state included in the associations may be a separate DL/UL TCI state.

In the example shown in FIG. 8B, when a TCI codepoint “000” is indicated to the UE by using beam indication DCI, the UE determines BAT #1 to be a BAT. When a TCI codepoint “100” is indicated to the UE by using beam indication DCI, the UE determines BAT #2 to be a BAT.

### <<Option 1-1-2>>

The specific period may be determined/configured based on a specific RRC parameter.

The specific RRC parameter may be an RRC parameter not related to (independent from) a codepoint in DCI (for example, a TCI codepoint).

The specific RRC parameter may be an RRC parameter related to an application time point of a beam (TCI state) (for example, “BeamAppTime”).

### <<Option 1-1-3>>

The specific period may be determined/configured based on a specific RRC parameter.

For example, the specific RRC parameter may be an RRC parameter for configuring the specific period for each specific number of (for example, N (where N is an integer larger than 0)) TCI codepoints in a TCI field included in DCI.

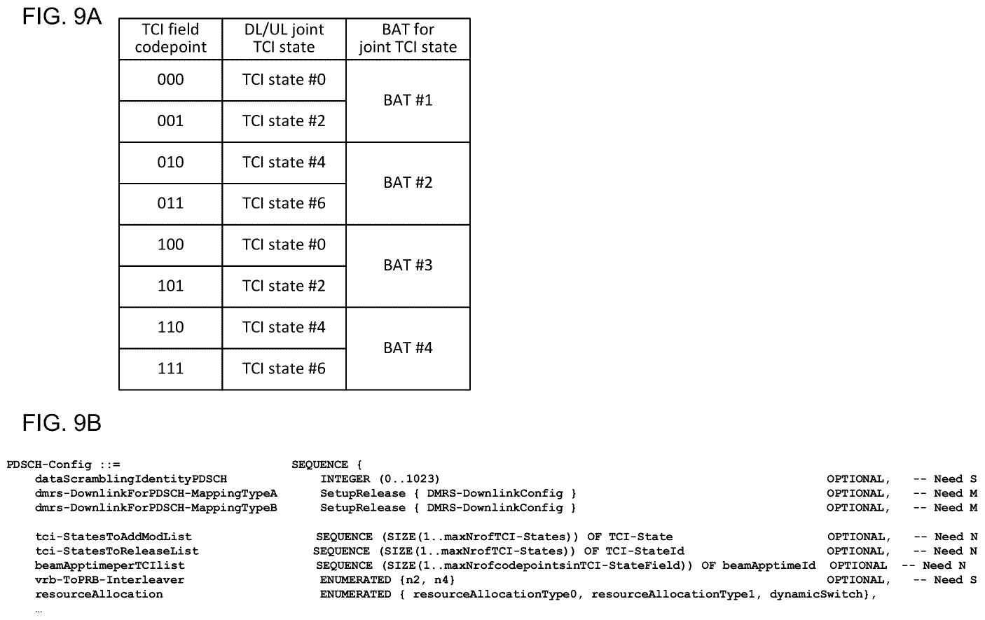

FIG. 9A and FIG. 9B are diagrams to show an example of application of a TCI state according to option 1-1-3. As shown in FIG. 9A, associations between a TCI codepoint (TCI state (joint DL/UL TCI state in the example in FIG. 9A)) and a BAT for a UE.

In the example shown in FIG. 9A, a BAT is configured for each two (N=2) TCI codepoints. In other words, four BATs are configured for a UE by an RRC parameter. The configuration may be performed in configuration of the specific RRC parameter. In the example shown in FIG. 9B, a parameter related to a beam application time point per TCI state (TCI list) (beamApptimeperTCIlist) is included in a PDSCH configuration (PDSCH-Config). The parameter related to a beam application time point (beamApptimeperTCIlist) includes the ID of a beam application time point (beamApptimeId) of the maximum number of codepoints in a corresponding TCI field (maxNrofcodepointsinTCI-StateField). The ID of a beam application time point (beamApptimeId) may be a parameter for specifying an RRC parameter related to an application time point of a beam (TCI state) (for example, “BeamAppTime”).

Note that, in the present disclosure, indication of a BAT may be indicated by the index (number) of the BAT or may be indicated by an index related to the BAT. Associations between an index related to a BAT and the value of the BAT may be configured by higher layer signaling (RRC/MAC CE) or may be defined in a specification in advance.

The maximum number of codepoints in a TCI field (maxNrofcodepointsinTCI-StateField) may be a specific number. For example, when N above is 1, the maximum number of codepoints in a corresponding TCI field (maxNrofcodepointsinTCI-StateField) may be a first value (for example, eight). For example, when N above is 2, the maximum number of codepoints in a corresponding TCI field (maxNrofcodepointsinTCI-StateField) may be a second value (for example, four).

### <<Option 1-1-4>>

The specific period may be determined/configured based on a specific RRC parameter.

For example, the specific RRC parameter may be a TCI state configuration parameter (“TCI-State”). The TCI state configuration parameter (“TCI-State”) may include an RRC parameter related to an application time point of a beam (TCI state) (for example, “beamApptime”).

FIG. 10 is a diagram to show an example of application of a TCI state according to option 1-1-4. In the example shown in FIG. 10, the TCI state configuration parameter (“TCI-State”) may include an RRC parameter related to an application time point of a beam (TCI state) (for example, “beamApptime”). The RRC parameter related to an application time point of a beam (TCI state) (for example, “beamApptime”) may indicate one value among a plurality of values (in the example in FIG. 10, n1, n2, n4, n8, or n16). Note that the plurality of values shown in FIG. 10 are merely examples, and these are not restrictive.

### Modification Example 1 of Option 1-1-4

For example, the specific RRC parameter may be a QCL information parameter (“QCL-Info”) included in the TCI state configuration parameter (“TCI-State”). The QCL information parameter (“QCL-Info”) may include an RRC parameter related to an application time point of a beam (TCI state) (for example, “beamApptime”).

The QCL information parameter (“QCL-Info”) may be indicated by at least one of a parameter indicating a first QCL type (“qcl-Type1”) and a parameter indicating a second QCL type (“qcl-Type2”).

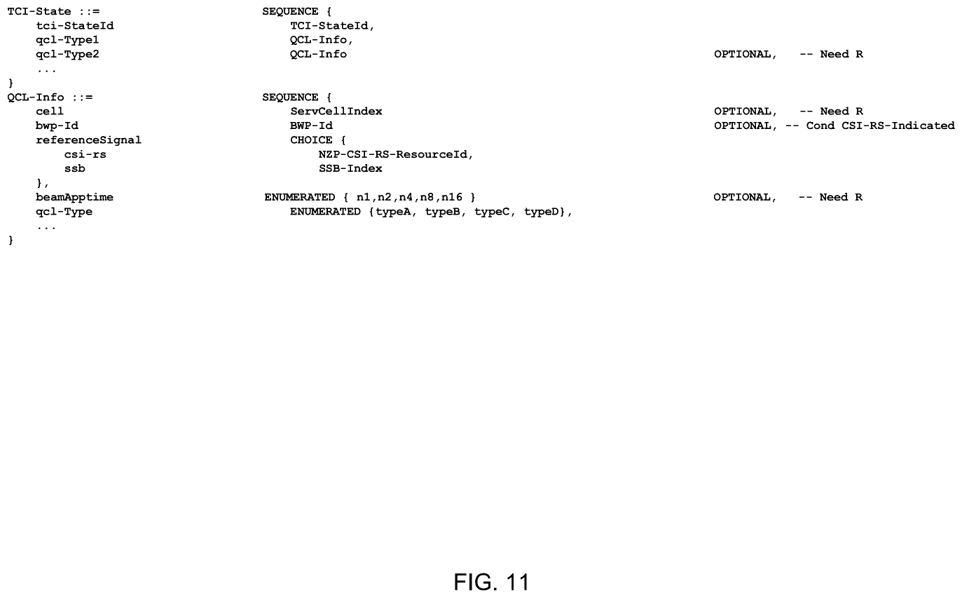

FIG. 11 is a diagram to show an example of application of a TCI state according to modification example 1 of option 1-1-4. In the example shown in FIG. 11, the TCI state configuration parameter (“TCI-State”) includes the QCL information parameter (“QCL-Info”), and the QCL information parameter (“QCL-Info”) includes an RRC parameter related to an application time point of a beam (TCI state) (for example, “beamApptime”). The RRC parameter related to an application time point of a beam (TCI state) (for example, “beamApptime”) may indicate one value among a plurality of values (in the example in FIG. 11, n1, n2, n4, n8, or n16). Note that the plurality of values shown in FIG. 11 are merely examples, and these are not restrictive.

According to this modification example, it is possible to configure independent (different) BATs depending on different QCL types (for example, QCL types A/B/C/D) and hence to perform configuration of a BAT flexibly.

### Modification Example 2 of Option 1-1-4

A UE may be configured with/notified of information related to a correspondence relationship (mapping) between TCI state IDs and IDs of BATs in at least one of option 1-1-4 above and modification example 1 above.

The ID of a BAT may be a parameter for specifying the value of the BAT. The correspondence relationship between the IDs of the BATs and the values of the BATs may be defined in a specification in advance, may be configured for/indicated to the UE by using higher layer signaling (RRC/MAC CE)/DCI, or may be determined based on reported UE capability information.

The information related to the correspondence relationship (mapping) of the TCI state IDs and the IDs of the BATs may be information associating the TCI state IDs and the IDs of the BATs. The UE may be notified of the information by using higher layer signaling (RRC/MAC CE).

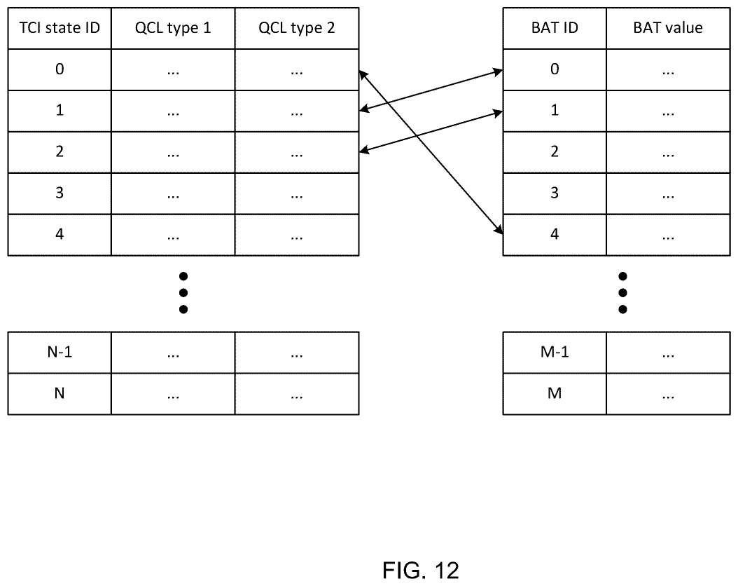

FIG. 12 is a diagram to show an example of application of a TCI state according to modification example 2 of option 1-1-4. The example shown in FIG. 12 illustrates associations related to N TCI state IDs and associations related to M BATs. The associations and information related to a correspondence relationship (mapping) between TCI state IDs and the IDs of BATs are configured for a UE. In this case, the UE determines a BAT for application of a TCI state, based on the correspondence relationship and an indicated TCI state (ID).

According to this modification example, a BAT related to a TCI state need not be indicated each time, and candidate values for the value of a BAT for each TCI state ID can be limited, which can hence reduce overhead.

### <<Option 1-1-5>>

The specific period may be determined/configured/indicated based on a parameter/field indicated by a MAC CE.

The MAC CE may be a MAC CE of at least one of options 1-1-5-1 and 1-1-5-2 below, for example.

### {Option 1-1-5-1}

The MAC CE may be a new MAC CE (defined in Rel. 17 or later versions).

A subheader of the MAC CE may include a new Logical Channel ID (LCID).

The MAC CE may include a field indicating activation of a TCI state.

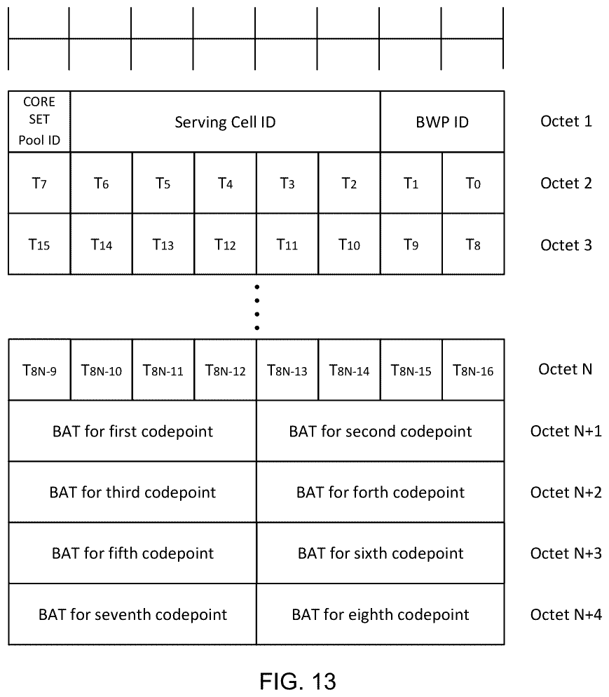

FIG. 13 is a diagram to show an example of a structure of a MAC CE according to option 1-1-5-1. A MAC CE shown in FIG. 13 includes a field indicating a CORESET pool ID, a field indicating a serving cell ID, a field indicating a BWP ID, and fields each indicating activation/deactivation of TCI state i (described as Ti).

The MAC CE shown in FIG. 13 further includes fields each indicating a BAT corresponding to an activated TCI point. A UE determines a BAT corresponding to an indicated TCI state, based on the field indicating the BAT.

### {Option 1-1-5-2}

The MAC CE may be an existing MAC CE (for example, defined in Rel. 15/16 or previous versions).

For the MAC CE, a reserved bit included in an existing MAC CE (for example, defined in Rel. 15/16 or previous versions) may be used as a field indicating whether to interpret this MAC CE as a MAC CE having a field for activation of a list of TCI states with BATs (time offsets).

The MAC CE may be a MAC CE obtained by adding a new field/octet to an existing MAC CE (for example, defined in Rel. 15/16 or previous versions).

The existing MAC CE (for example, defined in Rel. 15/16 or previous versions) may be a MAC CE for activation/deactivation of TCI states of a UE-specific PDSCH (Enhanced TCI states Activation/Deactivation for UE-specific PDSCH MAC CE), for example.

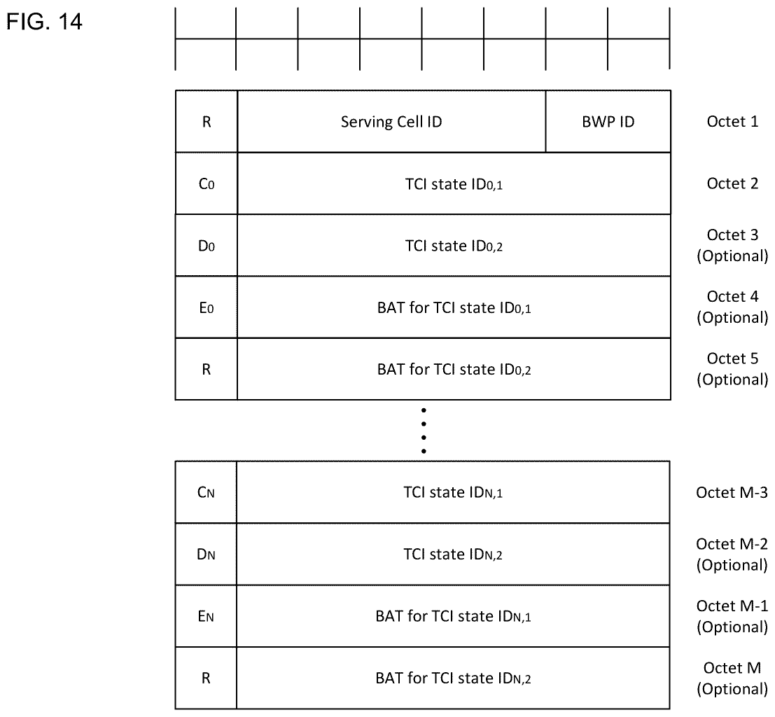

FIG. 14 is a diagram to show an example of a structure of a MAC CE according to option 1-1-5-2. The MAC CE shown in FIG. 14 may include a serving cell ID field, a BWP ID field, fields each being for indicating a TCI state identified by TCI-StateID (TCI state IDi,j (where i is an integer from 0 to N, and j is 1 or 2)), fields (Cᵢ) each indicating whether or not TCI state IDi,2 is present in a corresponding octet, and a reserved bit field (R, set at 0).

“i” may correspond to the index of the TCI field codepoint indicated by DCI. “TCI state IDi,j” may indicate the j-th TCI state of the i-th TCI field codepoint.

The MAC CE shown in FIG. 14 further includes fields each indicating presence of an octet of a BAT corresponding to (the first TCI state field corresponding to) the i-th TCI state ID (that is, TCI state IDi,1) (described as Dᵢ) and fields each indicating presence of an octet of a BAT corresponding to the second TCI state field corresponding to the i-th TCI state ID (that is, TCI state IDi,2) (described as Eᵢ).

When the Dᵢ field above indicates a first value (for example, 0 (or 1)), the UE may determine that a field indicating a BAT corresponding to TCI state IDi,1 is included. When the Dᵢ field above indicates a second value (for example, 1 (or 0)), the UE may determine that a field indicating a BAT corresponding to TCI state IDi,1 is not included.

When the Eᵢ field above indicates a first value (for example, 0 (or 1)), the UE may determine that a field indicating a BAT corresponding to TCI state IDi,2 is included. When the Eᵢ field above indicates a second value (for example, 1 (or 0)), the UE may determine that a field indicating a BAT corresponding to TCI state IDi,2 is not included.

In the example shown in FIG. 14, the UE determines a BAT corresponding to an indicated TCI state, based on the field indicating the BAT.

### <<Option 1-1-6>>

The specific period may be determined/indicated based on a specific field included in DCI.

The DCI may follow at least one of options 1-1-6-1 to 1-1-6-4 to be described below.

### {Option 1-1-6-1}

The DCI may be existing DCI (format A_B (A and B may be any positive numbers)).

For the DCI, cyclic redundancy check (CRC) of the DCI may be scrambled with an existing radio network temporary identifier (RNTI).

The DCI may include a new DCI field. The new DCI field may be a field for indicating a BAT.

For the DCI, an existing field may be used/interpreted as a field for indicating a BAT under a specific condition.

The specific condition may be a condition that a specific field (for example, at least one of an FDRA field, a TDRA field, an MCS field, an RV field, and an NDI field) is (entirely) set at a specific value (for example, 0 (or 1)), for example.

### {Option 1-1-6-2}

The DCI may be existing DCI (format A_B (A and B may be any positive numbers)).

For the DCI, CRC of the DCI may be scrambled with a new RNTI defined in Rel. 17 or later versions.

The DCI may include a new DCI field. The new DCI field may be a field for indicating a BAT.

For the DCI, an existing field may be used/interpreted as a field for indicating a BAT under a specific condition.

The specific condition may be a condition that a specific field (for example, at least one of an FDRA field, a TDRA field, an MCS field, an RV field, and an NDI field) is (entirely) set at a specific value (for example, 0 (or 1)), for example.

### {Option 1-1-6-3}

The DCI may be new DCI (format A_B (A and B may be any positive numbers)) defined in Rel. 17 or later versions.

For the DCI, CRC attached to the DCI may be scrambled with an existing RNTI.

### {Option 1-1-6-4}

The DCI may be new DCI (format A_B (A and B may be any positive numbers)) defined in Rel. 17 or later versions.

For the DCI, CRC attached to the DCI may be scrambled with a new RNTI defined in Rel. 17 or later versions.

### <<Option 1-1-7>>

A UE may apply at least two of options 1-1-1 to 1-1-6 above in combination.

For example, when a TCI field codepoint is not mapped with a BAT as shown in option 1-1-3/1-1-4 above, option 1-1-1/1-1-2 above may be used.

According to options 1-1-1 to 1-1-7 above, it is possible to appropriately determine the length (period) of a BAT.

For example, for a UE, a BAT common to a plurality of (for example, all) TCI codepoints and a differential BAT for one or some of codepoints of the plurality of TCI codepoints may be configured/indicated. The UE may determine a BAT, based on the differential BAT. This example may follow at least one of options 1-2-1 and 1-2-2 below.

### <<Option 1-2-1>>

A UE may calculate/derive/determine a BAT, based on a differential value (differential BAT) associated for a specific number of (for example, N (where N is an integer equal to or larger than 1)) TCI codepoints and a common BAT.

The common BAT may be configured by specific higher layer signaling (RRC parameter), may be defined in a specification in advance, or may be indicated by using a MAC CE/DCI. The specific RRC parameter may be an RRC parameter related to an application time point of a beam (TCI state) (for example, “BeamAppTime”), for example.

### <<Option 1-2-2>>

A UE may calculate/derive/determine a BAT, based on a differential value associated for each specific number of (for example, N (where N is an integer equal to or larger than 1)) TCI codepoints and a BAT associated with a specific TCI codepoint.

For example, the UE may calculate/derive/determine a BAT, based on a BAT value associated with the specific TCI codepoint and a differential value associated with a TCI codepoint other than the specific TCI codepoint.

For example, the BAT corresponding to each TCI codepoint may be calculated/derived/determined based on the total of the BAT value associated with the specific TCI codepoint and the BAT associated with the TCI codepoint (and the common BAT).

The specific TCI codepoint may be the TCI codepoint corresponding to the highest (or lowest) codepoint index among lower (or higher) codepoint indices associated with different values, for example.

Note that a differential BAT value may be determined based on at least one method (option) described in the first embodiment. For the differential BAT value, positive and negative values may be supported.

According to option 1-2-2, it is enough to configure a differential value having a bit width smaller than that in option 1-2-1, which can reduce overhead required for configuration of a BAT.

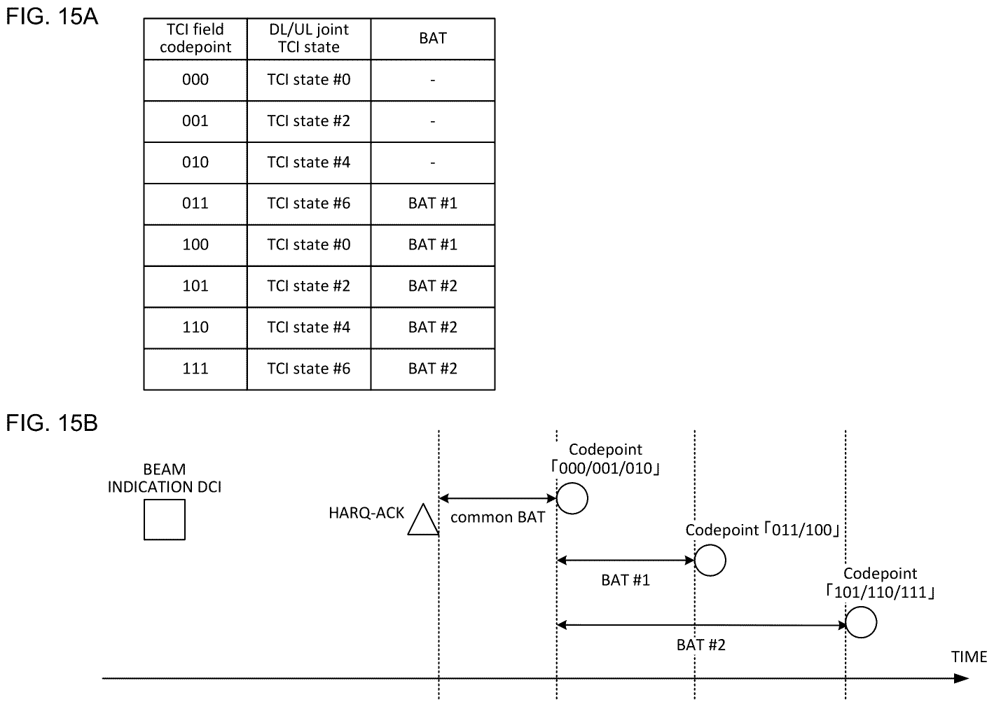

FIG. 15A and FIG. 15B are diagrams to show an example of application of a TCI state according to option 1-2-1. In the example shown in FIG. 15A and FIG. 15B, a UE receives beam indication DCI and applies a TCI state indicated by the DCI.

In the example shown in FIG. 15A, a correspondence relationship of TCI codepoints, TCI states (although joint DL/UL TCI states are shown in the example in FIG. 15A, separate TCI states may be used), and BATs (differential BATs) is configured for the UE. For the UE, a common BAT is configured/defined.

In the example shown in FIG. 15B, when 000/001/010 is indicated as a TCI codepoint for the UE, the UE determines that the BAT is the common BAT. When 011/100 is indicated as a TCI codepoint for the UE, the UE determines that a BAT is a value obtained by adding (a value corresponding to) BAT #1 to the common BAT. When 101/110/111 is indicated as a TCI codepoint for the UE, the UE determines that the BAT is a value obtained by adding (a value corresponding to) BAT #2 to the common BAT.

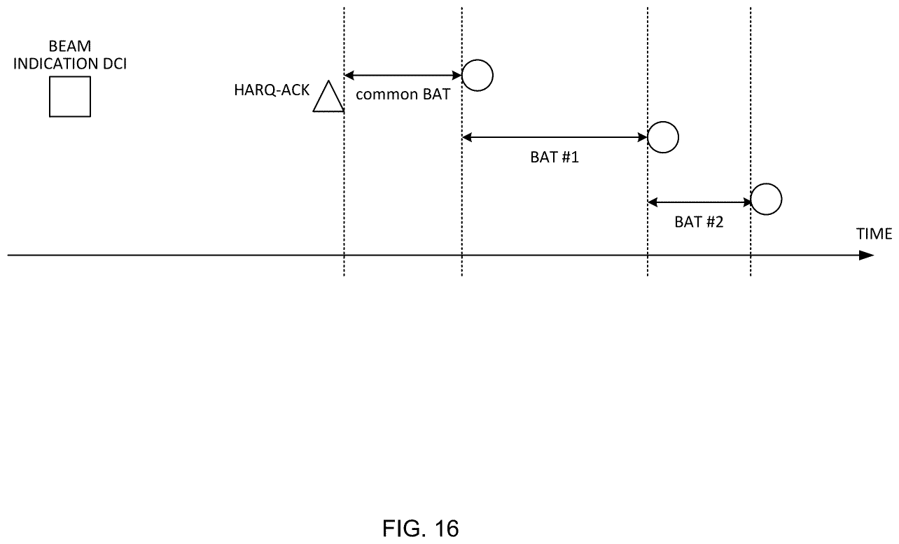

FIG. 16 is a diagram to show an example of application of a TCI state according to option 1-2-2. In the example shown in FIG. 16, a UE receives beam indication DCI and applies a TCI state indicated by the DCI. Note that the example shown in FIG. 16 shows an example also applied to option 1-2-1 above in addition to option 1-2-2.

In the example shown in FIG. 16, for the UE, a common BAT is configured/defined. For the UE, a correspondence relationship between TCI codepoints, TCI states, and BATs is also configured.

In the example shown in FIG. 16, when (a TCI codepoint corresponding to) the largest BAT among the BATs in the correspondence relationship is indicated for the UE, the UE determines a value obtained by adding the largest BAT (BAT #1 in the example in FIG. 16) and the common BAT, to be a BAT. When (a TCI codepoint corresponding to) a BAT other than the largest BAT is indicated for the UE, the UE determines that a value obtained by adding the largest BAT value (BAT #1) and a BAT other than the largest BAT (BAT #2 in the example shown in FIG. 16), to be a BAT.

According to options 1-2-1 and 1-2-2 above, it is possible to configure/indicate a BAT with reduced overhead.

In the following, quantization of a field related to a BAT will be described.

A UE may determine a time offset (BAT) value, based on a BAT of quantized bits (bit field). This example may follow at least one of options 1-3-1 and 1-3-2 below.

### <<Option 1-3-1>>

Associations between a BAT bit field/BAT ID and a BAT value may be configured for a UE by using higher layer signaling (RRC signaling).

For example, the UE may be configured with (associations including) a plurality of BAT values by using RRC signaling. Then, the UE may determine one (or one or more) BAT value from among the plurality of BAT values.

If associations including only one BAT value are configured for the UE by using RRC signaling, the UE need not receive the quantized bits indicating the BAT value (bit field indicating the BAT).

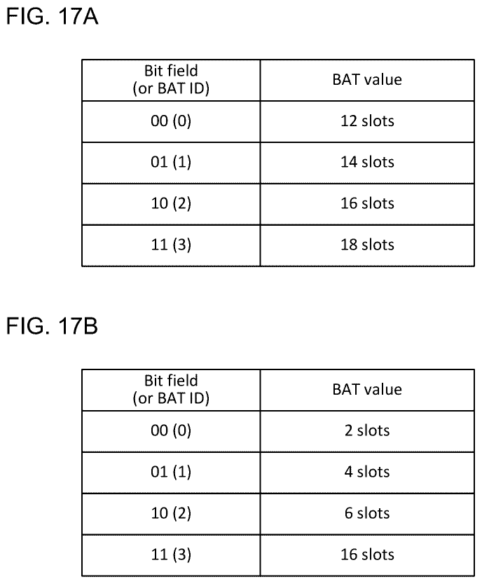

FIG. 17A is a diagram to show an example of associations of BAT values according to option 1-3-1. The UE may be configured with associations between a bit field (or BAT ID) and a BAT value as those shown in FIG. 17A, and determine a BAT, based on indicated quantized bits (bit field indicating a BAT).

Note that the values and terms of the fields shown in FIG. 17A are merely examples, and these are not restrictive.

### <<Option 1-3-2>>

Associations between a BAT bit field/BAT ID and a BAT value may be determined/defined based on a specific rule.

The specific rule/associations may be defined in a specification in advance, for example.

The UE may receive quantized bits indicating a BAT value based on a specific rule (bit field indicating a BAT).

FIG. 17B is a diagram to show an example of associations of BAT values according to option 1-3-2. Associations between a bit field (or BAT ID) and a BAT value as those shown in FIG. 17B are defined/determined in advance. The UE may determine a BAT, based on the associations and indicated quantized bits (bit field indicating a BAT).

Note that the values and terms of the fields shown in FIG. 17B are merely examples, and these are not restrictive.

According to options 1-3-1 and 1-3-2 above, it is possible to appropriately perform notification about a BAT.

### Modification Example of First Embodiment

For example, at least one option of the present embodiment may be applied to a case where a BAT is not associated with at least one TCI field codepoint. Note that this modification example is also applicable to a second embodiment below.

For example, also when a UE performs operation using multi-panel/multi-TRP/multi-cell, the UE may apply at least one option of the present embodiment (for example, option 1-2-1/1-2-2) to determine a BAT.

For example, a common BAT may be configured for the UE. The common BAT may be configured by specific higher layer signaling (RRC parameter), may be defined in a specification in advance, or may be indicated by using a MAC CE/DCI. The specific RRC parameter may be an RRC parameter related to an application time point of a beam (TCI state) (for example, “BeamAppTime”), for example.

For the UE, a differential BAT corresponding to information related to specific information may be configured/indicated.

The specific information may be at least one of a physical cell ID (PCI), information related to a panel to be used, information related to whether to use a single panel or multi-panel, and information related to a TRP, for example. The information related to a TRP may be at least one of information related to a CORESET pool index (RRC parameter “coresetPoolIndex”), information related to which TCI state to refer to when a plurality of (two) TCI states are indicated for a CORESET, and information related to which spatial relation to refer to when a plurality of (two) spatial relations are configured for each PUCCH resource, for example. By configuring/indicating a differential BAT corresponding to the specific information, the UE may derive/calculate a BAT of a case where the specific information is applied/configured by using the common BAT and the differential BAT.

According to the first embodiment above, it is possible to appropriately determine/configure/indicate a BAT.

### Second Embodiment

A second embodiment relates to mapping of BATs and TCI states.

In the first symbol/slot after the elapse of a specific period after a specific time resource from reception of beam indication DCI, a UE may refer to a plurality of RSs indicated by a TCI field codepoint of the beam indication.

In the first symbol/slot after the elapse of a specific period after a specific time resource from reception of beam indication DCI, the UE may apply one or more TCI states indicated by a TCI field codepoint of the beam indication.

The present embodiment may be applied in combination with at least one method described in the first embodiment.

The specific time resource may follow at least one of options 1-0-1 to 1-0-3 above.

The specific period may be the BAT/time offset in the first embodiment above.

One TCI state (common TCI state/joint (DL/UL) TCI state/separate (DL/UL) TCI state) may be mapped with one BAT. In other words, when one TCI codepoint indicates a plurality of TCI states, a BAT may be mapped for each of the TCI states.

With such a configuration, it is possible to indicate a pattern of beams (TCI states) and BATs over a plurality of time domains by using one piece of DCI (TCI codepoint).

Note that, in the present disclosure, an application method related to two TCI states including a first TCI state and a second TCI state is mainly described for TCI states. However, the number of TCI states is not limited to two and may be three or more.

In the present disclosure, a beam pattern, a TCI state pattern, a sequence of TCI states, a correspondence relationship related to a plurality of TCI states, and a correspondence relationship related to a plurality of TCI states and BATs may be interchangeably interpreted. In the present disclosure, a beam pattern may mean a correspondence relationship for indicating a plurality of TCI states over a plurality of time domains by using one TCI codepoint.

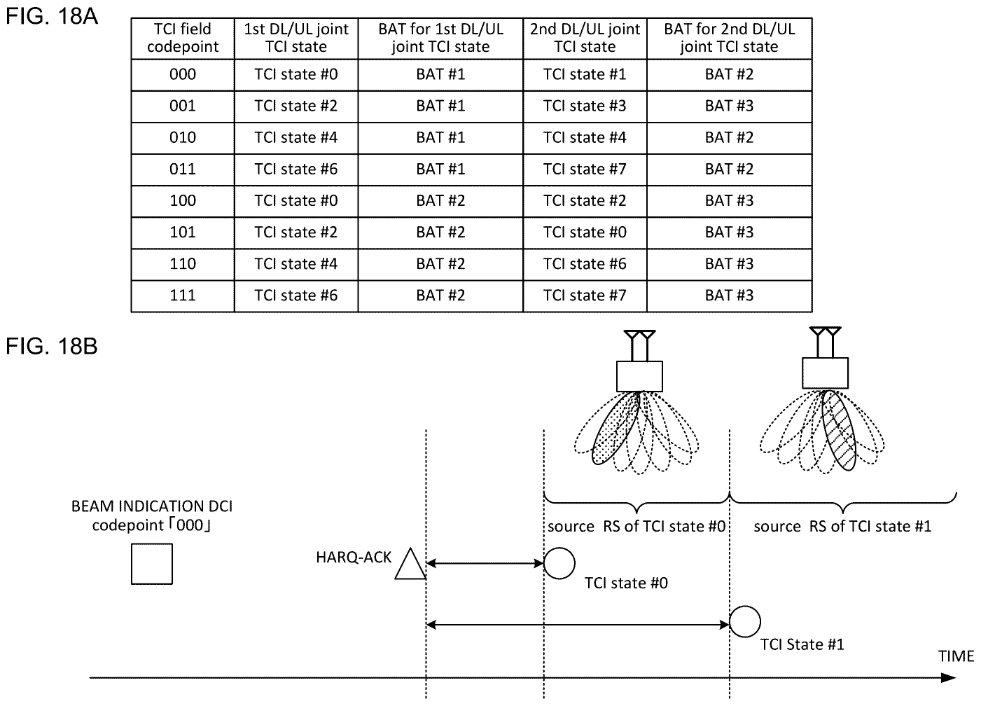

FIG. 18A and FIG. 18B are diagrams to show an example of application of TCI states according to a second embodiment. In the example shown in FIG. 18A, a correspondence relationship of TCI codepoints, TCI states (first joint DL/UL TCI states and second joint DL/UL TCI states), and BATs corresponding to the TCI states is configured/defined for a UE.

In the example shown in FIG. 18B, the UE receives a TCI field with a codepoint indicating 000, by using beam indication DCI. Based on the TCI state, the UE applies a first TCI state (TCI #0), based on BAT #1, and applies a second TCI state (TCI #1), based on BAT #2.

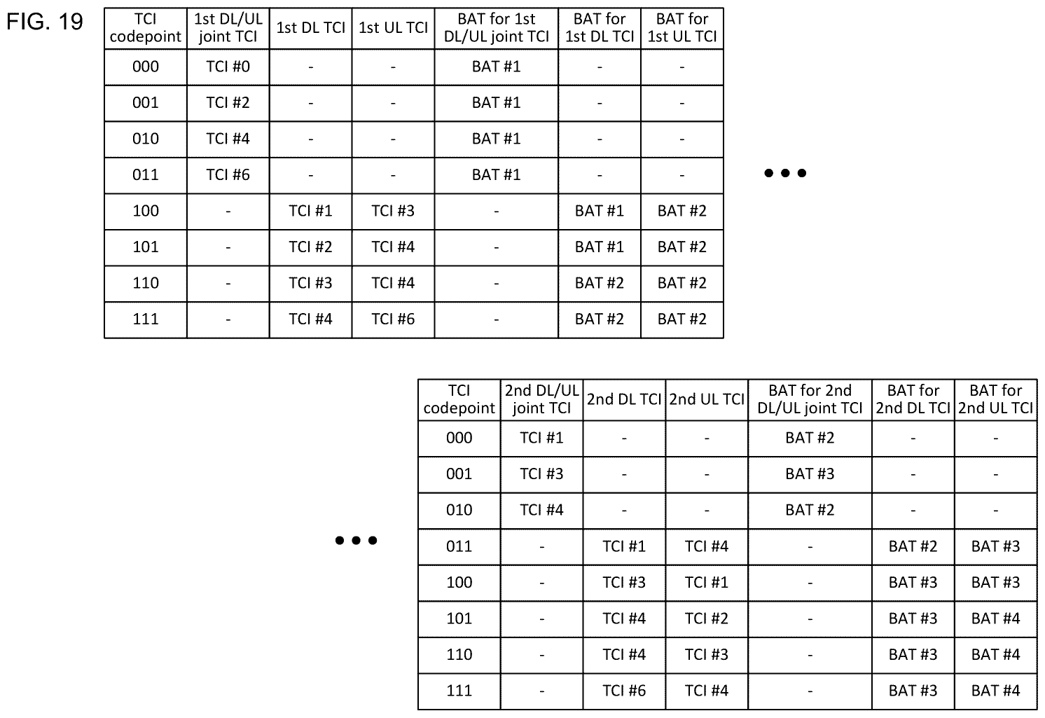

FIG. 19 is a diagram to show another example of the application of TCI states according to the second embodiment. As shown in the example in FIG. 19, the correspondence relationship of TCI codepoints, TCI states, and BATs corresponding to TCI states configured for a UE may include at least one of joint DL/UL TCI states and separate DL/UL TCI states. Among the separate DL/UL TCI states, a DL TCI state and a UL TCI state may indicate the same TCI state or may indicate different TCI state. Also in such an example, at least one method described in the first embodiment may be applied.

In the following, configuration of a correspondence relationship between BATs and TCI states will be described.

A UE may apply a plurality of TCI states indicated by using one TCI codepoint (refer to a plurality of RSs) according to at least one of options 2-1-1 to 2-1-3 to be described below.

### <<Option 2-1-1>>

For a UE, a TCI state parameter (“TCI-State”) including a plurality of pieces of QCL information (“QCL-info”) of the same type may be configured by using RRC.

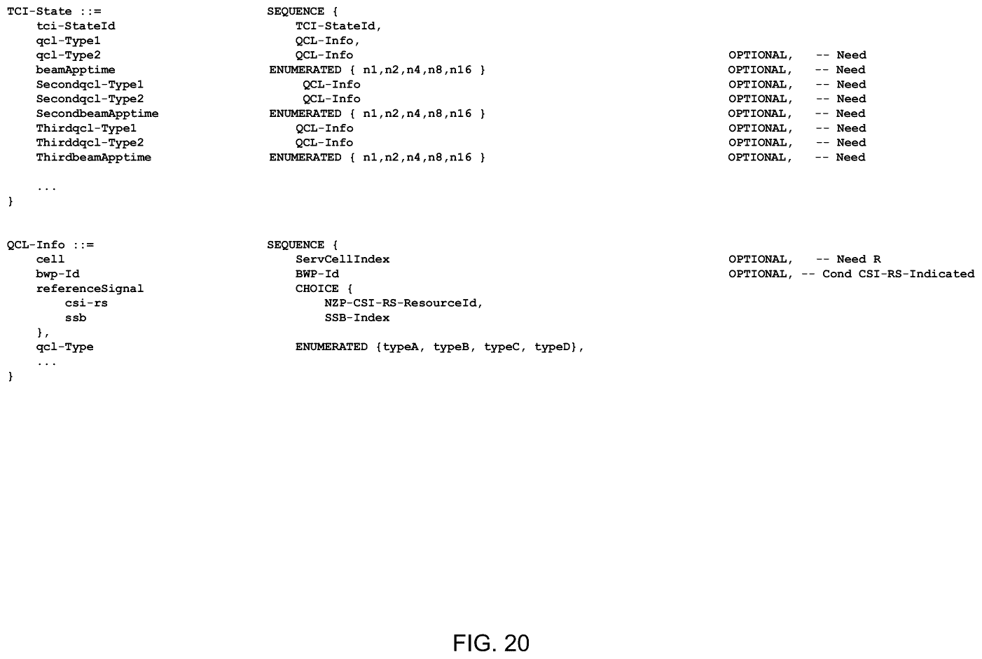

FIG. 20 is a diagram to show an example of a TCI state parameter according to option 2-1-1. In the example shown in FIG. 20, an RRC parameter (“TCI-State”) includes a TCI state ID, a plurality of pieces of Type 1 QCL information (first Type 1 QCL information “qcl-Type1,” second Type 1 QCL information “Secondqcl-Type1,” and third Type 1 QCL information “Thirdqcl-Type1”) and pieces of Type 2 QCL information (first Type 2 QCL information “qcl-Type2,” second Type 2 QCL information “Secondqcl-Type2,” and third Type 2 QCL information “Thirdqcl-Type2”), and parameters configuring beam application time points corresponding to the pieces of QCL information (“beamApptime,” “SecondbeamApptime,” and “ThirdbeamApptime”). “beamApptime” corresponds to “qcl-Type1” and “qcl-Type2,” “SecondbeamApptime” corresponds to “Secondqcl-Type1” and “Secondqcl-Type2,” and “ThirdbeamApptime” corresponds to “Thirdqcl-Type1” and “Thirdqcl-Type2.”

Note that, in FIG. 20, an example where each number of pieces of QCL information is three is shown, but the number may be three or more. The term of each parameter is merely an example and is not limited to this example.

In the example shown in FIG. 20, a UE may determine, for application of a first TCI state among the plurality of TCI states indicated by using one TCI codepoint, application timing of an indicated TCI state, based on the parameter for configuring a beam application time point corresponding to the first Type 1/Type 2 QCL information (“beamApptime”).

The UE may also determine, for application of a second TCI state among the plurality of TCI states indicated by using one TCI codepoint, application timing of an indicated TCI state, based on the parameter for configuring a beam application time point corresponding to the second Type 1/Type 2 QCL information (“SecondbeamApptime”).

The UE may also determine, for application of a third TCI state among the plurality of TCI states indicated by using one TCI codepoint, application timing of an indicated TCI state, based on the parameter for configuring a beam application time point corresponding to the third Type 1/Type 2 QCL information (“ThirdbeamApptime”).

Determination of BATs based on the parameters configuring the plurality of beam application time points may follow at least one of variations 2-1-1-1 to 2-1-1-4 to be described below.

### {Variation 2-1-1-1}

The UE may determine that the BAT configured by the parameter for configuring a beam application time point corresponding to the first Type 1/Type 2 QCL information (“beamApptime”) is a common BAT. The UE may perform application of the first TCI state corresponding to the first Type 1/Type 2 QCL information at the timing based on the common BAT.

The UE may perform application of the first TCI state corresponding to the n-th (where n is an integer equal to or larger than 2) Type 1/Type 2 QCL information at the timing based on the BAT configured by the parameter for configuring a beam application time point corresponding to the n-th Type 1/Type 2 QCL information and the common BAT.

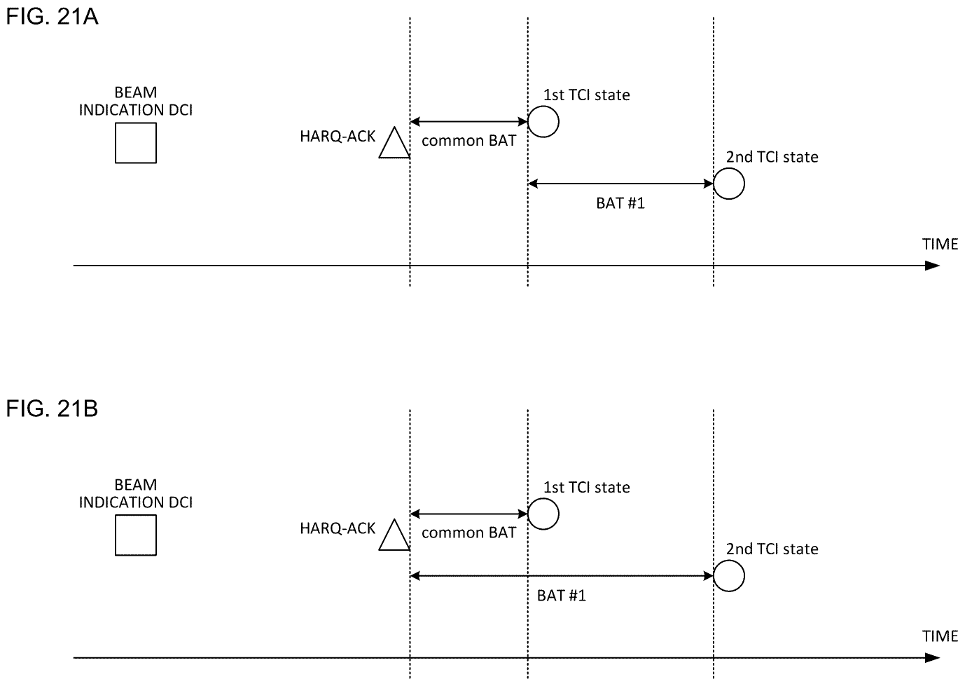

FIG. 21A is a diagram to show an example of application of TCI states according to variation 2-1-1-1. In the example shown in FIG. 21A, the UE determines that the BAT configured by the parameter for configuring a beam application time point corresponding to the first Type 1/Type 2 QCL information (“beamApptime”) is a common BAT and applies the first TCI state.

In the example shown in FIG. 21A, the UE also applies the second TCI state at the timing obtained by adding the BAT (in FIG. 21A, BAT #1) configured by the parameter for configuring a beam application time point corresponding to the second Type 1/Type 2 QCL information (“SecondbeamApptime”) and the common BAT.

### {Variation 2-1-1-2}

The UE may determine that the BAT configured by the parameter for configuring a beam application time point corresponding to the m-th (where m is a positive integer) Type 1/Type 2 QCL information is a BAT for applying the m-th TCI state.

FIG. 21B is a diagram to show an example of application of a TCI state according to variation 2-1-1-2. In the example shown in FIG. 21B, the UE determines that the BAT configured by the parameter for configuring a beam application time point corresponding to the first Type 1/Type 2 QCL information (“beamApptime”) is BAT #1 (which may be the common BAT) and applies the first TCI state.

In the example shown in FIG. 21B, the UE determines that the BAT configured by the parameter for configuring a beam application time point corresponding to the second Type 1/Type 2 QCL information (“SecondbeamApptime”) is BAT #2 and applies the second TCI state.

### {Variation 2-1-1-3}

The UE may determine that the BAT configured by the parameter for configuring a beam application time point corresponding to the first Type 1/Type 2 QCL information (“beamApptime”) is a common BAT. The UE may perform application of the first TCI state corresponding to the first Type 1/Type 2 QCL information at the timing based on the common BAT.

The UE may perform application of the first TCI state corresponding to the n-th (where n is an integer equal to or larger than 2) Type 1/Type 2 QCL information at the timing based on the BAT configured by the parameter for configuring a beam application time point corresponding to the n-th Type 1/Type 2 QCL information and the BAT configured by the parameter for configuring a beam application time point corresponding to the (n−1)-th Type 1/Type 2 QCL information.

In this case, the period from the application timing of the (n−1)-th TCI state to the application timing of the n-th TCI state may be configured by using the parameter for configuring a beam application time point corresponding to the n-th Type 1/Type 2 QCL information.

Alternatively, the TCI state RRC parameter (“TCI State”) may include no parameter for configuring a beam application time point corresponding to the n-th Type 1/Type 2 QCL information (for example, “SecondbeamApptime,” “ThirdbeamApptime” above) and may instead include a parameter indicating a switch gap (switching gap).

The parameter indicating a switching gap may be a parameter indicating a period/gap from the application timing of the (n−1)-th TCI state to the application timing of the n-th TCI state.

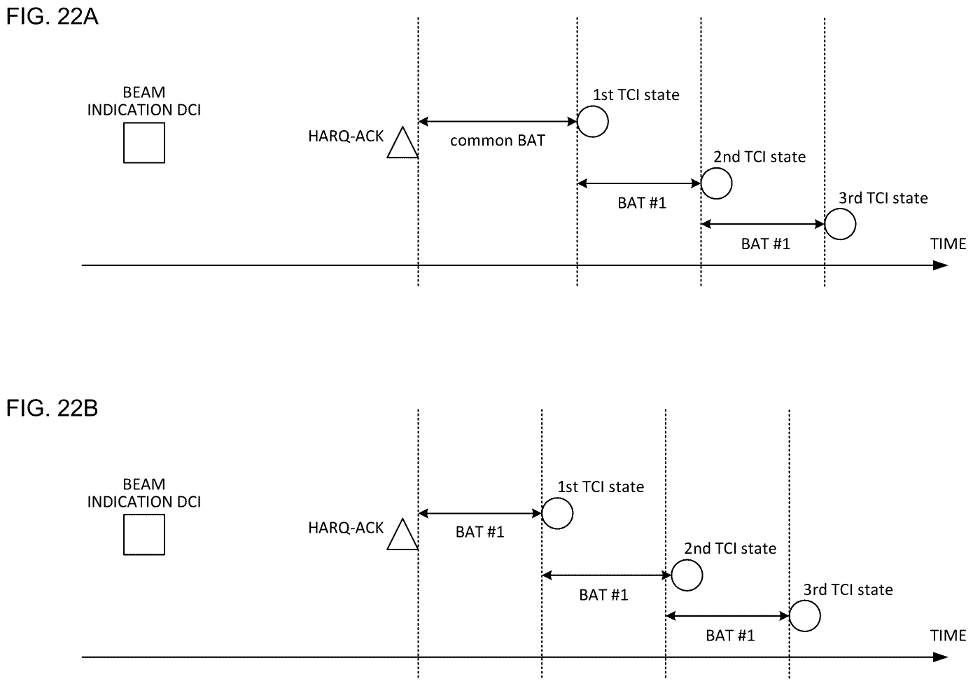

FIG. 22A is a diagram to show an example of application of TCI states according to variation 2-1-1-3. In the example shown in FIG. 22A, the UE determines that a common BAT is configured by the parameter for configuring a beam application time point corresponding to the first Type 1/Type 2 QCL information (“beamApptime”) and applies the first TCI state.

In the example shown in FIG. 22A, the parameter indicating a switching gap is configured for the UE. The UE determines application timing of each of the second TCI state and the third TCI state, based on the timing indicated by the switching gap (BAT #1 in FIG. 22A).

### {Variation 2-1-1-4}

The UE may determine that the BAT configured by the parameter for configuring a beam application time point corresponding to the first Type 1/Type 2 QCL information (for example, “beamApptime”) is a parameter indicating a switching gap from the application timing of the (m−1)-th TCI state to the application of the m-th TCI state.

In the variation 2-1-1-4, the TCI state RRC parameter (“TCI State”) may include no parameter for configuring a beam application time point corresponding to the m-th Type 1/Type 2 QCL information (for example, “beamApptime,” “SecondbeamApptime,” “ThirdbeamApptime” above) and may instead include a parameter indicating a switching gap.

FIG. 22B is a diagram to show an example of application of a TCI state according to variation 2-1-1-4. In the example shown in FIG. 22B, the UE determines application timing of the first/second/third TCI state, based on the BAT (BAT #1 in FIG. 22B) configured by the parameter indicating the switching gap.

According to option 2-1-1-4, by narrowing down to one BAT for application of a plurality of TCI states, it is possible to attempt reduction of overhead.

### <<Option 2-1-2>>

For the UE, QCL information (“QCL-info”) including pieces of information related to a plurality of source RSs may be configured by using RRC.

In option 2-1-2, QCL information in one TCI state parameter may include the pieces of information related to a plurality of source RSs. Hence, the UE may receive indication of one TCI codepoint (TCI state ID), and determine BATs to apply to a plurality of TCI states, based on the pieces of information related to the plurality of source RSs included in the indicated TCI state.

The pieces of information related to a plurality of source RSs may be, for example, an RRC parameter indicating a first reference signal (for example, “referenceSignal”), an RRC parameter indicating a second reference signal (for example, “SecondreferenceSignal”), and an RRC parameter indicating a third reference signal (for example, “ThirdreferenceSignal”).

The parameter indicating each of the reference signals may indicate the index of the reference-destination reference signal (for example, a CSI-RS/SSB).

Note that the number of pieces of information related to resource RSs is not limited to three and may be any number. The term of each parameter is merely an example and is not limited to this example.

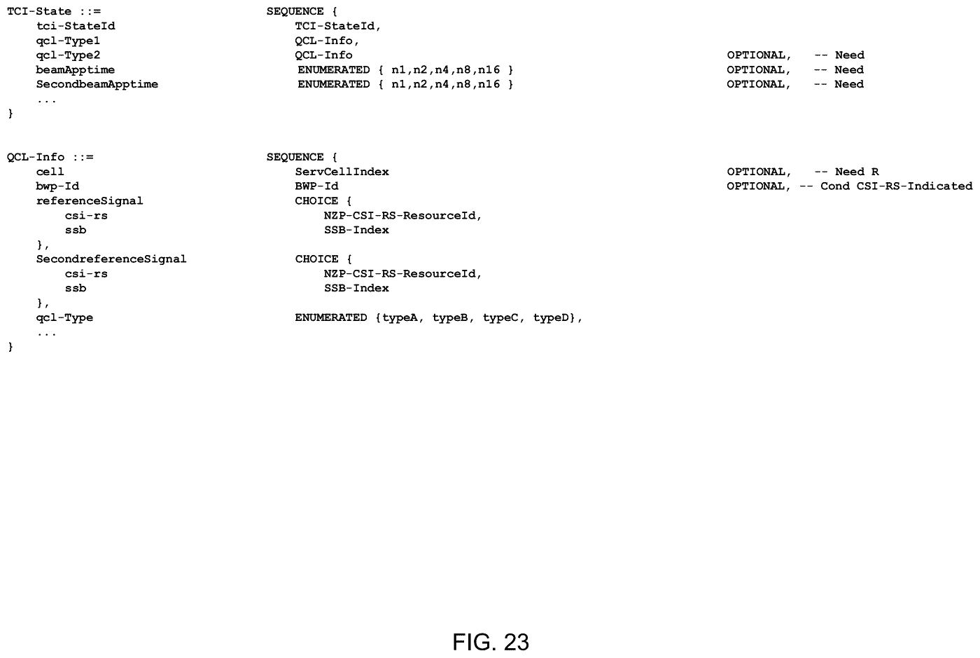

FIG. 23 is a diagram to show an example of a TCI state parameter according to option 2-1-2. In the example shown in FIG. 23, the RRC parameter (“TCI-State”) may include Type 1 QCL information (“qcl-Type1”) and Type 2 QCL information (“qcl-Type2”), and the parameter for configuring a beam application time point (“beamApptime”).

In the example shown in FIG. 23, QCL information parameter (QCL-Info) referred to by Type 1 QCL information (“qcl-Type1”) and Type 2 QCL information (“qcl-Type2”) includes an RRC parameter indicating the first reference signal (“referenceSignal”) and an RRC parameter indicating the second reference signal (“SecondreferenceSignal”).

Note that, in FIG. 23, an example where the number of parameters related to reference signals in the QCL information is two is shown, but the number is not limited to this and may be three or more.

In the example shown in FIG. 23, a UE determines, for application of a first TCI state among the plurality of TCI states indicated by using one TCI codepoint, application of the TCI state, based on information related to a first source RS. The UE also determines, for application of a second TCI state among the plurality of TCI states indicated by using one TCI codepoint, application of the TCI state, based on information related to a second source RS.

In this case, the application timing of each of the first and second TCI states may be determined based on the parameter for configuring a beam application time point (“beamApptime”) included in the TCI state parameter.

In the example shown in FIG. 23 above, an example where the parameter for configuring a beam application time point (“beamApptime”) is included in the TCI state parameter is shown, but the parameter for configuring a beam application time point (“beamApptime”) may be included in the QCL information parameter (“QCL-Info”).

When the parameter for configuring a beam application time point is included in the QCL information parameter (“QCL-Info”), a plurality of parameters for configuring a beam application time point may be included. In this case, the parameters related to a plurality of source RSs included in the QCL information parameter (“QCL-Info”) and the respective parameters for configuring a beam application time point may correspond to each other. The UE may apply a BAT corresponding to each source RS, to application of a TCI state corresponding to the parameter related to the source RS.

At least one of variations 2-1-1-1 to 2-1-1-4 above may be appropriately applied to determination of a BAT based on the parameter configuring a beam application time point in option 2-1-2.

### <<Option 2-1-3>>

The UE may receive a MAC CE (activation/deactivation command MAC CE) including fields related to a plurality of TCI states for a plurality of (different) BATs.

The plurality of BATs may be BATs corresponding to application of a plurality of respective TCI states associated with one TCI codepoint.

The MAC CE may be a MAC CE described in at least one of options 2-1-3-1 and 2-1-3-2 below.

### {Option 2-1-3-1}

The MAC CE may be a new MAC CE (defined in Rel. 17 or later versions).

A subheader of the MAC CE may include a new Logical Channel ID (LCID).

The MAC CE may include fields each indicating activation of a TCI state.

The number of fields/octets included in the MAC CE may be configured by using RRC signaling or may be determined based on reported UE capability information. The UE capability information may be defined by the maximum number of BATs related to one codepoint, for example.

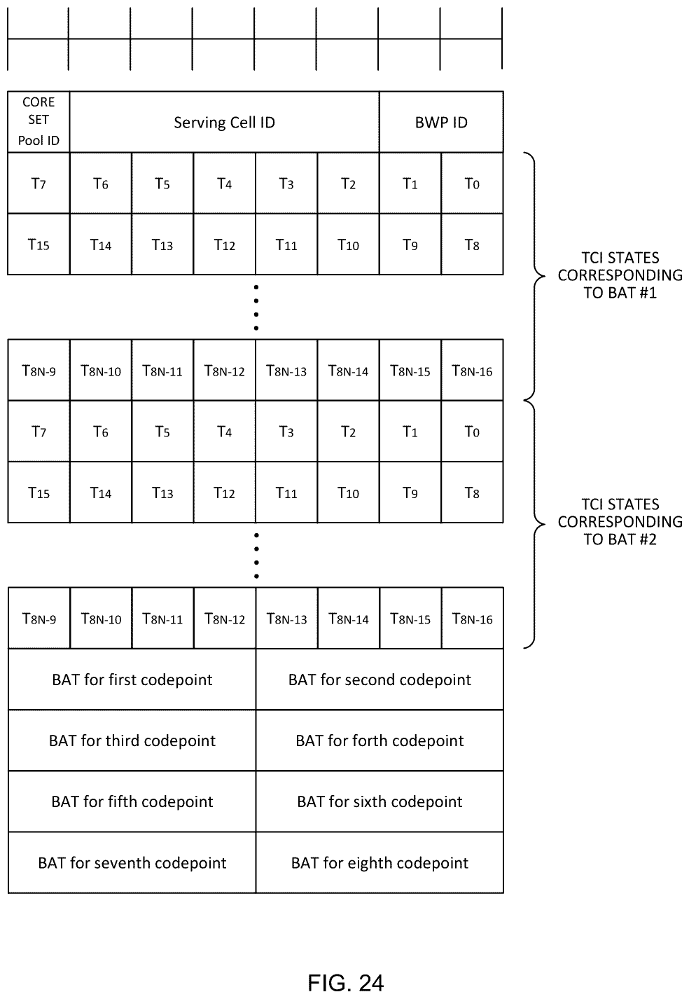

FIG. 24 is a diagram to show an example of a structure of a MAC CE according to option 2-1-3-1. The MAC CE shown in FIG. 24 includes a field indicating a CORESET pool ID, a field indicating a serving cell ID, a field indicating a BWP ID, and fields each indicating activation/deactivation of a TCI state (described as TN).

In the MAC CE shown in FIG. 24, the fields each indicating activation of a TCI state may corresponds to BATs. For example, in the MAC CE, the fields each for activating a first TCI state of the plurality of TCI states corresponding to one TCI codepoint correspond to a first BAT (for example, BAT #1). In the MAC CE, the fields each for activating a second TCI state of the plurality of TCI states corresponding to one TCI codepoint correspond to a second BAT (for example, BAT #2). In other words, the UE may refer to the field related to the first TCI state in application of the first BAT and refer to the field related to the second TCI state in application of the second BAT.

The MAC CE shown in FIG. 24 further includes fields indicating BAT #1 and fields indicating BAT #2 corresponding to respective TCI states. A UE determines BATs corresponding to an indicated TCI state, based on the fields indicating the BATs.

Note that, in the example shown in FIG. 24, the fields indicating BATs may be added/deleted according to LCID, for example.

### {Option 2-1-3-2}

The MAC CE may be an existing MAC CE (for example, defined in Rel. 15/16 or previous versions).

For the MAC CE, a reserved bit included in an existing MAC CE (for example, defined in Rel. 15/16 or previous versions) may be used as a field indicating whether to interpret this MAC CE as a MAC CE having a field for activation of a list of TCI states with BATs (time offsets).

The MAC CE may be a MAC CE obtained by adding a new field/octet to an existing MAC CE (for example, defined in Rel. 15/16 or previous versions).

The existing MAC CE (for example, defined in Rel. 15/16 or previous versions) may be a MAC CE for activation/deactivation of TCI states of a UE-specific PDSCH (Enhanced TCI states Activation/Deactivation for UE-specific PDSCH MAC CE), for example.

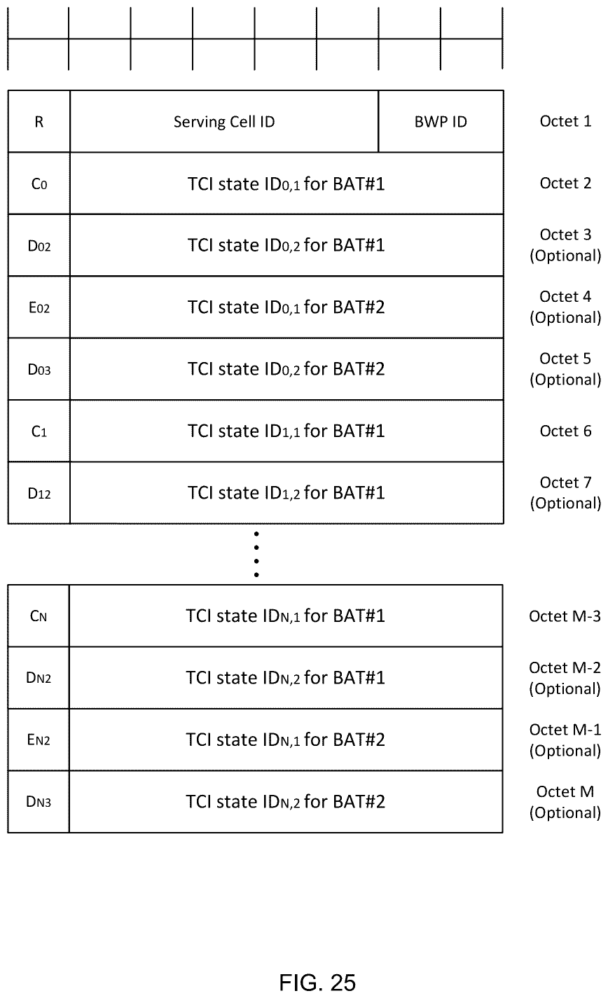

FIG. 25 is a diagram to show an example of a structure of a MAC CE according to option 2-1-3-2. The MAC CE shown in FIG. 25 may include a serving cell ID field, a BWP ID field, fields each indicating a TCI state identified by TCI-StateID corresponding to each BAT (BAT #1/BAT #2) (TCI state IDi,j (where i is an integer from 0 to N, j is 1 or 2)), fields (Cᵢ) each indicating whether or not TCI state IDi,2 is present in a corresponding octet, and a reserved bit field (R, set at 0). Note that a field for indicating a TCI state corresponding to each BAT may mean a field for indicating a TCI state to be referred to after the elapse of each BAT.

“i” may correspond to the index of the TCI field codepoint indicated by DCI. “TCI state IDi,j” may indicate the j-th TCI state of the i-th TCI field codepoint.

The MAC CE shown in FIG. 25 further includes fields each indicating presence of an octet corresponding to the first TCI state field with the i-th TCI state ID corresponding to BAT #Y (where Y is any integer) (that is, TCI state IDi,1) (described as D_{iY}) and fields each indicating presence of an octet corresponding to the second TCI state field with the i-th TCI state ID corresponding to BAT #Y (that is, TCI state IDi,2) (described as E_{iY}).

When the D_{iY} field above indicates a first value (for example, 0 (or 1)), the UE may determine that a field for indicating the TCI state corresponding to TCI state IDi,1 corresponding to BAT #Y is included. When the D_{iY} field above indicates a second value (for example, 1 (or 0)), the UE may determine that a field for indicating the TCI state corresponding to TCI state IDi,1 corresponding to BAT #Y is not included.

When the E_{iY} field above indicates a first value (for example, 0 (or 1)), the UE may determine that a field indicating the BAT corresponding to TCI state IDi,2 corresponding to BAT #Y is included. When the E_{iY} field above indicates a second value (for example, 1 (or 0)), the UE may determine that a field indicating the BAT corresponding to TCI state IDi,2 corresponding to BAT #Y is not included.

In the example shown in FIG. 25, the UE determines a BAT corresponding to an indicated TCI state, based on the field indicating the BAT.

Note that, in the example in FIG. 25, a case where the number of BATs is two is shown, but the number may be three or more. A field indicating each BAT (for example, BAT #1/#2 in the example in FIG. 25) corresponding to a TCI state ID as that described in option 1-1-5-2 of the first embodiment may be included in the MAC CE in option 2-1-3-2.

According to options 2-1-1 to 2-1-3 above, even when a plurality of TCI states are associated with one TCI codepoint, it is possible to appropriately perform configuration of a TCI state/BAT.

In the following, description will be given of initiation timing (symbol/slot) of application of a TCI state/reference of an RS by a UE when one TCI codepoint is mapped to a plurality of TCI states/source RSs with a plurality of BATs.

When one TCI codepoint is mapped to a plurality of TCI states/source RSs with a plurality of BATs, a UE may determine initiation timing (symbol/slot) of reference of an RS related to an indicated TCI state, based on a specific method.

The specific method may follow at least one of choices 2-2-1 and 2-2-2 below.

### <<Choice 2-2-1>>

The UE may initiate reference of an RS related to the indicated TCI state, based on a configured/indicated BAT, after a specific time resource determined based on at least one method described in the first embodiment.

In other words, the UE may initiate application of the indicated TCI state, based on a configured/indicated BAT, after a specific time resource determined based on at least one method described in the first embodiment.

The configured/indicated BAT may indicate a period from the specific time resource.

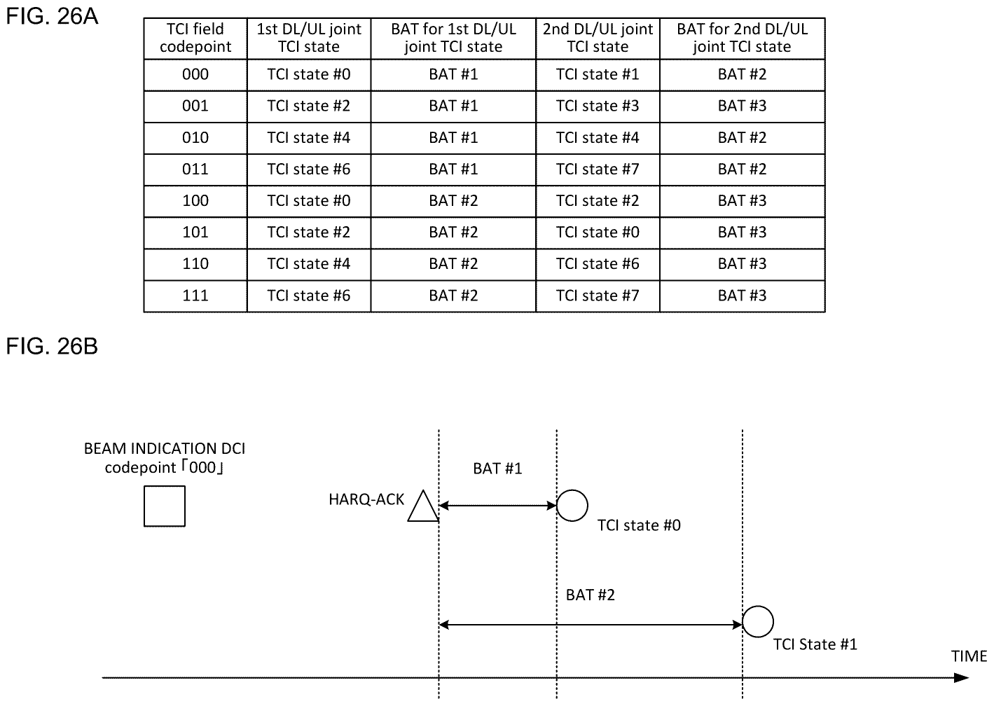

FIG. 26A and FIG. 26B are diagrams to show an example of application of TCI states according to choice 2-2-1. As in the example shown in FIG. 26A, associations of TCI codepoints, a plurality of TCI states (first TCI states/second TCI state), and BATs corresponding to respective TCI states are configured for a UE.

In the example shown in FIG. 26B, the UE receives beam indication DCI indicating a TCI codepoint “000.” In this case, the UE determines that initiation of application of a first TCI state (TCI #0) is timing after the elapse of BAT #1 from transmission of HARQ-ACK related to beam indication DCI. The UE determines that initiation of application of a second TCI state (TCI #1) is timing after the elapse of BAT #2 from transmission of HARQ-ACK related to beam indication DCI.

### <<Choice 2-2-2>>

The UE may initiate reference of an RS related to the indicated TCI state, based on a configured/indicated BAT, after a specific time resource determined based on at least one method described in the first embodiment.

In other words, the UE may initiate application of the indicated TCI state, based on a configured/indicated BAT, after a specific time resource determined based on at least one method described in the first embodiment.

The configured/indicated BAT may indicate at least one of a period from the specific time resource and an added period (that is, a differential BAT).

For example, for a first TCI state among a plurality of TCI states and a plurality of BATs corresponding to one TCI codepoint, the UE may determine that application is initiated after the elapse of a BAT corresponding to the first TCI state (first BAT) after the specific time resource. In this case, for a second TCI state, the UE may determine that application is initiated further after the elapse of a BAT corresponding to the second TCI state (second BAT) after the elapse of the first BAT after the specific time resource. As described above, initiation of application of the n-th TCI state may be determined/judged based on the initiation timing of application of the (n−1)-th TCI state and an indicated BAT.

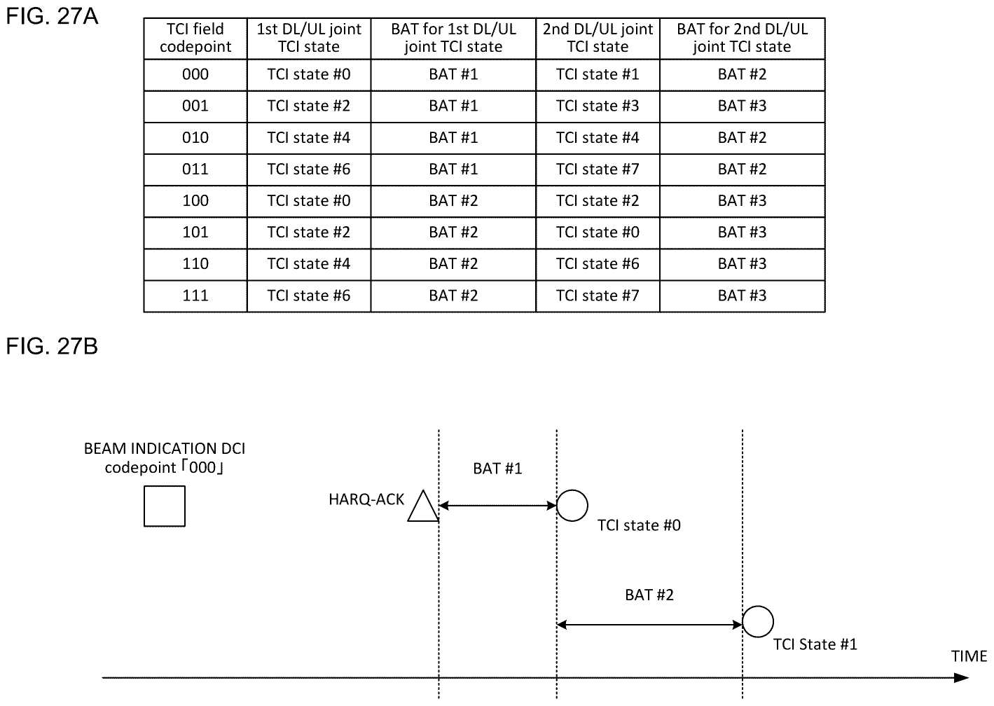

FIG. 27A and FIG. 27B are diagrams to show an example of application of TCI states according to choice 2-2-2. As in the example shown in FIG. 27A, associations of TCI codepoints, a plurality of TCI states (first TCI states/second TCI state), and BATs corresponding to respective TCI states are configured for a UE.

In the example shown in FIG. 27B, the UE receives beam indication DCI indicating a TCI codepoint “000.” In this case, the UE determines that initiation of application of a first TCI state (TCI #0) is timing after the elapse of BAT #1 from transmission of HARQ-ACK related to beam indication DCI. The UE determines that initiation of application of a second TCI state (TCI #1) is timing further after the elapse of BAT #2 from the application initiation timing of the first TCI state (after the elapse of BAT #1 from transmission of HARQ-ACK related to beam indication DCI).

Note that, in the present embodiment, the UE may assume that application of the first TCI state is initiated before application of the second TCI state. In the present embodiment, the UE may assume that application of the n-th TCI state is initiated before application of the (n+1)-th TCI state.

In the present embodiment, the UE may assume that the first BAT and the second BAT are the same value. In this case, the UE may be notified of information indicating one BAT value. With this method, it is possible to reduce overhead of notification of a BAT to a UE.

According to the second embodiment above, even when a plurality of TCI states correspond to one TCI codepoint, it is possible to appropriately apply a TCI state and determine timing of the application.

### Third Embodiment

A third embodiment relates to the number of TCI states to be activated for a UE.

### <<Aspect 3-1>>

A UE may receive an activation command (MAC CE) corresponding to a combination/pair of a specific number of (for example, X at maximum) TCI states.

For example, the MAC CE may activate a combination/pair of eight TCI states at maximum.

In the present disclosure, one combination of TCI states may correspond to TCI states (pair of TCI states) indicated by one TCI codepoint.

### <<Aspect 3-2>>

A UE may receive an activation command (MAC CE) corresponding to a combination of TCI states consisted of a specific number of (for example, X at maximum) TCI states (pairs of TCI states) in total.

For example, the MAC CE may activate eight TCI states (pairs of TCI states) at maximum in total. By thus restricting the maximum number of TCI states, it is possible to restrict the number of active TCI states.

### <<Aspect 3-3>>

A UE may receive an activation command (MAC CE) corresponding to a combination/pair of TCI states including a specific number of (for example, X at maximum) source RSs of QCL information in total.

For example, the MAC CE may activate TCI states (pair of TCI states) including eight source RSs at maximum in total.

The X may be determined/configured for each QCL type.

The X may be determined/configured for each specific QCL type (for example, QCL type D).

The X may express the maximum number for the total number of source RSs of a specific QCL type (for example, QCL type A/B/C).

Note that, in at least one of aspects 3-1 to 3-3 above, X may be a value defined in a specification in advance, may be determined based on higher layer signaling (RRC/MAC CE)/DCI, or may be determined based on reported UE capability information.

Note that, although an example where X is eight has been shown in the above example, a number larger than eight may be supported for X.

According to the third embodiment above, the number of TCI states to be activated for a UE can be appropriately determined.

### Fourth Embodiment

A fourth embodiment relates to the maximum value/minimum value of a BAT.

The maximum value/minimum value of a BAT configured/indicated for a UE may be a value defined in a specification in advance, may be determined based on higher layer signaling (RRC/MAC CE)/DCI, or may be determined based on reported UE capability information.

### <<Aspect 4-1>>

A UE need not assume/expect to receive indication/activation/configuration including a BAT being a value larger than the defined/determined maximum value of a BAT.

The UE may assume/expect not to receive indication/activation/configuration including a BAT being a value larger than the defined/determined maximum value of a BAT.

When the UE is notified of indication/activation/configuration including a BAT being a value larger than the defined/determined maximum value of a BAT, the UE may determine to use the defined/determined maximum value of a BAT.

### <<Aspect 4-2>>

A UE need not assume/expect to receive indication/activation/configuration including a BAT being a value smaller than the defined/determined minimum value of a BAT.

The UE may assume/expect not to receive indication/activation/configuration including a BAT being a value smaller than the defined/determined minimum value of a BAT.

When the UE is notified of indication/activation/configuration including a BAT being a value smaller than the defined/determined minimum value of a BAT, the UE may determine to use the defined/determined minimum value of a BAT.

According to the fourth embodiment above, it is possible to appropriately perform determination of a maximum value/minimum value of a BAT and operation of a UE related to a maximum value/minimum value.

### Fifth Embodiment

A fifth embodiment relates to operation of a case where a UE receives a plurality of pieces of beam indication DCI.

### <<Aspect 5-1>>

A UE need not assume/expect to receive, after reception of DCI/MAC CE indicating a TCI state, specific DCI/MAC CE.

The specific DCI/MAC CE may be DCI/MAC CE indicating a BAT at timing before the last BAT (beam application timing) indicated by using the received DCI/MAC CE.

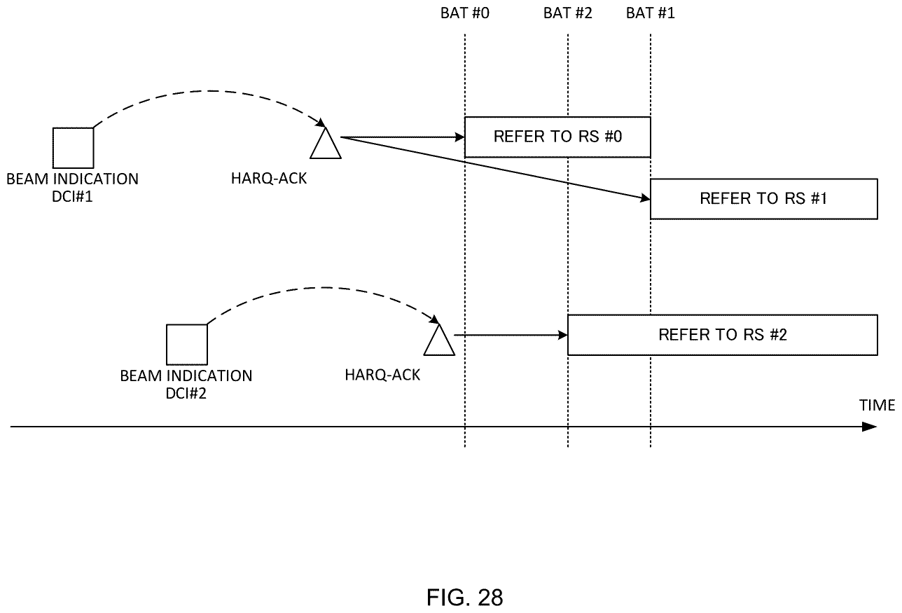

FIG. 28 is a diagram to show an example of application of TCI states according to aspect 5-1. In the example in FIG. 28, a UE receives beam indication DCI #1 indicating referring to RS #0 after the elapse of BAT #0 and referring to RS #1 after the elapse of BAT #1.

Note that, in the present disclosure, a referred RS and a source RS (reference RS) of a TCI state used at a given time may be interchangeably interpreted.

In FIG. 28, beam indication DCI #2 indicating referring to RS #2 after the elapse of BAT #2 is illustrated. Beam indication DCI #2 is present after the reception of beam indication DCI #1, and BAT #2 indicates timing before BAT #1 (specifically, the last BAT indicated by beam indication DCI #1).

In such a case, the UE does not assume/expect to receive beam indication DCI #2.

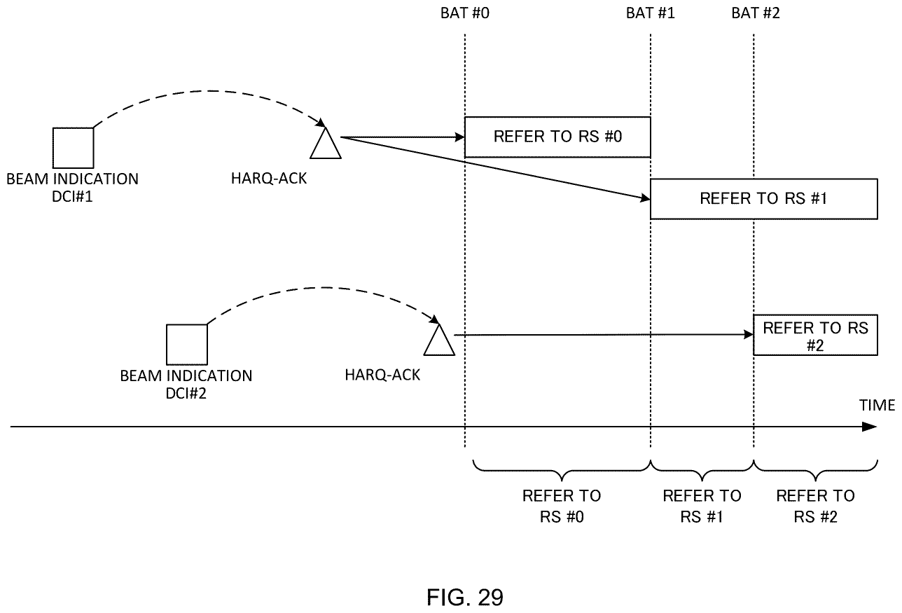

FIG. 29 is a diagram to show another example of the application of TCI states according to aspect 5-1. In the example in FIG. 29, a UE receives beam indication DCI #1 indicating referring to RS #0 after the elapse of BAT #0 and referring to RS #1 after the elapse of BAT #1.

In FIG. 29, beam indication DCI #2 indicating referring to RS #2 after the elapse of BAT #2 is illustrated. Beam indication DCI #2 is present after the reception of beam indication DCI #1, and BAT #2 indicates timing after BAT #1 (specifically, the last BAT indicated by beam indication DCI #1).

In such a case, the UE determines to refer to RS #2 according to the indication of beam indication DCI #2.

### <<Aspect 5-2>>

A UE may ignore part of/entire indication by specific DCI/MAC CE after reception of DCI/MAC CE indicating a TCI state.

The specific DCI/MAC CE may be DCI/MAC CE indicating a BAT at timing before the last BAT (beam application timing) indicated by using the received DCI/MAC CE.

For the indication by beam indication DCI #2 as that shown in FIG. 28, the UE ignores part of the/the entire indication.

### <<Aspect 5-3>>

A UE need not assume/expect to receive, after reception of DCI/MAC CE indicating a TCI state, specific DCI/MAC CE.

The specific DCI/MAC CE may be DCI/MAC CE indicating a TCI state/RS different from indication of a TCI state/RS at timing before the last BAT (beam application timing) indicated by using the received DCI/MAC CE.

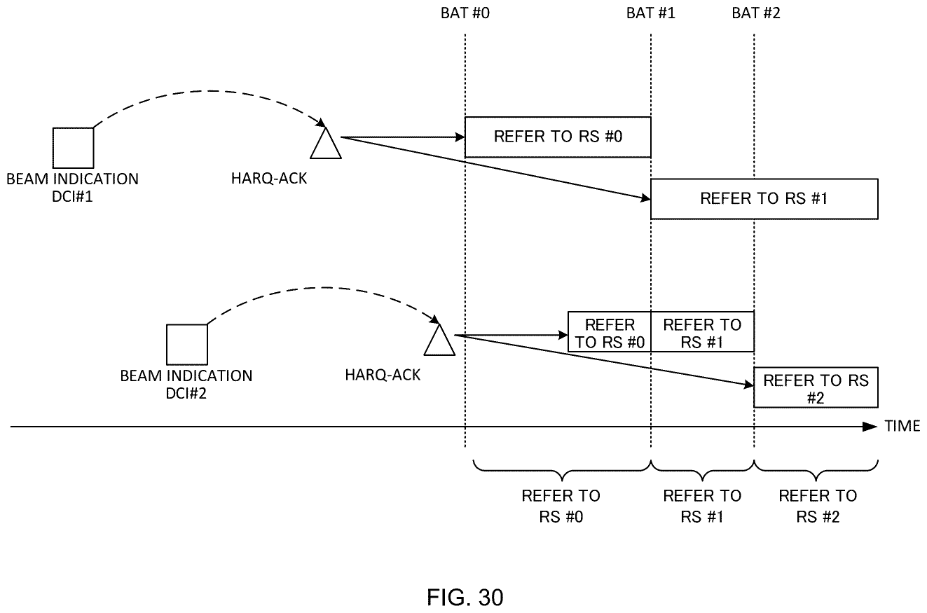

FIG. 30 is a diagram to show an example of application of TCI states according to aspect 5-3. In the example in FIG. 30, a UE receives beam indication DCI #1 indicating referring to RS #0 after the elapse of BAT #0 and referring to RS #1 after the elapse of BAT #1.

In FIG. 30, beam indication DCI #2 indicating referring to RS #0 in a specific period after the elapse of BAT #0 and before the elapse of BAT #1, referring to RS #1 in a specific period after the elapse of BAT #1 and before the elapse of BAT #2, and referring to RS #2 after the elapse of BAT #2. The indication about RS #0 and RS #1 by beam indication DCI #2 includes indication having the same content as that of the indication of beam indication DCI #1.

In such a case, the UE determines to refer to RS #2 (and RS #0/#1) according to the indication of beam indication DCI #2.

In contrast, for beam indication DCI #2 as that shown in FIG. 28 above, the UE does not assume/expect to receive the beam indication DCI.

### <<Aspect 5-4>>

A UE may ignore part of/entire indication by specific DCI/MAC CE after reception of DCI/MAC CE indicating a TCI state.

The specific DCI/MAC CE may be DCI/MAC CE indicating a TCI state/RS different from indication of a TCI state/RS at timing before the last BAT (beam application timing) indicated by using the received DCI/MAC CE.

The part of information ignored by a UE above may be defined in a specification in advance, may be determined based on higher layer signaling (RRC/MAC CE)/DCI, or may be determined based on reported UE capability information.

### <<Aspect 5-5>>

In aspect 5-5, description will be given of operation when a UE receives specific DCI/MAC CE after reception of DCI/MAC CE indicating a TCI state.

The specific DCI/MAC CE may be DCI/MAC CE indicating a TCI state/RS different from indication of a TCI state/RS at timing before the last BAT (beam application (initiation) timing) indicated by using the received DCI/MAC CE.

If the UE receives the specific DCI/MAC CE after reception of DCI/MAC CE indicating a TCI state, the UE may perform (change of) application of a TCI state, based on the indication of the DCI/MAC CE received later. In this case, for the indication by the DCI/MAC CE received earlier, the UE need not refer to the TCI state/source RS to be applied after specific timing.

The specific timing may be at least one of options 5-5-1 and 5-5-2 below.

### {Option 5-5-1}

The specific timing may be timing after the elapse of a specific period (for example, X symbol(s)/slot(s)/subframe(s)/Y [ms]) after reception of the DCI/MAC CE (received later).

The specific timing may be transmission timing of HARQ-ACK related to the DCI/MAC CE (received later).

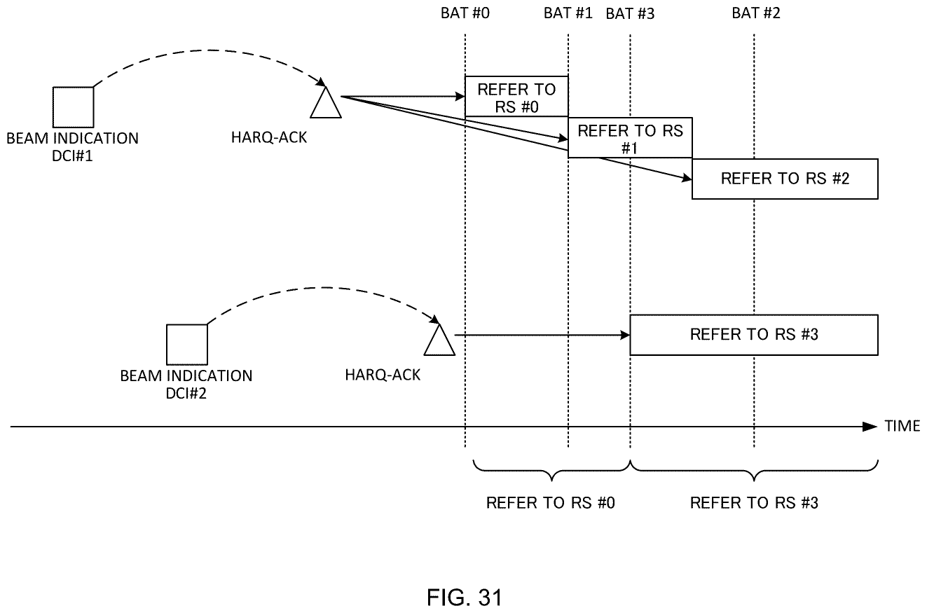

FIG. 31 is a diagram to show an example of application of TCI states according to option 5-5-1. In the example in FIG. 31, a UE receives beam indication DCI #1 indicating referring to RS #0 after the elapse of BAT #0, referring to RS #1 after the elapse of BAT #1, and referring to RS #2 after the elapse of BAT #2.

In the example in FIG. 31, the UE also receives beam indication DCI #2 indicating referring to RS #3 after the elapse of BAT #3. BAT #3 is present between BAT #1 and BAT #2.

In the example shown in FIG. 31, the UE does not follow reference of an RS (application of a TCI state) by beam indication DCI #1 after specific timing (for example, after transmission of HARQ-ACK related to beam indication DCI #2). In other words, the UE determines to refer to RS #0 (does not determine to refer to RS #1) after transmission of HARQ-ACK related to beam indication DCI #2 to BAT #3. The UE determines to refer to RS #3 after the elapse of BAT #3.

### {Option 5-5-2}

The specific timing may be a time resource (symbol) for first application/reference of a TCI state/RS indicated by the DCI/MAC CE (received later).

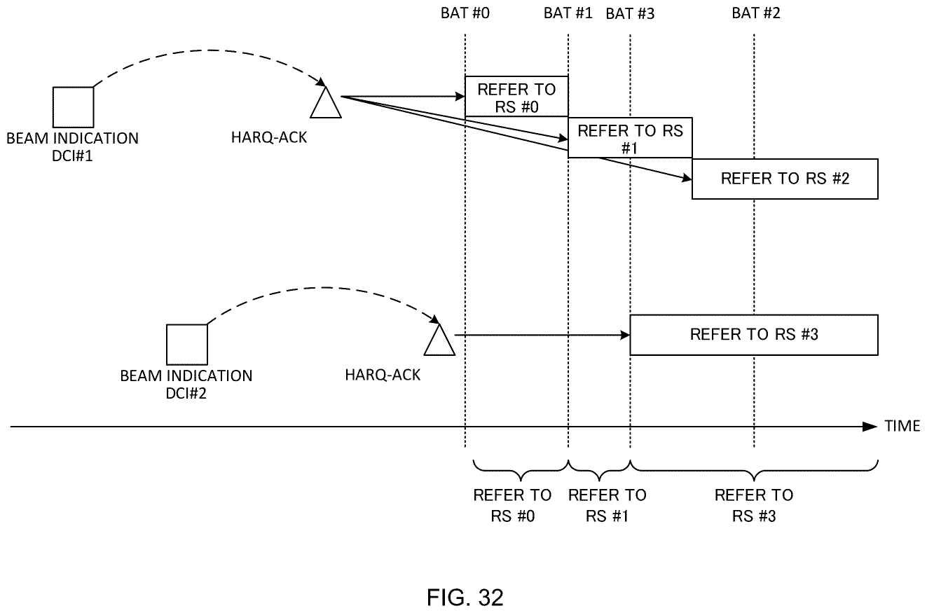

FIG. 32 is a diagram to show an example of application of TCI states according to option 5-5-2. In the example in FIG. 32, a UE receives beam indication DCI #1 indicating referring to RS #0 after the elapse of BAT #0, referring to RS #1 after the elapse of BAT #1, and referring to RS #2 after the elapse of BAT #2.

In the example in FIG. 32, the UE also receives beam indication DCI #2 indicating referring to RS #3 after the elapse of BAT #3. BAT #3 is present between BAT #1 and BAT #2.

In the example shown in FIG. 32, the UE does not follow reference of an RS (application of a TCI state) by beam indication DCI #1 after the specific timing (for example, the symbol for the first application/reference of a TCI state/RS indicated by beam indication DCI (that is, BAT #3)). In other words, the UE determines to refer to RS #0/#1, based on the indication of beam indication DCI #1 before BAT #3, and determines to refer to RS #3 after the elapse of BAT #3.

The “timing before the last BAT” in aspects 5-1 to 5-5 above and “timing before the elapse of a specific period after the last BAT” may be interchangeably interpreted.

The specific period may be defined in a specification in advance, may be determined based on a specific rule, may be determined based on higher layer signaling (RRC/MAC CE)/DCI, or may be determined based on reported UE capability information (for example, capability information related to application time of QCL (“timedurationForQCL”)). The specific period may be expressed by X symbol(s)/slot(s)/subframe(s)/Y [ms].

According to the fifth embodiment, it is possible to appropriately control application of a TCI state and operation of reference of a source RS even when a plurality of beam indications are received.

### Other Embodiments

At least one of the above-described embodiments may be applied only to a UE that has reported specific UE capability or that supports the specific UE capability.

The specific UE capability may indicate at least one of the following (may be defined by at least one of the following):
capability about operation/information related to each embodiment/aspect,
capability about operation/information related to each option/combination of options,
capability about the operation/information related to each choice/combination of choices,
the (supported) maximum number of TCI states associated with one TCI codepoint,
the (supported) maximum number of source RSs having the same QCL type and associated with one TCI codepoint,
the (supported) maximum number of TCI states to be activated, and
the (supported) maximum value/minimum value of a BAT.

The UE capability above may be defined whether or not to support at least one of determination of a BAT (for AI-aided beam prediction), configuration/indication of a BAT, configuration/activation/indication of a beam pattern (a plurality of TCI states), the maximum number of (combinations/pairs of) TCI states included in a MAC CE, the maximum value/minimum value of a BAT, and operation for reception of a plurality of beam indications, for example.

The UE capability above may be defined by the supported maximum N/M/n/m/X/Y value (described in each embodiment).

The UE capability above may be reported for each frequency, may be reported for each frequency range (for example, Frequency Range 1 (FR1), Frequency Range 2 (FR2), FR2-1, FR2-2)), may be reported for each cell, or may be reported for each subcarrier spacing (SCS).

The UE capability may be reported in common to or may be reported independently of time division duplex (TDD) and frequency division duplex (FDD).

At least one of the above-described embodiments may be applied to a case where specific information related to the above-described embodiment is configured for a UE by higher layer signaling.

According to the other embodiments above, the UE can implement the above functions while maintaining compatibility with an existing specification.

### (Radio Communication System)

Hereinafter, a structure of a radio communication system according to one embodiment of the present disclosure will be described. In this radio communication system, the radio communication method according to each embodiment of the present disclosure described above may be used alone or may be used in combination for communication.

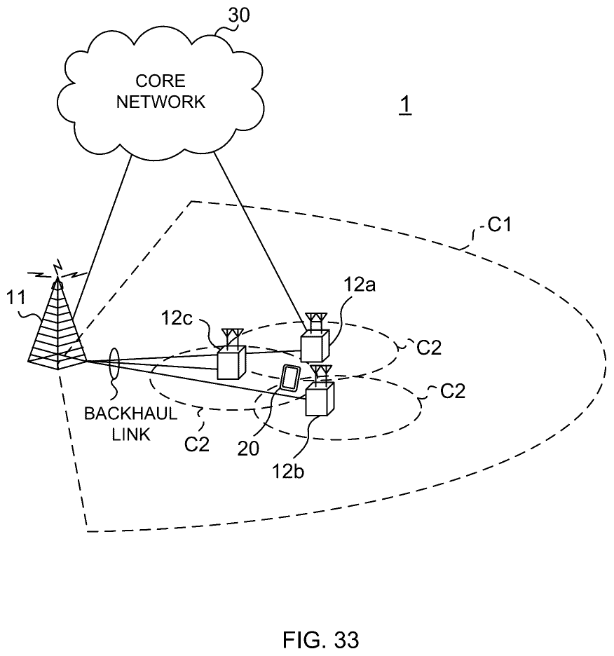

FIG. 33 is a diagram to show an example of a schematic structure of the radio communication system according to one embodiment. The radio communication system 1 may be a system implementing a communication using Long Term Evolution (LTE), 5th generation mobile communication system New Radio (5G NR) and so on the specifications of which have been drafted by Third Generation Partnership Project (3GPP).

The radio communication system 1 may support dual connectivity (multi-RAT dual connectivity (MR-DC)) between a plurality of Radio Access Technologies (RATs). The MR-DC may include dual connectivity (E-UTRA-NR Dual Connectivity (EN-DC)) between LTE (Evolved Universal Terrestrial Radio Access (E-UTRA)) and NR, dual connectivity (NR-E-UTRA Dual Connectivity (NE-DC)) between NR and LTE, and so on.

In EN-DC, a base station (eNB) of LTE (E-UTRA) is a master node (MN), and a base station (gNB) of NR is a secondary node (SN). In NE-DC, a base station (gNB) of NR is an MN, and a base station (eNB) of LTE (E-UTRA) is an SN.

The radio communication system 1 may support dual connectivity between a plurality of base stations in the same RAT (for example, dual connectivity (NR-NR Dual Connectivity (NN-DC)) where both of an MN and an SN are base stations (gNB) of NR).

The radio communication system 1 may include a base station 11 that forms a macro cell C1 of a relatively wide coverage, and base stations 12 (12a to 12c) that form small cells C2, which are placed within the macro cell C1 and which are narrower than the macro cell C1. The user terminal 20 may be located in at least one cell. The arrangement, the number, and the like of each cell and user terminal 20 are by no means limited to the aspect shown in the diagram. Hereinafter, the base stations 11 and 12 will be collectively referred to as “base stations 10,” unless specified otherwise.

The user terminal 20 may be connected to at least one of the plurality of base stations 10. The user terminal 20 may use at least one of carrier aggregation (CA) and dual connectivity (DC) using a plurality of component carriers (CCs).

Each CC may be included in at least one of a first frequency band (Frequency Range 1 (FR1)) and a second frequency band (Frequency Range 2 (FR2)). The macro cell C1 may be included in FR1, and the small cells C2 may be included in FR2. For example, FR1 may be a frequency band of 6 GHz or less (sub-6 GHz), and FR2 may be a frequency band which is higher than 24 GHz (above-24 GHz). Note that frequency bands, definitions and so on of FR1 and FR2 are by no means limited to these, and for example, FR1 may correspond to a frequency band which is higher than FR2.

The user terminal 20 may communicate using at least one of time division duplex (TDD) and frequency division duplex (FDD) in each CC.

The plurality of base stations 10 may be connected by a wired connection (for example, optical fiber in compliance with the Common Public Radio Interface (CPRI), the X2 interface and so on) or a wireless connection (for example, an NR communication). For example, if an NR communication is used as a backhaul between the base stations 11 and 12, the base station 11 corresponding to a higher station may be referred to as an “Integrated Access Backhaul (IAB) donor,” and the base station 12 corresponding to a relay station (relay) may be referred to as an “IAB node.”

The base station 10 may be connected to a core network 30 through another base station 10 or directly. For example, the core network 30 may include at least one of Evolved Packet Core (EPC), 5G Core Network (5GCN), Next Generation Core (NGC), and so on.

The user terminal 20 may be a terminal supporting at least one of communication schemes such as LTE, LTE-A, 5G, and so on.

In the radio communication system 1, an orthogonal frequency division multiplexing (OFDM)-based wireless access scheme may be used. For example, in at least one of the downlink (DL) and the uplink (UL), Cyclic Prefix OFDM (CP-OFDM), Discrete Fourier Transform Spread OFDM (DFT-s-OFDM), Orthogonal Frequency Division Multiple Access (OFDMA), Single Carrier Frequency Division Multiple Access (SC-FDMA), and so on may be used.

The wireless access scheme may be referred to as a “waveform.” Note that, in the radio communication system 1, another wireless access scheme (for example, another single carrier transmission scheme, another multi-carrier transmission scheme) may be used for a wireless access scheme in the UL and the DL.

In the radio communication system 1, a downlink shared channel (Physical Downlink Shared Channel (PDSCH)), which is used by each user terminal 20 on a shared basis, a broadcast channel (Physical Broadcast Channel (PBCH)), a downlink control channel (Physical Downlink Control Channel (PDCCH)) and so on, may be used as downlink channels.

In the radio communication system 1, an uplink shared channel (Physical Uplink Shared Channel (PUSCH)), which is used by each user terminal 20 on a shared basis, an uplink control channel (Physical Uplink Control Channel (PUCCH)), a random access channel (Physical Random Access Channel (PRACH)) and so on may be used as uplink channels.

User data, higher layer control information, System Information Blocks (SIBs) and so on are communicated on the PDSCH. User data, higher layer control information and so on may be communicated on the PUSCH. The Master Information Blocks (MIBs) may be communicated on the PBCH.

Lower layer control information may be communicated on the PDCCH. For example, the lower layer control information may include downlink control information (DCI) including scheduling information of at least one of the PDSCH and the PUSCH.

Note that DCI for scheduling the PDSCH may be referred to as “DL assignment,” “DL DCI,” and so on, and DCI for scheduling the PUSCH may be referred to as “UL grant,” “UL DCI,” and so on. Note that the PDSCH may be interpreted as “DL data”, and the PUSCH may be interpreted as “UL data”.

For detection of the PDCCH, a control resource set (CORESET) and a search space may be used. The CORESET corresponds to a resource to search DCI. The search space corresponds to a search area and a search method of PDCCH candidates. One CORESET may be associated with one or more search spaces. The UE may monitor a CORESET associated with a certain search space, based on search space configuration.

One search space may correspond to a PDCCH candidate corresponding to one or more aggregation levels. One or more search spaces may be referred to as a “search space set.” Note that a “search space,” a “search space set,” a “search space configuration,” a “search space set configuration,” a “CORESET,” a “CORESET configuration” and so on of the present disclosure may be interchangeably interpreted.

Uplink control information (UCI) including at least one of channel state information (CSI), transmission confirmation information (for example, which may be referred to as Hybrid Automatic Repeat reQuest ACKnowledgement (HARQ-ACK), ACK/NACK, and so on), and scheduling request (SR) may be communicated by means of the PUCCH. By means of the PRACH, random access preambles for establishing connections with cells may be communicated.

Note that the downlink, the uplink, and so on in the present disclosure may be expressed without a term of “link.” In addition, various channels may be expressed without adding “Physical” to the head.

In the radio communication system 1, a synchronization signal (SS), a downlink reference signal (DL-RS), and so on may be communicated. In the radio communication system 1, a cell-specific reference signal (CRS), a channel state information-reference signal (CSI-RS), a demodulation reference signal (DMRS), a positioning reference signal (PRS), a phase tracking reference signal (PTRS), and so on may be communicated as the DL-RS.

For example, the synchronization signal may be at least one of a primary synchronization signal (PSS) and a secondary synchronization signal (SSS). A signal block including an SS (PSS, SSS) and a PBCH (and a DMRS for a PBCH) may be referred to as an “SS/PBCH block,” an “SS Block (SSB),” and so on. Note that an SS, an SSB, and so on may be also referred to as a “reference signal.”

In the radio communication system 1, a sounding reference signal (SRS), a demodulation reference signal (DMRS), and so on may be communicated as an uplink reference signal (UL-RS). Note that DMRS may be referred to as a “user terminal specific reference signal (UE-specific Reference Signal).”

### (Base Station)

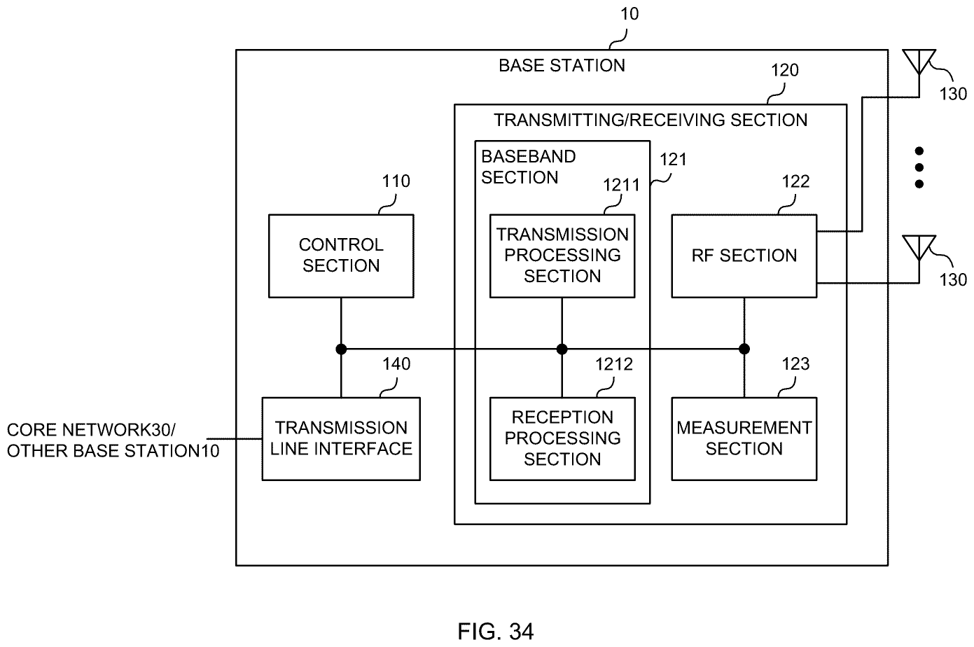

FIG. 34 is a diagram to show an example of a structure of the base station according to one embodiment. The base station 10 includes a control section 110, a transmitting/receiving section 120, transmitting/receiving antennas 130 and a communication path interface (transmission line interface) 140. Note that the base station 10 may include one or more control sections 110, one or more transmitting/receiving sections 120, one or more transmitting/receiving antennas 130, and one or more communication path interfaces 140.

Note that, the present example primarily shows functional blocks that pertain to characteristic parts of the present embodiment, and it is assumed that the base station 10 may include other functional blocks that are necessary for radio communication as well. Part of the processes of each section described below may be omitted.

The control section 110 controls the whole of the base station 10. The control section 110 can be constituted with a controller, a control circuit, or the like described based on general understanding of the technical field to which the present disclosure pertains.

The control section 110 may control generation of signals, scheduling (for example, resource allocation, mapping), and so on. The control section 110 may control transmission and reception, measurement and so on using the transmitting/receiving section 120, the transmitting/receiving antennas 130, and the communication path interface 140. The control section 110 may generate data, control information, a sequence and so on to transmit as a signal, and forward the generated items to the transmitting/receiving section 120. The control section 110 may perform call processing (setting up, releasing) for communication channels, manage the state of the base station 10, and manage the radio resources.

The transmitting/receiving section 120 may include a baseband section 121, a Radio Frequency (RF) section 122, and a measurement section 123. The baseband section 121 may include a transmission processing section 1211 and a reception processing section 1212. The transmitting/receiving section 120 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 120 may be structured as a transmitting/receiving section in one entity, or may be constituted with a transmitting section and a receiving section. The transmitting section may be constituted with the transmission processing section 1211, and the RF section 122. The receiving section may be constituted with the reception processing section 1212, the RF section 122, and the measurement section 123.

The transmitting/receiving antennas 130 can be constituted with antennas, for example, an array antenna, or the like described based on general understanding of the technical field to which the present disclosure pertains.

The transmitting/receiving section 120 may transmit the above-described downlink channel, synchronization signal, downlink reference signal, and so on. The transmitting/receiving section 120 may receive the above-described uplink channel, uplink reference signal, and so on.

The transmitting/receiving section 120 may form at least one of a transmit beam and a receive beam by using digital beam forming (for example, precoding), analog beam forming (for example, phase rotation), and so on.

The transmitting/receiving section 120 (transmission processing section 1211) may perform the processing of the Packet Data Convergence Protocol (PDCP) layer, the processing of the Radio Link Control (RLC) layer (for example, RLC retransmission control), the processing of the Medium Access Control (MAC) layer (for example, HARQ retransmission control), and so on, for example, on data and control information and so on acquired from the control section 110, and may generate bit string to transmit.

The transmitting/receiving section 120 (transmission processing section 1211) may perform transmission processing such as channel coding (which may include error correction coding), modulation, mapping, filtering, discrete Fourier transform (DFT) processing (as necessary), inverse fast Fourier transform (IFFT) processing, precoding, digital-to-analog conversion, and so on, on the bit string to transmit, and output a baseband signal.

The transmitting/receiving section 120 (RF section 122) may perform modulation to a radio frequency band, filtering, amplification, and so on, on the baseband signal, and transmit the signal of the radio frequency band through the transmitting/receiving antennas 130.

On the other hand, the transmitting/receiving section 120 (RF section 122) may perform amplification, filtering, demodulation to a baseband signal, and so on, on the signal of the radio frequency band received by the transmitting/receiving antennas 130.

The transmitting/receiving section 120 (reception processing section 1212) may apply reception processing such as analog-digital conversion, fast Fourier transform (FFT) processing, inverse discrete Fourier transform (IDFT) processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 120 (measurement section 123) may perform the measurement related to the received signal. For example, the measurement section 123 may perform Radio Resource Management (RRM) measurement, Channel State Information (CSI) measurement, and so on, based on the received signal. The measurement section 123 may measure a received power (for example, Reference Signal Received Power (RSRP)), a received quality (for example, Reference Signal Received Quality (RSRQ), a Signal to Interference plus Noise Ratio (SINR), a Signal to Noise Ratio (SNR)), a signal strength (for example, Received Signal Strength Indicator (RSSI)), channel information (for example, CSI), and so on. The measurement results may be output to the control section 110.

The communication path interface 140 may perform transmission/reception (backhaul signaling) of a signal with an apparatus included in the core network 30 or other base stations 10, and so on, and acquire or transmit user data (user plane data), control plane data, and so on for the user terminal 20.

Note that the transmitting section and the receiving section of the base station 10 in the present disclosure may be constituted with at least one of the transmitting/receiving section 120, the transmitting/receiving antennas 130, and the communication path interface 140.

The transmitting/receiving section 120 may transmit configuration information including a configuration related to a transmission configuration indication (TCI) state to be applied to a plurality of types of channels and indication of the TCI state to be applied to the plurality of types of channels. The control section 110 may indicate, by using information related to application initiation timing of the TCI state included in the configuration information and the indication, the application initiation timing of the TCI state (first embodiment).

The transmitting/receiving section 120 may transmit configuration information including a configuration related to a transmission configuration indication (TCI) state to be applied to a plurality of types of channels and the indication of the TCI state. A TCI field codepoint included in the indication may be associated with a plurality of the TCI states. The control section 110 may indicate, by using information related to application initiation timing of the TCI state included in the configuration information and the indication, the application initiation timing of the TCI state (second embodiment).

The transmitting/receiving section 120 may transmit at least one of configuration information including a configuration related to a transmission configuration indication (TCI) state to be applied to a plurality of types of channels, first indication related to the TCI state, and second indication related to the TCI state. The control section 110 may indicate, by using at least one of information related to application initiation timing of the TCI state included in the configuration information, the first indication, and the second indication, application of a first TCI state based on the first indication and application of a second TCI state based on the second indication (fifth embodiment).

### (User Terminal)

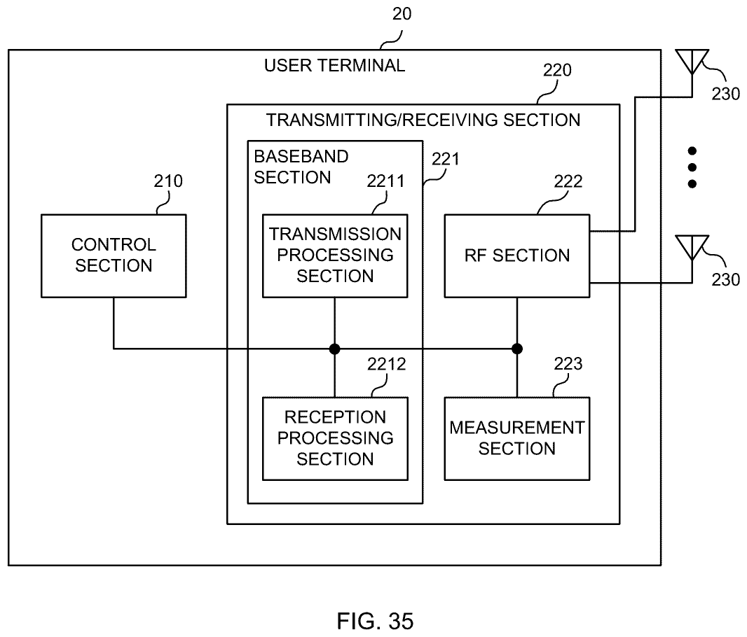

FIG. 35 is a diagram to show an example of a structure of the user terminal according to one embodiment. The user terminal 20 includes a control section 210, a transmitting/receiving section 220, and transmitting/receiving antennas 230. Note that the user terminal 20 may include one or more control sections 210, one or more transmitting/receiving sections 220, and one or more transmitting/receiving antennas 230.

Note that, the present example primarily shows functional blocks that pertain to characteristic parts of the present embodiment, and it is assumed that the user terminal 20 may include other functional blocks that are necessary for radio communication as well. Part of the processes of each section described below may be omitted.

The control section 210 controls the whole of the user terminal 20. The control section 210 can be constituted with a controller, a control circuit, or the like described based on general understanding of the technical field to which the present disclosure pertains.

The control section 210 may control generation of signals, mapping, and so on. The control section 210 may control transmission/reception, measurement and so on using the transmitting/receiving section 220, and the transmitting/receiving antennas 230. The control section 210 generates data, control information, a sequence and so on to transmit as a signal, and may forward the generated items to the transmitting/receiving section 220.

The transmitting/receiving section 220 may include a baseband section 221, an RF section 222, and a measurement section 223. The baseband section 221 may include a transmission processing section 2211 and a reception processing section 2212. The transmitting/receiving section 220 can be constituted with a transmitter/receiver, an RF circuit, a baseband circuit, a filter, a phase shifter, a measurement circuit, a transmitting/receiving circuit, or the like described based on general understanding of the technical field to which the present disclosure pertains.

The transmitting/receiving section 220 may be structured as a transmitting/receiving section in one entity, or may be constituted with a transmitting section and a receiving section. The transmitting section may be constituted with the transmission processing section 2211, and the RF section 222. The receiving section may be constituted with the reception processing section 2212, the RF section 222, and the measurement section 223.

The transmitting/receiving antennas 230 can be constituted with antennas, for example, an array antenna, or the like described based on general understanding of the technical field to which the present disclosure pertains.

The transmitting/receiving section 220 may receive the above-described downlink channel, synchronization signal, downlink reference signal, and so on. The transmitting/receiving section 220 may transmit the above-described uplink channel, uplink reference signal, and so on.

The transmitting/receiving section 220 may form at least one of a transmit beam and a receive beam by using digital beam forming (for example, precoding), analog beam forming (for example, phase rotation), and so on.

The transmitting/receiving section 220 (transmission processing section 2211) may perform the processing of the PDCP layer, the processing of the RLC layer (for example, RLC retransmission control), the processing of the MAC layer (for example, HARQ retransmission control), and so on, for example, on data and control information and so on acquired from the control section 210, and may generate bit string to transmit.

The transmitting/receiving section 220 (transmission processing section 2211) may perform transmission processing such as channel coding (which may include error correction coding), modulation, mapping, filtering, DFT processing (as necessary), IFFT processing, precoding, digital-to-analog conversion, and so on, on the bit string to transmit, and output a baseband signal.

Note that, whether to apply DFT processing or not may be based on the configuration of the transform precoding. The transmitting/receiving section 220 (transmission processing section 2211) may perform, for a certain channel (for example, PUSCH), the DFT processing as the above-described transmission processing to transmit the channel by using a DFT-s-OFDM waveform if transform precoding is enabled, and otherwise, does not need to perform the DFT processing as the above-described transmission process.

The transmitting/receiving section 220 (RF section 222) may perform modulation to a radio frequency band, filtering, amplification, and so on, on the baseband signal, and transmit the signal of the radio frequency band through the transmitting/receiving antennas 230.

On the other hand, the transmitting/receiving section 220 (RF section 222) may perform amplification, filtering, demodulation to a baseband signal, and so on, on the signal of the radio frequency band received by the transmitting/receiving antennas 230.

The transmitting/receiving section 220 (reception processing section 2212) may apply reception processing such as analog-digital conversion, FFT processing, IDFT processing (as necessary), filtering, de-mapping, demodulation, decoding (which may include error correction decoding), MAC layer processing, the processing of the RLC layer and the processing of the PDCP layer, and so on, on the acquired baseband signal, and acquire user data, and so on.

The transmitting/receiving section 220 (measurement section 223) may perform the measurement related to the received signal. For example, the measurement section 223 may perform RRM measurement, CSI measurement, and so on, based on the received signal. The measurement section 223 may measure a received power (for example, RSRP), a received quality (for example, RSRQ, SINR, SNR), a signal strength (for example, RSSI), channel information (for example, CSI), and so on. The measurement results may be output to the control section 210.

Note that the transmitting section and the receiving section of the user terminal 20 in the present disclosure may be constituted with at least one of the transmitting/receiving section 220 and the transmitting/receiving antennas 230.

The transmitting/receiving section 220 may receive configuration information including a configuration related to a transmission configuration indication (TCI) state to be applied to a plurality of types of channels and indication of the TCI state to be applied to the plurality of types of channels. The control section 210 may determine, based on information related to application initiation timing of the TCI state included in the configuration information and the indication, the application initiation timing of the TCI state (first embodiment).

The configuration information may be a Radio Resource Control (RRC) parameter. The information related to the application initiation timing of the TCI state may be included in at least one of a physical downlink shared channel configuration parameter, a TCI state configuration parameter, and a quasi-co-location configuration parameter (first embodiment).

The configuration information may be a Medium Access Control control element (MAC Control Element (CE)). The information related to the application initiation timing of the TCI state may be a specific field included in the MAC CE (first embodiment).

The configuration information may include information related to first application initiation timing corresponding to a first TCI state among the TCI states and information related to second application initiation timing corresponding to a second TCI state among the TCI states. When the first TCI state is to be applied, the control section 210 may determine the application initiation timing of the first TCI state, based on information related to the first application initiation timing. When the second TCI state is to be applied, the control section 210 may determine the application initiation timing of the second TCI state, based on information related to the first application initiation timing and the information related to the second application initiation timing.

The transmitting/receiving section 220 may receive configuration information including a configuration related to a transmission configuration indication (TCI) state to be applied to a plurality of types of channels and the indication of the TCI state. A TCI field codepoint included in the indication may be associated with a plurality of the TCI states. The control section 210 may determine, based on information related to application initiation timing of the TCI state included in the configuration information and the indication, the application initiation timing of the TCI state (second embodiment).

The configuration information may include information related to first application initiation timing corresponding to a first TCI state among the plurality of TCI states and information related to second application initiation timing corresponding to a second TCI state among the plurality of TCI states. When the first TCI state is to be applied, the control section 210 may determine the application initiation timing of the first TCI state, based on information related to the first application initiation timing. When the second TCI state is to be applied, the control section 210 may determine the application initiation timing of the second TCI state, based on information related to the first application initiation timing and the information related to the second application initiation timing (second embodiment).

The configuration information may be a Medium Access Control control element (MAC Control Element (CE)). The MAC CE may activate TCI states included in a pair or a combination of the TCI states the number of which is a specific number at maximum (third embodiment).

The control section 210 need not assume reception of at least one of indication related to application initiation timing having a value larger than a maximum value related to the application initiation timing and indication related to application initiation timing having a value smaller than a minimum value related to the application initiation timing (fourth embodiment).

The transmitting/receiving section 220 may receive at least one of configuration information including a configuration related to a transmission configuration indication (TCI) state to be applied to a plurality of types of channels, first indication related to the TCI state, and second indication related to the TCI state. The control section 210 may determine, based on at least one of information related to application initiation timing of the TCI state included in the configuration information, the first indication, and the second indication, application of a first TCI state based on the first indication and application of a second TCI state based on the second indication (fifth embodiment).

The control section 210 need not assume to receive the second indication indicating the application initiation timing of the second TCI state being earlier than specific timing related to the application initiation timing of the first TCI state, or may ignore at least part of the second indication indicating the application initiation timing of the second TCI state being earlier than the specific timing (fifth embodiment).

The control section 210 need not assume to receive the second indication indicating application of a TCI state other than the first TCI state in a period to which the first TCI state is applied based on the first indication, or may ignore at least part of the second indication indicating application of a TCI state other than the first TCI state in the period (fifth embodiment).

The control section 210 may determine to change application of the first TCI state based on the first indication after the elapse of a specific period from reception of the second indication and apply the second TCI state based on the second indication (fifth embodiment).

### (Hardware Structure)

Note that the block diagrams that have been used to describe the above embodiments show blocks in functional units. These functional blocks (components) may be implemented in arbitrary combinations of at least one of hardware and software. Also, the method for implementing each functional block is not particularly limited. That is, each functional block may be realized by one piece of apparatus that is physically or logically coupled, or may be realized by directly or indirectly connecting two or more physically or logically separate pieces of apparatus (for example, via wire, wireless, or the like) and using these plurality of pieces of apparatus. The functional blocks may be implemented by combining softwares into the apparatus described above or the plurality of apparatuses described above.

Here, functions include judgment, determination, decision, calculation, computation, processing, derivation, investigation, search, confirmation, reception, transmission, output, access, resolution, selection, designation, establishment, comparison, assumption, expectation, considering, broadcasting, notifying, communicating, forwarding, configuring, reconfiguring, allocating (mapping), assigning, and the like, but function are by no means limited to these. For example, functional block (components) to implement a function of transmission may be referred to as a “transmitting section (transmitting unit),” a “transmitter,” and the like. The method for implementing each component is not particularly limited as described above.

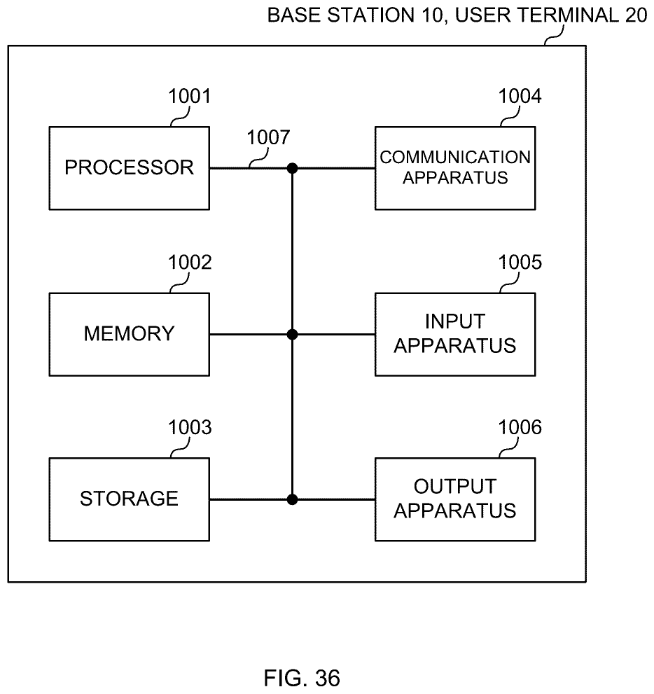

For example, a base station, a user terminal, and so on according to one embodiment of the present disclosure may function as a computer that executes the processes of the radio communication method of the present disclosure. FIG. 36 is a diagram to show an example of a hardware structure of the base station and the user terminal according to one embodiment. Physically, the above-described base station 10 and user terminal 20 may each be formed as a computer apparatus that includes a processor 1001, a memory 1002, a storage 1003, a communication apparatus 1004, an input apparatus 1005, an output apparatus 1006, a bus 1007, and so on.

Note that in the present disclosure, the words such as an apparatus, a circuit, a device, a section, a unit, and so on can be interchangeably interpreted. The hardware structure of the base station 10 and the user terminal 20 may be configured to include one or more of apparatuses shown in the drawings, or may be configured not to include part of apparatuses.

For example, although only one processor 1001 is shown, a plurality of processors may be provided. Furthermore, processes may be implemented with one processor or may be implemented at the same time, in sequence, or in different manners with two or more processors. Note that the processor 1001 may be implemented with one or more chips.

Each function of the base station 10 and the user terminals 20 is implemented, for example, by allowing certain software (programs) to be read on hardware such as the processor 1001 and the memory 1002, and by allowing the processor 1001 to perform calculations to control communication via the communication apparatus 1004 and control at least one of reading and writing of data in the memory 1002 and the storage 1003.

The processor 1001 controls the whole computer by, for example, running an operating system. The processor 1001 may be configured with a central processing unit (CPU), which includes interfaces with peripheral apparatus, control apparatus, computing apparatus, a register, and so on. For example, at least part of the above-described control section 110 (210), the transmitting/receiving section 120 (220), and so on may be implemented by the processor 1001.

Furthermore, the processor 1001 reads programs (program codes), software modules, data, and so on from at least one of the storage 1003 and the communication apparatus 1004, into the memory 1002, and executes various processes according to these. As for the programs, programs to allow computers to execute at least part of the operations of the above-described embodiments are used. For example, the control section 110 (210) may be implemented by control programs that are stored in the memory 1002 and that operate on the processor 1001, and other functional blocks may be implemented likewise.

The memory 1002 is a computer-readable recording medium, and may be constituted with, for example, at least one of a Read Only Memory (ROM), an Erasable Programmable ROM (EPROM), an Electrically EPROM (EEPROM), a Random Access Memory (RAN), and other appropriate storage media. The memory 1002 may be referred to as a “register,” a “cache,” a “main memory (primary storage apparatus)” and so on. The memory 1002 can store executable programs (program codes), software modules, and the like for implementing the radio communication method according to one embodiment of the present disclosure.

The storage 1003 is a computer-readable recording medium, and may be constituted with, for example, at least one of a flexible disk, a floppy (registered trademark) disk, a magneto-optical disk (for example, a compact disc (Compact Disc ROM (CD-ROM) and so on), a digital versatile disc, a Blu-ray (registered trademark) disk), a removable disk, a hard disk drive, a smart card, a flash memory device (for example, a card, a stick, and a key drive), a magnetic stripe, a database, a server, and other appropriate storage media. The storage 1003 may be referred to as “secondary storage apparatus.”

The communication apparatus 1004 is hardware (transmitting/receiving device) for allowing inter-computer communication via at least one of wired and wireless networks, and may be referred to as, for example, a “network device,” a “network controller,” a “network card,” a “communication module,” and so on. The communication apparatus 1004 may be configured to include a high frequency switch, a duplexer, a filter, a frequency synthesizer, and so on in order to realize, for example, at least one of frequency division duplex (FDD) and time division duplex (TDD). For example, the above-described transmitting/receiving section 120 (220), the transmitting/receiving antennas 130 (230), and so on may be implemented by the communication apparatus 1004. In the transmitting/receiving section 120 (220), the transmitting section 120a (220a) and the receiving section 120b (220b) can be implemented while being separated physically or logically.

The input apparatus 1005 is an input device that receives input from the outside (for example, a keyboard, a mouse, a microphone, a switch, a button, a sensor, and so on). The output apparatus 1006 is an output device that allows sending output to the outside (for example, a display, a speaker, a Light Emitting Diode (LED) lamp, and so on). Note that the input apparatus 1005 and the output apparatus 1006 may be provided in an integrated structure (for example, a touch panel).

Furthermore, these types of apparatus, including the processor 1001, the memory 1002, and others, are connected by a bus 1007 for communicating information. The bus 1007 may be formed with a single bus, or may be formed with buses that vary between pieces of apparatus.

Also, the base station 10 and the user terminals 20 may be structured to include hardware such as a microprocessor, a digital signal processor (DSP), an Application Specific Integrated Circuit (ASIC), a Programmable Logic Device (PLD), a Field Programmable Gate Array (FPGA), and so on, and part or all of the functional blocks may be implemented by the hardware. For example, the processor 1001 may be implemented with at least one of these pieces of hardware.

### Modification Examples

Note that the terminology described in the present disclosure and the terminology that is needed to understand the present disclosure may be replaced by other terms that convey the same or similar meanings. For example, a “channel,” a “symbol,” and a “signal” (or signaling) may be interchangeably interpreted. Also, “signals” may be “messages.” A reference signal may be abbreviated as an “RS,” and may be referred to as a “pilot,” a “pilot signal,” and so on, depending on which standard applies. Furthermore, a “component carrier (CC)” may be referred to as a “cell,” a “frequency carrier,” a “carrier frequency” and so on.

A radio frame may be constituted of one or a plurality of periods (frames) in the time domain. Each of one or a plurality of periods (frames) constituting a radio frame may be referred to as a “subframe.” Furthermore, a subframe may be constituted of one or a plurality of slots in the time domain. A subframe may be a fixed time length (for example, 1 ms) independent of numerology.

Here, numerology may be a communication parameter applied to at least one of transmission and reception of a certain signal or channel. For example, numerology may indicate at least one of a subcarrier spacing (SCS), a bandwidth, a symbol length, a cyclic prefix length, a transmission time interval (TTI), the number of symbols per TTI, a radio frame structure, a specific filter processing performed by a transceiver in the frequency domain, a specific windowing processing performed by a transceiver in the time domain, and so on.

A slot may be constituted of one or a plurality of symbols in the time domain (Orthogonal Frequency Division Multiplexing (OFDM) symbols, Single Carrier Frequency Division Multiple Access (SC-FDMA) symbols, and so on). Furthermore, a slot may be a time unit based on numerology.

A slot may include a plurality of mini-slots. Each mini-slot may be constituted of one or a plurality of symbols in the time domain. A mini-slot may be referred to as a “sub-slot.” A mini-slot may be constituted of symbols less than the number of slots. A PDSCH (or PUSCH) transmitted in a time unit larger than a mini-slot may be referred to as “PDSCH (PUSCH) mapping type A.” A PDSCH (or PUSCH) transmitted using a mini-slot may be referred to as “PDSCH (PUSCH) mapping type B.”

A radio frame, a subframe, a slot, a mini-slot, and a symbol all express time units in signal communication. A radio frame, a subframe, a slot, a mini-slot, and a symbol may each be called by other applicable terms. Note that time units such as a frame, a subframe, a slot, mini-slot, and a symbol in the present disclosure may be interchangeably interpreted.

For example, one subframe may be referred to as a “TTI,” a plurality of consecutive subframes may be referred to as a “TTI,” or one slot or one mini-slot may be referred to as a “TTI.” That is, at least one of a subframe and a TTI may be a subframe (1 ms) in existing LTE, may be a shorter period than 1 ms (for example, 1 to 13 symbols), or may be a longer period than 1 ms. Note that a unit expressing TTI may be referred to as a “slot,” a “mini-slot,” and so on instead of a “subframe.”

Here, a TTI refers to the minimum time unit of scheduling in radio communication, for example. For example, in LTE systems, a base station schedules the allocation of radio resources (such as a frequency bandwidth and transmit power that are available for each user terminal) for the user terminal in TTI units. Note that the definition of TTIs is not limited to this.

TTIs may be transmission time units for channel-encoded data packets (transport blocks), code blocks, or codewords, or may be the unit of processing in scheduling, link adaptation, and so on. Note that, when TTIs are given, the time interval (for example, the number of symbols) to which transport blocks, code blocks, codewords, or the like are actually mapped may be shorter than the TTIs.

Note that, in the case where one slot or one mini-slot is referred to as a TTI, one or more TTIs (that is, one or more slots or one or more mini-slots) may be the minimum time unit of scheduling. Furthermore, the number of slots (the number of mini-slots) constituting the minimum time unit of the scheduling may be controlled.

A TTI having a time length of 1 ms may be referred to as a “normal TTI” (TTI in 3GPP Rel. 8 to Rel. 12), a “long TTI,” a “normal subframe,” a “long subframe,” a “slot” and so on. A TTI that is shorter than a normal TTI may be referred to as a “shortened TTI,” a “short TTI,” a “partial or fractional TTI,” a “shortened subframe,” a “short subframe,” a “mini-slot,” a “sub-slot,” a “slot” and so on.

Note that a long TTI (for example, a normal TTI, a subframe, and so on) may be interpreted as a TTI having a time length exceeding 1 ms, and a short TTI (for example, a shortened TTI and so on) may be interpreted as a TTI having a TTI length shorter than the TTI length of a long TTI and equal to or longer than 1 ms.

A resource block (RB) is the unit of resource allocation in the time domain and the frequency domain, and may include one or a plurality of consecutive subcarriers in the frequency domain. The number of subcarriers included in an RB may be the same regardless of numerology, and, for example, may be 12. The number of subcarriers included in an RB may be determined based on numerology.

Also, an RB may include one or a plurality of symbols in the time domain, and may be one slot, one mini-slot, one subframe, or one TTI in length. One TTI, one subframe, and so on each may be constituted of one or a plurality of resource blocks.

Note that one or a plurality of RBs may be referred to as a “physical resource block (Physical RB (PRB)),” a “sub-carrier group (SCG),” a “resource element group (REG),” a “PRB pair,” an “RB pair” and so on.

Furthermore, a resource block may be constituted of one or a plurality of resource elements (REs). For example, one RE may correspond to a radio resource field of one subcarrier and one symbol.

A bandwidth part (BWP) (which may be referred to as a “fractional bandwidth,” and so on) may represent a subset of contiguous common resource blocks (common RBs) for certain numerology in a certain carrier. Here, a common RB may be specified by an index of the RB based on the common reference point of the carrier. A PRB may be defined by a certain BWP and may be numbered in the BWP.

The BWP may include a UL BWP (BWP for the UL) and a DL BWP (BWP for the DL). One or a plurality of BWPs may be configured in one carrier for a UE.

At least one of configured BWPs may be active, and a UE does not need to assume to transmit/receive a certain signal/channel outside active BWPs. Note that a “cell,” a “carrier,” and so on in the present disclosure may be interpreted as a “BWP”.

Note that the above-described structures of radio frames, subframes, slots, mini-slots, symbols, and so on are merely examples. For example, structures such as the number of subframes included in a radio frame, the number of slots per subframe or radio frame, the number of mini-slots included in a slot, the numbers of symbols and RBs included in a slot or a mini-slot, the number of subcarriers included in an RB, the number of symbols in a TTI, the symbol length, the cyclic prefix (CP) length, and so on can be variously changed.

Also, the information, parameters, and so on described in the present disclosure may be represented in absolute values or in relative values with respect to certain values, or may be represented in another corresponding information. For example, radio resources may be specified by certain indices.

The names used for parameters and so on in the present disclosure are in no respect limiting. Furthermore, mathematical expressions that use these parameters, and so on may be different from those expressly disclosed in the present disclosure. Since various channels (PUCCH, PDCCH, and so on) and information elements can be identified by any suitable names, the various names allocated to these various channels and information elements are in no respect limiting.

The information, signals, and so on described in the present disclosure may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output in at least one of from higher layers to lower layers and from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/embodiments described in the present disclosure, and other methods may be used as well. For example, reporting of information in the present disclosure may be implemented by using physical layer signaling (for example, downlink control information (DCI), uplink control information (UCI)), higher layer signaling (for example, Radio Resource Control (RRC) signaling, broadcast information (master information block (MIB), system information blocks (SIBs), and so on), Medium Access Control (MAC) signaling and so on), and other signals or combinations of these.

Note that physical layer signaling may be referred to as “Layer 1/Layer 2 (L1/L2) control information (L1/L2 control signals),” “L1 control information (L1 control signal),” and so on. Also, RRC signaling may be referred to as an “RRC message,” and can be, for example, an RRC connection setup message, an RRC connection reconfiguration message, and so on. Also, MAC signaling may be reported using, for example, MAC control elements (MAC CEs).

Also, reporting of certain information (for example, reporting of “X holds”) does not necessarily have to be reported explicitly, and can be reported implicitly (by, for example, not reporting this certain information or reporting another piece of information).

Determinations may be made in values represented by one bit (0 or 1), may be made in Boolean values that represent true or false, or may be made by comparing numerical values (for example, comparison against a certain value).

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using at least one of wired technologies (coaxial cables, optical fiber cables, twisted-pair cables, digital subscriber lines (DSL), and so on) and wireless technologies (infrared radiation, microwaves, and so on), at least one of these wired technologies and wireless technologies are also included in the definition of communication media.

The terms “system” and “network” used in the present disclosure can be used interchangeably. The “network” may mean an apparatus (for example, a base station) included in the network.

In the present disclosure, the terms such as “precoding,” a “precoder,” a “weight (precoding weight),” “quasi-co-location (QCL),” a “Transmission Configuration Indication state (TCI state),” a “spatial relation,” a “spatial domain filter,” a “transmit power,” “phase rotation,” an “antenna port,” an “antenna port group,” a “layer,” “the number of layers,” a “rank,” a “resource,” a “resource set,” a “resource group,” a “beam,” a “beam width,” a “beam angular degree,” an “antenna,” an “antenna element,” a “panel,” and so on can be used interchangeably.

In the present disclosure, the terms such as a “base station (BS),” a “radio base station,” a “fixed station,” a “NodeB,” an “eNB (eNodeB),” a “gNB (gNodeB),” an “access point,” a “transmission point (TP),” a “reception point (RP),” a “transmission/reception point (TRP),” a “panel,” a “cell,” a “sector,” a “cell group,” a “carrier,” a “component carrier,” and so on can be used interchangeably. The base station may be referred to as the terms such as a “macro cell,” a small cell,” a “femto cell,” a “pico cell,” and so on.

A base station can accommodate one or a plurality of (for example, three) cells. When a base station accommodates a plurality of cells, the entire coverage area of the base station can be partitioned into multiple smaller areas, and each smaller area can provide communication services through base station subsystems (for example, indoor small base stations (Remote Radio Heads (RRHs))). The term “cell” or “sector” refers to part of or the entire coverage area of at least one of a base station and a base station subsystem that provides communication services within this coverage.

In the present disclosure, the terms “mobile station (MS),” “user terminal,” “user equipment (UE),” and “terminal” may be used interchangeably.

A mobile station may be referred to as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

At least one of a base station and a mobile station may be referred to as a “transmitting apparatus,” a “receiving apparatus,” a “radio communication apparatus,” and so on. Note that at least one of a base station and a mobile station may be a device mounted on a moving object or a moving object itself, and so on.

The moving object is a movable object with any moving speed, and naturally a case where the moving object is stopped is also included. Examples of the moving object include a vehicle, a transport vehicle, an automobile, a motorcycle, a bicycle, a connected car, a loading shovel, a bulldozer, a wheel loader, a dump truck, a fork lift, a train, a bus, a trolley, a rickshaw, a ship and other watercraft, an airplane, a rocket, a satellite, a drone, a multicopter, a quadcopter, a balloon, and an object mounted on any of these, but these are not restrictive. The moving object may be a moving object that autonomously travels based on a direction for moving.

The moving object may be a vehicle (for example, a car, an airplane, and the like), may be a moving object which moves unmanned (for example, a drone, an automatic operation car, and the like), or may be a robot (a manned type or unmanned type). Note that at least one of a base station and a mobile station also includes an apparatus which does not necessarily move during communication operation. For example, at least one of a base station and a mobile station may be an Internet of Things (IoT) device such as a sensor.

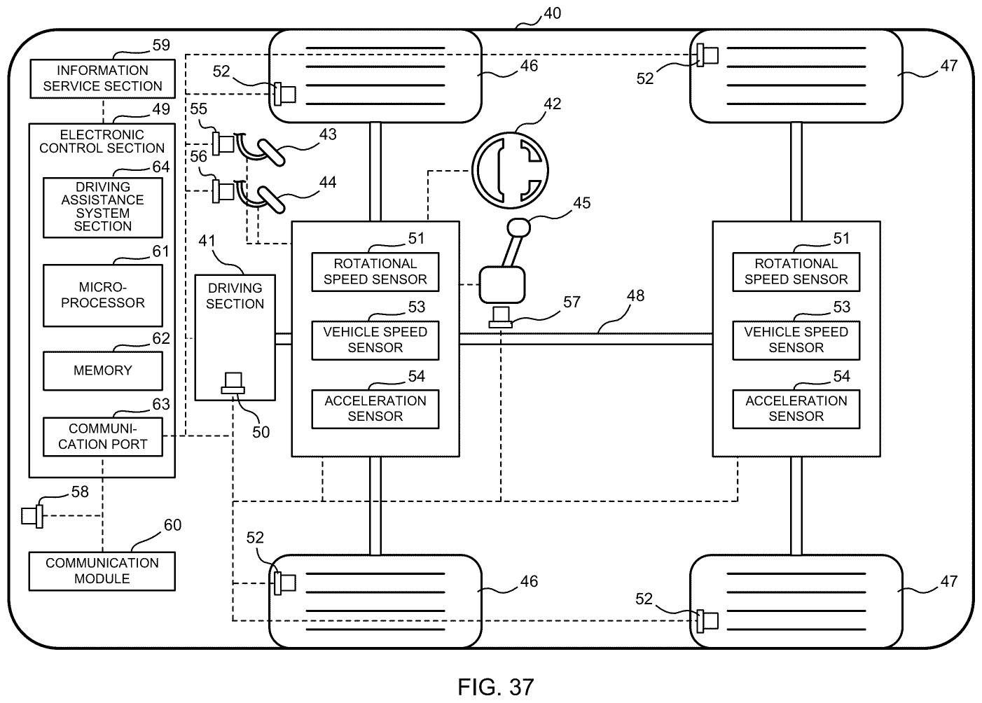

FIG. 37 is a diagram to show an example of a vehicle according to one embodiment. A vehicle 40 includes a driving section 41, a steering section 42, an accelerator pedal 43, a brake pedal 44, a shift lever 45, right and left front wheels 46, right and left rear wheels 47, an axle 48, an electronic control section 49, various sensors (including a current sensor 50, a rotational speed sensor 51, a pneumatic sensor 52, a vehicle speed sensor 53, an acceleration sensor 54, an accelerator pedal sensor 55, a brake pedal sensor 56, a shift lever sensor 57, and an object detection sensor 58), an information service section 59, and a communication module 60.

The driving section 41 includes, for example, at least one of an engine, a motor, and a hybrid of an engine and a motor. The steering section 42 at least includes a steering wheel, and is configured to steer at least one of the front wheels 46 and the rear wheels 47, based on operation of the steering wheel operated by a user.

The electronic control section 49 includes a microprocessor 61, a memory (ROM, RAM) 62, and a communication port (for example, an input/output (IO) port) 63. The electronic control section 49 receives, as input, signals from the various sensors 50 to 58 included in the vehicle. The electronic control section 49 may be referred to as an Electronic Control Unit (ECU).

Examples of the signals from the various sensors 50 to 58 include a current signal from the current sensor 50 for sensing current of a motor, a rotational speed signal of the front wheels 46/rear wheels 47 acquired by the rotational speed sensor 51, a pneumatic signal of the front wheels 46/rear wheels 47 acquired by the pneumatic sensor 52, a vehicle speed signal acquired by the vehicle speed sensor 53, an acceleration signal acquired by the acceleration sensor 54, a depressing amount signal of the accelerator pedal 43 acquired by the accelerator pedal sensor 55, a depressing amount signal of the brake pedal 44 acquired by the brake pedal sensor 56, an operation signal of the shift lever 45 acquired by the shift lever sensor 57, and a detection signal for detecting an obstruction, a vehicle, a pedestrian, and the like acquired by the object detection sensor 58.

The information service section 59 includes various devices for providing (outputting) various pieces of information such as drive information, traffic information, and entertainment information, such as a car navigation system, an audio system, a speaker, a display, a television, and a radio, and one or more ECUs that control these devices. The information service section 59 provides various pieces of information/services (for example, multimedia information/multimedia service) for an occupant of the vehicle 40, using information acquired from an external apparatus via the communication module 60 and the like.

The information service section 59 may include an input device (for example, a keyboard, a mouse, a microphone, a switch, a button, a sensor, a touch panel, and the like) for receiving input from the outside, or may include an output device (for example, a display, a speaker, an LED lamp, a touch panel, and the like) for implementing output to the outside.

A driving assistance system section 64 includes various devices for providing functions for preventing an accident and reducing a driver's driving load, such as a millimeter wave radar, Light Detection and Ranging (LiDAR), a camera, a positioning locator (for example, a Global Navigation Satellite System (GNSS) and the like), map information (for example, a high definition (HD) map, an autonomous vehicle (AV) map, and the like), a gyro system (for example, an inertial measurement apparatus (inertial measurement unit (IMU)), an inertial navigation apparatus (inertial navigation system (INS)), and the like), an artificial intelligence (AI) chip, and an AI processor, and one or more ECUs that control these devices. The driving assistance system section 64 transmits and receives various pieces of information via the communication module 60, and implements a driving assistance function or an autonomous driving function.

The communication module 60 can communicate with the microprocessor 61 and the constituent elements of the vehicle 40 via the communication port 63. For example, via the communication port 63, the communication module 60 transmits and receives data (information) to and from the driving section 41, the steering section 42, the accelerator pedal 43, the brake pedal 44, the shift lever 45, the right and left front wheels 46, the right and left rear wheels 47, the axle 48, the microprocessor 61 and the memory (ROM, RAM) 62 in the electronic control section 49, and the various sensors 50 to 58, which are included in the vehicle 40.

The communication module 60 can be controlled by the microprocessor 61 of the electronic control section 49, and is a communication device that can perform communication with an external apparatus. For example, the communication module 60 performs transmission and reception of various pieces of information to and from the external apparatus via radio communication. The communication module 60 may be either inside or outside the electronic control section 49. The external apparatus may be, for example, the base station 10, the user terminal 20, or the like described above. The communication module 60 may be, for example, at least one of the base station 10 and the user terminal 20 described above (may function as at least one of the base station 10 and the user terminal 20).

The communication module 60 may transmit at least one of signals from the various sensors 50 to 58 described above input to the electronic control section 49, information obtained based on the signals, and information based on an input from the outside (a user) obtained via the information service section 59, to the external apparatus via radio communication. The electronic control section 49, the various sensors 50 to 58, the information service section 59, and the like may be referred to as input sections that receive input. For example, the PUSCH transmitted by the communication module 60 may include information based on the input.

The communication module 60 receives various pieces of information (traffic information, signal information, inter-vehicle distance information, and the like) transmitted from the external apparatus, and displays the various pieces of information on the information service section 59 included in the vehicle. The information service section 59 may be referred to as an output section that outputs information (for example, outputs information to devices, such as a display and a speaker, based on the PDSCH received by the communication module 60 (or data/information decoded from the PDSCH)).

The communication module 60 stores the various pieces of information received from the external apparatus in the memory 62 that can be used by the microprocessor 61. Based on the pieces of information stored in the memory 62, the microprocessor 61 may perform control of the driving section 41, the steering section 42, the accelerator pedal 43, the brake pedal 44, the shift lever 45, the right and left front wheels 46, the right and left rear wheels 47, the axle 48, the various sensors 50 to 58, and the like included in the vehicle 40.

Furthermore, the base station in the present disclosure may be interpreted as a user terminal. For example, each aspect/embodiment of the present disclosure may be applied to the structure that replaces a communication between a base station and a user terminal with a communication between a plurality of user terminals (for example, which may be referred to as “Device-to-Device (D2D),” “Vehicle-to-Everything (V2X),” and the like). In this case, user terminals 20 may have the functions of the base stations 10 described above. The words “uplink” and “downlink” may be interpreted as the words corresponding to the terminal-to-terminal communication (for example, “sidelink”). For example, an uplink channel, a downlink channel, and so on may be interpreted as a sidelink channel.

Likewise, the user terminal in the present disclosure may be interpreted as base station. In this case, the base station 10 may have the functions of the user terminal 20 described above.

Actions which have been described in the present disclosure to be performed by a base station may, in some cases, be performed by upper nodes of the base station. In a network including one or a plurality of network nodes with base stations, it is clear that various operations that are performed to communicate with terminals can be performed by base stations, one or more network nodes (for example, Mobility Management Entities (MMEs), Serving-Gateways (S-GWs), and so on may be possible, but these are not limiting) other than base stations, or combinations of these.

The aspects/embodiments illustrated in the present disclosure may be used individually or in combinations, which may be switched depending on the mode of implementation. The order of processes, sequences, flowcharts, and so on that have been used to describe the aspects/embodiments in the present disclosure may be re-ordered as long as inconsistencies do not arise. For example, although various methods have been illustrated in the present disclosure with various components of steps in exemplary orders, the specific orders that are illustrated herein are by no means limiting.

The aspects/embodiments illustrated in the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 6th generation mobile communication system (6G), xth generation mobile communication system (xG (where x is, for example, an integer or a decimal)), Future Radio Access (FRA), New-Radio Access Technology (RAT), New Radio (NR), New radio access (NX), Future generation radio access (FX), Global System for Mobile communications (GSM (registered trademark)), CDMA 2000, Ultra Mobile Broadband (M4B), IEEE 802.11 (Wi-Fi (registered trademark)), IEEE 802.16 (WiMAX (registered trademark)), IEEE 802.20, Ultra-WideBand (UWB), Bluetooth (registered trademark), systems that use other adequate radio communication methods and next-generation systems that are enhanced based on these. A plurality of systems may be combined (for example, a combination of LTE or LTE-A and 5G, and the like) and applied.

The phrase “based on” (or “on the basis of”) as used in the present disclosure does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second,” and so on as used in the present disclosure does not generally limit the quantity or order of these elements. These designations may be used in the present disclosure only for convenience, as a method for distinguishing between two or more elements. Thus, reference to the first and second elements does not imply that only two elements may be employed, or that the first element must precede the second element in some way.

The term “judging (determining)” as in the present disclosure herein may encompass a wide variety of actions. For example, “judging (determining)” may be interpreted to mean making “judgments (determinations)” about judging, calculating, computing, processing, deriving, investigating, looking up, search and inquiry (for example, searching a table, a database, or some other data structures), ascertaining, and so on.

Furthermore, “judging (determining)” may be interpreted to mean making “judgments (determinations)” about receiving (for example, receiving information), transmitting (for example, transmitting information), input, output, accessing (for example, accessing data in a memory), and so on.

In addition, “judging (determining)” as used herein may be interpreted to mean making “judgments (determinations)” about resolving, selecting, choosing, establishing, comparing, and so on. In other words, “judging (determining)” may be interpreted to mean making “judgments (determinations)” about some action.

In addition, “judging (determining)” may be interpreted as “assuming,” “expecting,” “considering,” and the like.

“The maximum transmit power” according to the present disclosure may mean a maximum value of the transmit power, may mean the nominal maximum transmit power (the nominal UE maximum transmit power), or may mean the rated maximum transmit power (the rated UE maximum transmit power).

The terms “connected” and “coupled,” or any variation of these terms as used in the present disclosure mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In the present disclosure, when two elements are connected, the two elements may be considered “connected” or “coupled” to each other by using one or more electrical wires, cables and printed electrical connections, and, as some non-limiting and non-inclusive examples, by using electromagnetic energy having wavelengths in radio frequency regions, microwave regions, (both visible and invisible) optical regions, or the like.

In the present disclosure, the phrase “A and B are different” may mean that “A and B are different from each other.” Note that the phrase may mean that “A and B is each different from C.” The terms “separate,” “be coupled,” and so on may be interpreted similarly to “different.”

When terms such as “include,” “including,” and variations of these are used in the present disclosure, these terms are intended to be inclusive, in a manner similar to the way the term “comprising” is used. Furthermore, the term “or” as used in the present disclosure is intended to be not an exclusive disjunction.

For example, in the present disclosure, when an article such as “a,” “an,” and “the” in the English language is added by translation, the present disclosure may include that a noun after these articles is in a plural form.

Now, although the invention according to the present disclosure has been described in detail above, it should be obvious to a person skilled in the art that the invention according to the present disclosure is by no means limited to the embodiments described in the present disclosure. The invention according to the present disclosure can be implemented with various corrections and in various modifications, without departing from the spirit and scope of the invention defined by the recitations of claims. Consequently, the description of the present disclosure is provided only for the purpose of explaining examples, and should by no means be construed to limit the invention according to the present disclosure in any way.

1. A terminal comprising:
a receiving section that receives configuration information including a configuration related to a transmission configuration indication (TCI) state to be applied to a plurality of types of channels and indication of the TCI state, a TCI field codepoint included in the indication being associated with a plurality of the TCI states; and
a control section that determines, based on information related to application initiation timing of the TCI state included in the configuration information and the indication, the application initiation timing of the TCI state.

2. The terminal according to claim 1, wherein
the configuration information includes information related to first application initiation timing corresponding to a first TCI state among the plurality of TCI states and information related to second application initiation timing corresponding to a second TCI state of the plurality of TCI states,
when the first TCI state is to be applied, the control section determines the application initiation timing of the first TCI state, based on the information related to the first application initiation timing, and
when the second TCI state is to be applied, the control section determines the application initiation timing of the second TCI state, based on the information related to the first application initiation timing and the information related to the second application initiation timing.

3. The terminal according to claim 1, wherein
the configuration information is a Medium Access Control control element (MAC Control Element (CE)), and
the MAC CE activates TCI states included in a pair or a combination of the TCI states the number of which is a specific number at maximum.

4. The terminal according to claim 1, wherein
the control section does not assume reception of at least one of indication related to application initiation timing having a value larger than a maximum value related to the application initiation timing and indication related to application initiation timing having a value smaller than a minimum value related to the application initiation timing.

5. A radio communication method for a terminal, the radio communication method comprising:
receiving configuration information including a configuration related to a transmission configuration indication (TCI) state to be applied to a plurality of types of channels and indication of the TCI state, a TCI field codepoint included in the indication being associated with a plurality of the TCI states; and
determining, based on information related to application initiation timing of the TCI state included in the configuration information and the indication, the application initiation timing of the TCI state.

6. A base station comprising:
a transmitting section that transmits configuration information including a configuration related to a transmission configuration indication (TCI) state to be applied to a plurality of types of channels and indication of the TCI state, a TCI field codepoint included in the indication being associated with a plurality of the TCI states; and
a control section that indicates, by using information related to application initiation timing of the TCI state included in the configuration information and the indication, the application initiation timing of the TCI state.
